(19) United States
(12) Patent Application Publication
(10) Pub. No.: US 2025/0035527 A1
(43) Pub. Date: Jan. 30, 2025

(54) MODELING OPTIMIZED FRICTION REDUCING COMPOSITIONS FOR DOWNHOLE FLUID COMPOSITIONS AND METHODS OF MAKING AND USING

(71) Applicants: PfP INDUSTRIES LLC, Houston, TX (US); INDIAN INSTITUTE OF TECHNOLOGY KHARAGPUR, West Bengal (IN)

(72) Inventors: Asoke Kumar Deysarkar, Houston, TX (US); Nikhil Patel, Houston, TX (US); Christopher Dilley, Houston, TX (US); Sandeep D. Kulkarni, West Bengal (IN); Navneeth Kumar Korlepara, West Bengal (IN)

(73) Assignees: PfP INDUSTRIES LLC, Houston, TX (US); INDIAN INSTITUTE OF TECHNOLOGY KHARAGPUR, West Bengal (IN)

(21) Appl. No.: 18/765,157

(22) Filed: Jul. 5, 2024

Related U.S. Application Data
(60) Provisional application No. 63/525,104, filed on Jul. 5, 2023.

(51) Int. Cl. G01N 11/02; C09K 8/68; C09K 8/88

(52) U.S. Cl. CPC G01N 11/02; C09K 8/68; C09K 8/882; C09K 2208/28

(57) ABSTRACT

Mathematical equations for predicting a percent drag reduction (% DR) value for friction-reducing (FR) polymer compositions including various polymer properties and base fluid properties as the independent variables such as base fluid salinity, type of salts in the base fluid, molecular weight of the FR polymers, FR polymer concentrations, degrees of ionicity of the FR polymers, and percent sulfonation of AMPS-containing FR polymers.

### RELATED APPLICATIONS

This application claims the benefit of and priority to U.S. Provisional Patent Application Ser. No. 63/525,104 filed Jul. 5, 2023 (5 Jul. 2023).

### BACKGROUND OF THE DISCLOSURE

### 1. Field of the Disclosure

Embodiments of the present disclosure relate to predicting optimized friction reducing (FR) compositions for downhole fluid compositions and methods of making and using same.

In particular, embodiments of the present disclosure relate to predicting optimized friction reducing (FR) compositions for downhole fluid compositions, wherein the optimized FR compositions are determined using a mathematical equation for predicting a percent drag reduction (% DR) value based on certain FR polymer properties and downhole base fluid properties, and methods of making and using same.

### 2. Description of the Related Art

Friction-reducing (FR) polymer compositions have been used for reducing friction properties of downhole fluids, wherein the FR polymers are designed to reduce a percent drag reduction (% DR). However, the ability to optimize a FR polymer composition for a particular base fluid remains problematic and is often the subject of trial and error.

Thus, there is a need in the art for computational systems and methods for optimizing FR polymer compositions for downhole fluids based on the nature of the polymers and the nature of the base fluid used in preparing the downhole fluids.

### SUMMARY OF THE DISCLOSURE

Embodiments of this disclosure provide computational systems of producing optimized friction-reducing (FR) polymer compositions for downhole fluids implemented on an electronic device includes a processing unit and a memory, one or more mass storage device, one or more input devices and one or more output devices in communication and under the control of the processing unit, wherein the processing unit is configured to:
receive input data comprising properties of a friction-reducing polymer composition and properties of an aqueous base fluid used to prepare a downhole fluid,
calculate a percent drag reduction (% DR) for a downhole fluid according to Equation (1):

$$\% DR = {C}_{0} \times {f}_{1} ( MW ) \times {f}_{2} ( [ MVI ] ) \times {f}_{3} ( [ DVI ] , \% S ) \times {f}_{4} ( [ FRP ] ) \qquad ( 1 )$$

wherein:
   C₀ is a constant;
   ƒ₁ is explicit function of friction-reducing (FR) polymer molecular weights;
   ƒ₂ is explicit function of monovalent salt concentration in base fluid;
   ƒ₃ is explicit function of two independent variables: divalent salt concentration of the base fluid and the percent 2-acrylamido-2-methylpropane sulfonic acid (AMPS) monomer units in the FR polymers;
   ƒ₄ is explicit function of the FR polymer concentration; and
      the following dependent variable:
      % DR is estimated drag reduction of a downhole fluid; and
      the following measurable independent variables:
      MW is the polymer weight of the FR polymers to be added to the base fluid to form the downhole fluid;
      % S is a measure of a percentage of AMPS units in the FR polymers to be added to the base fluid to form the downhole fluid;
      [MVI] is the monovalent ion concentration in the base fluid;
      [DVI] is the divalent ion concentration in the base fluid;
      [FRP] is the FR polymer concentration to be added to the base fluid to form the downhole fluid; and
      % S is a measure of a percentage of AMPS units in the FR polymers to be added to the base fluid to form the downhole fluid,
receive updated input data comprising properties of a friction-reducing polymer composition and properties of an aqueous base fluid in real-time or near real-time used to modify a composition of the friction-reducing polymer composition used in the downhole fluid,
modify the friction-reducing polymer composition based on the updated input data, and repeat the receive updated input data and the modify the friction-reducing polymer composition until the downhole operation is stopped.

Thus, the systems are configured to receive input values for the measurable independent variables and to compute a % DR value based on the input values of the measurable independent variables based on Equation (1). The downhole operation may be a treating downhole fluid for treating a formation or a drilling fluid for drilling into a formation, wherein the treating downhole fluids include slick water fracturing fluids, cross-linked fracturing fluids, proppant-containing, slick water fracturing fluids, proppant-containing, cross-linked fracturing fluids, high and low viscosity completion fluids, zone isolation fluids, or any other treating fluid.

Embodiments of this disclosure provide methods for computing optimized friction-reducing (FR) polymer compositions for downhole fluids implemented on an electronic device includes a processing unit and a memory, one or more mass storage device, one or more input devices and one or more output devices in communication and under the control of the processing unit, the methods including:
receiving input values comprising properties of a friction-reducing polymer composition and properties of an aqueous base fluid used to prepare a downhole fluid,
calculating a percent drag reduction (% DR) according to Equation (1):

$$\% DR = {C}_{0} \times {f}_{1} ( MW ) \times {f}_{2} ( [ MVI ] ) \times {f}_{3} ( [ DVI ] , \% S ) \times {f}_{4} ( [ FRP ] ) \qquad ( 1 )$$

wherein:
   C₀ is a constant;
   ƒ₁ is explicit function of friction-reducing (FR) polymer molecular weights;
   ƒ₂ is explicit function of monovalent salt concentration in base fluid;
   ƒ₃ is explicit function of two independent variables: divalent salt concentration of the base fluid and the percent AMPS units in the FR polymers;
   ƒ₄ is explicit function of the FR polymer concentration; and
      the following dependent variable:
         % DR is estimated drag reduction of a downhole fluid; and
      the following measurable independent variables:
         MW is the polymer weight of the FR polymers to be added to the base fluid to form the downhole fluid;
         % S is a measure of a percentage of AMPS units in the FR polymers to be added to the base fluid to form the downhole fluid;
      [MVI] is the monovalent ion concentration in the base fluid;
      [DVI] is the divalent ion concentration in the base fluid;
         [FRP] is the FR polymer concentration to be added to the base fluid to form the downhole fluid; and
         % S is a measure of a percentage of AMPS units in the FR polymers to be added to the base fluid to form the downhole fluid,
receiving updated input data comprising properties of a friction-reducing polymer composition and properties of an aqueous base fluid in real-time or near real-time used to modify a composition of the friction-reducing polymer composition used in the downhole fluid,
modifying the friction-reducing polymer composition based on the updated input data, and repeating the receiving updated input data and the modifying the friction-reducing polymer composition until the downhole operation is stopped.

Thus, the methods are designed to receive input values for the measurable independent variables and to compute a % DR value based on the input values of the measurable independent variables based on Equation (1). The downhole operation may be a treating downhole fluid for treating a formation or a drilling fluid for drilling into a formation, wherein the treating downhole fluids include slick water fracturing fluids, cross-linked fracturing fluids, proppant-containing, slick water fracturing fluids, proppant-containing, cross-linked fracturing fluids, high and low viscosity completion fluids, zone isolation fluids, or any other treating fluid.

### BRIEF DESCRIPTION OF THE DRAWINGS OF THE DISCLOSURE

The disclosure may be better understood with reference to the following detailed description together with the appended illustrative drawings in which like elements are numbered the same:

FIG. 1 depicts a plot of raw flow-loop data of percent drag reduction (% DR) in tap water versus time for a variety of 2-acrylamido-2-methylpropane sulfonic acid (AMPS)-containing friction reducing (FR) polymer compositions: FR1, FR2, FR3, FR4, FR5, FR6, and FR7.

FIG. 2 depicts a plot of raw flow-loop data of % DR in 55,000 (55K) ppm brine versus time for a variety of AMPS-containing friction reducing polymer compositions: FR1, FR2, FR3, FR4, FR5, FR6, and FR7.

FIG. 3 depicts a plot of raw flow-loop data of % DR in 110,000 (110K) ppm brine versus time for a variety of AMPS-containing friction reducing polymer compositions: FR1, FR2, FR3, FR4, FR5, FR6, and FR7.

FIG. 4 depicts a plot of normalized experimental % DR values versus salinity for a variety of AMPS-containing friction reducing polymer compositions: FR1, FR2, FR3, FR4, FR5, FR6, and FR7.

FIG. 5 depicts a plot of flow loop normalized experimental and calculated % DR values versus salinity for a variety of AMPS-containing friction reducing polymer compositions: FR1, FR2, FR3, FR4, FR5, FR6, and FR7.

FIG. 6 depicts a plot of calculated % DR values versus and experimental % DR values for a AMPS containing-polymer in tap water, 55K salt solution, and a 110K salt solution.

FIG. 7 depicts a plot of experimental dynamic % DR values versus time for FR1 in tap water, a 55K brine, a 110K brine, and a 180K brine.

FIG. 8 depicts a plot of experimental dynamic % DR values versus time for FR11 in tap water, a 55K brine, a 110K brine, and a 180K brine.

FIG. 9 depicts a plot of experimental dynamic % DR values versus time for FR6 in tap water, a 55K brine, a 110K brine, and a 180K brine.

FIG. 10 depicts a plot of experimental dynamic % DR values versus time for FR7 in tap water, a 55K brine, a 110K brine, and a 180K brine.

FIG. 11 depicts a plot of normalized calculated and experimental % DR values versus salinity for FR1, FR6, FR7, and FR11.

FIG. 12 depicts a plot of normalized calculated and experimental % DR values versus salinity for FR1, FR6, FR7, and FR11.

FIG. 13 depicts a plot of calculated % DR values versus experimental % DR values in tap water, a 55 k brine, a 110 k brine, and a 180 k brine.

FIG. 14 depicts screen shots of a user interface for predicting an optimized friction reducing polymer composition based input data including water salinity, hardness, and total dissolved salts and desired properties such as hydration viscosity target value and percent drag reduction (% DR) producing output data including hydration viscosity target value, percent drag reduction (% DR) and polymer composition including amounts of Group I-III polymers calculated ppt values and total polymer ppt value.

FIG. 15 depicts a plot of viscosity versus monovalent brine salinity for FR1, FR11 and FR7, and a log plot of the FR1 data.

FIG. 16 depicts a plot of viscosity versus monovalent brine salinity for FR6 and a log plot of the FR6 data.

FIG. 17 depicts a plot of experimental viscosity values (cP) versus predicted viscosity values (cP) for viscosity modeling of the behavior of FR polymers.

FIG. 18 depicts a plot of viscosity versus salinity of IS brines for friction reduction polymers, FR1, FR11, FR7, and FR6.

FIG. 19 depicts a plot of storage modulus G′ in Pa and loss modulus G″ in Pa for FR1 in distilled water and tap water.

FIG. 20 depicts a plot of storage modulus G′ in Pa and loss modulus G″ in Pa for FR1 in 55K IS Brine.

FIG. 21 depicts a plot of pH versus monovalent brine salinity for FR1, FR11, FR7, and FR6.

FIG. 22 depicts a plot of pH versus IS brine salinity for FR1, FR11, FR7, and FR6.

FIG. 23 depicts a plot of pH versus of added % wt. of a 0.1 N HCl solution to tap water for FR1 measured in a flow loop apparatus.

FIG. 24 depicts a plot of % DR versus time for FR1 after the addition of different amounts of 0.1 N HCl in wt. %.

FIG. 25 depicts a plot of relative % DR values versus time for different amounts of FR1 in ppt ranging from 1 ppt to 7 ppt in a 55K IS brine.

FIG. 26 depicts a plot of relative % DR values versus time for different amounts of FR7 in ppt ranging from 1 ppt to 7 ppt in a 55K IS brine.

FIG. 27 depicts a plot of relative % DR values versus polymer concentration for different concentrations of FR1 and FR7 in ppt ranging from 1 ppt to 7 ppt in a 55K IS brine.

FIG. 28 depicts a plot of pH at 26° C. versus ferric chloride concentration in ppm from 0 ppm to 300 ppm in a 55K IS brine.

FIG. 29 depicts a plot of % DR values versus ferric chloride concentration in ppm from 0 ppm to 300 ppm in a 55K IS brine for FR1, FR11, FR7, and FR14.

FIG. 30 depicts a plot of storage modulus G′ in Pa versus shear strain for a 20 ppt of FR1 in distilled water, tap water, a 20K IS brine, and a 55K IS brine.

FIG. 31 depicts a plot of storage modulus G′ in Pa versus shear strain for a 20 ppt of FR7 in distilled water, tap water, a 20K IS brine, and a 55K IS brine.

FIG. 32 depicts a 3D plot of storage modulus G′ in Pa for FR1 and FR7 in distilled water.

FIG. 33 depicts a 3D plot of storage modulus G′ in Pa for FR1 and FR7 in tap water.

FIG. 34 depicts a 3D plot of storage modulus G′ in Pa for FR1 and FR7 in 20K IS brine.

FIG. 35 depicts a 3D plot of storage modulus G′ in Pa for FR1 and FR7 in the 55K IS brine.

FIG. 36 depicts a plot of pressure drop versus time for FR7 in a 55K IS brine.

FIG. 37 depicts a plot of % DR values versus polymer concentration for FR7 in a 55K IS brine.

FIG. 38 depicts a plot of pressure drop versus time for FR7 in a 110K IS brine.

FIG. 39 depicts a plot of % DR values versus polymer concentration for FR7 in a 110K IS brine.

FIG. 40 depicts a plot of pressure drop versus time for FR7 in a 180K IS brine.

FIG. 41 depicts a plot of % DR values versus polymer concentration for FR7 in a 180K IS brine.

FIG. 42 depicts a plot % DR values versus polymer concentration for FR7 in all three brines of FIGS. 36-41.

FIG. 43 depicts a plot of pressure drop versus time for FR1 in fresh water.

FIG. 44 depicts a plot of % DR values versus polymer concentration for FR1 in fresh water.

FIG. 45 depicts a plot of pressure drop versus time for FR1 in a 20K IS brine.

FIG. 46 depicts a plot of % DR values versus polymer concentration for FR1 in a 20K IS brine.

FIG. 47 depicts a plot of pressure drop versus time for FR1 in a 55K IS brine.

FIG. 48 depicts a plot of % DR values versus polymer concentration for FR1 in a 55K IS brine.

FIG. 49 depicts a plot % DR values versus polymer concentration for FR1 in fresh water and the two brines of FIGS. 43-48.

FIG. 50 depicts comparison of a old version of FR14 (13.7 MDa) and a new version of FR14 (11.5 MDa) in a plot to time in seconds versus polymer concentration (ppt).

### DEFINITIONS USED IN THE DISCLOSURE

All terms used in this disclose and in the attached claims will be given their plain, ordinary meaning unless otherwise explicitly and clearly defined below:

The term “at least one”, “one or more”, or “one or a plurality” are interchangeable within this disclosure and refers to one item or more than one items, e.g., at least one polymer, one or more polymers, or one or a plurality of polymers means one polymer or more than one polymers. While these are open ended terms, one of ordinary skill in the art will understand in the context of the terms being used that there are practical limitations to the opened endedness of the terms. Generally, the upper limit is less than or equal to about 20, sometimes less than or equal to about 15, sometimes less than or equal to about 10, or sometimes less than or equal to about 5.

The term “about” or “approximately” refers to the fact that a value of a given quantity is within ±20% of the stated value, or within ±15% of the stated value, or within ±10% of the stated value, or within ±5% of the stated value, or within ±2.5% of the stated, or within ±1% of the stated value, or any sub±value.

The term “substantially” or “essentially” refers to the fact that that a value of a given quantity is within ±5% of the stated value, or within ±2.5% of the stated, or within ±2% of the stated value, or within ±1% of the stated value, or within ±0.1% of the stated value, or within ±0.01% of the stated value, or any sub±value.

In this disclosure, every range of values (e.g., “from about x to about y” or “from approximately x to y” or “from approximately x-y”—“between about x and about y” or “between approximate x and y” or “between approximately x-y) is to be understood as referring to the ranges including end points and all subranges between x and y, e.g., between about X and Y includes all ranges x and y, where x is greater than X and y is less than Y.

The term “gpt” or “gptg” refers to gallons per thousand gallons.

The term “pptg” or “ppt” refers to pounds per thousand gallons.

The term “ppg” refers to pounds of particulates per gallon of treatment fluid.

The term “wt. %” refers to weight percent.

The term “w/w” refers to weight per weight.

The term “vol. %” refers to volume percent.

The term “v/v” refers to volume per volume.

The term “w/v” refers to weight per volume.

The term “v/w” refers to volume per weight.

The term “% DR” means percent drag reduction.

The terms “treat”, “treatment”, “treating”, and grammatical equivalents thereof refer to any subterranean oil and/or gas bearing formation operation that uses a fluid in conjunction with achieving a desired function and/or for a desired purpose. Use of these terms does not imply any particular action by the treatment fluid.

The term “fracturing” refers to the process and methods of breaking down a geological formation, i.e., the rock formation around a well bore, by pumping fluid at very high pressures, in order to increase production rates from a hydrocarbon reservoir. The fracturing methods of this disclosure use otherwise conventional techniques known in the art.

The term “under treating conditions” refers injecting or pumping a treating fluid into a formation at a sufficient pressure, at a sufficient temperature (normally not an issue), and for a time sufficient to achieve a desired the formation treatment.

The term “under fracturing conditions” refers injecting or pumping a fracturing fluid into a formation at a sufficient pressure, at a sufficient temperature (normally not an issue), and for a time sufficient to form fractures or fissures in the formation. When the fracturing fluid include one or more proppants, then the conditions are also sufficient to achieve a desired proppant placement profile or concentration profile within the formation.

The term “cracks”, “microcracks”, “fissures”, “microfissures”, “fractures”, or “microfactures” refers to create or enhance openings in the formation, where the term micro refers to smaller openings in the formation. Under fracturing conditions, the enhanced or created openings of fractures will generally have an elongated profile.

The term “proppant” refers to a granular substance suspended in the fracturing fluid during the fracturing operation, which serves to keep the formation from closing back down upon itself once the pressure is released. Proppants envisioned by the present disclosure include, but are not limited to, conventional proppants familiar to those skilled in the art such as sand, 20-40 mesh sand, resin-coated sand, sintered bauxite, glass beads, particular plant materials, and other solid materials using a proppant in fracturing operations.

The term “friction-reducing (FR) polymers” refers to polymers used to reduce friction associated with pumping a downhole fluid through mechanisms into a formation to be treated or a bore hole during drilling operations.

The term “base fluid” refers to an aqueous fluid used to prepare aqueous downhole fluids.

The term “polymer” or “polymeric material” means or includes homopolymers, copolymers, terpolymers, etc.

The term “copolymer,” as used herein, means polymers including two or more monomers or monomeric units, e.g., terpolymers, tetrapolymers, etc.

The term “aqueous base fluid” refers to base fluids used in the water-based friction reducing additive of the present disclosure may include water from any source, which may include fresh water, saltwater (e.g., water containing one or more salts dissolved therein), brine (e.g., saturated saltwater), seawater, produced water, surface water (e.g., from a river or a pond), reclaimed water, any other water useable in downhole operations, or any combination thereof.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only and are not exhaustive of the scope of the disclosure.

### DETAILED DESCRIPTION OF THE DISCLOSURE

The inventors have found that friction reducing (FR) polymer compositions may be optimized for percentage drag reduction (% DR) based a mathematical relationship between certain polymer properties including molecular weight, polymer concentration, polymer types and amounts, percent sulfonation (an indication of number of AMPS monomer units in the FR polymers) of each of the FR polymers, degree of ionicity, etc. and certain base fluid properties including salinity, salt types and amounts, pH, etc. The mathematical model is configured to input values of certain FR polymer properties and base fluid properties, to calculate a % DR for a given FR composition, to vary the FR composition until a desired % DR is achieved, and to output the FR composition associated with the desired % DR.

Embodiments of this disclosure broadly relates to computational systems, for producing optimized FR compositions for downhole fluids, the computational systems including a processing unit having a memory, one or more mass storage devices, one or more input devices, one or more output devices, an operating system, and routines for executing percent drag reduction (% DR) computations. The computational systems are configured to calculate a % DR value using the values of certain FR polymers properties and base fluid properties as independent variables. The polymer properties include, without limitation, concentrations of the FR polymers, types of FR polymers, molecular weights of the FR polymers, monomer makeup of the FR polymers, percent sulfonation of the FR polymer (an indirect measure of the number of AMPS monomers units in the FR polymers, degree of ionicity of the FR polymers, or any combination thereof. The base fluid properties include, without limitation, a salinity of the base fluid, a concentration of all metal salts in the base fluid, a concentration of monovalent salts in the base fluid, a concentration of polyvalent metal salts in the base fluid, a pH of the base fluid, a temperature of the formation into which the FR composition is to be used, or any combination thereof.

In certain embodiments, the computational systems are configured to calculate or compute a percent drag reduction (% DR) based on the mathematical formula of Equation (1):

$$\% DR = {C}_{0} \times {f}_{1} ( MW ) \times {f}_{2} ( [ MVI ] ) \times {f}_{3} ( [ DVI ] , \% S ) \times {f}_{4} ( [ FRP ] ) \qquad ( 1 )$$

wherein:
C₀ is a constant;
ƒ₁ is explicit function of friction-reducing (FR) polymer molecular weights;
ƒ₂ is explicit function of monovalent salt concentration in base fluid;
ƒ₃ is explicit function of two independent variables: divalent salt concentration of the base fluid and the percent AMPS units in the FR polymers;
ƒ₄ is explicit function of the FR polymer concentration; and
   the following dependent variable:
      % DR is estimated drag reduction of a downhole fluid; and
   the following measurable independent variables:
      MW is the polymer weight of the FR polymers to be added to the base fluid to form the downhole fluid;
      % S is a measure of a percentage of AMPS units in the FR polymers to be added to the base fluid to form the downhole fluid;
   [MVI] is the monovalent ion concentration in the base fluid;
   [DVI] is the divalent ion concentration in the base fluid;
      [FRP] is the FR polymer concentration to be added to the base fluid to form the downhole fluid; and
      % S is a measure of a percentage of AMPS units in the FR polymers to be added to the base fluid to form the downhole fluid.

Embodiments of this disclosure broadly relates to computational methods, implemented on an electronic device including a processing unit having a memory, one or more mass storage devices, one or more input devices, one or more output devices, an operating system, and routines for running percent drag reduction computations, including computing a percent drag reduction (% DR) based on certain FR polymer properties and base fluid properties as independent variables. The polymer properties include, without limitation, concentrations of the FR polymers, types of FR polymers, molecular weights of the FR polymers, monomer make up of the FR polymers, percent sulfonation of the FR polymer (an indirect measure of the number of AMPS monomers units in the FR polymers, degree of ionicity of the FR polymers, or any combination thereof as independent variables. The base fluid properties include, without limitation, a salinity of the base fluid, concentration of metal salts in the base fluid (monovalent metal salts and/or polyvalent metal salts), type of salts in the base fluid (specific monovalent metal salts and/or polyvalent metal salts, temperature of the base fluid, pH of the base fluid, or any combination thereof.

In certain embodiments, the computing step comprises computing or calculating a % DR using the mathematical formula of Equation (1):

$$\% DR = {C}_{0} \times {f}_{1} ( M W ) \times {f}_{2} ( [ M V I ] ) \times {f}_{3} ( [ D V I ] , \% S ) \times {f}_{4} ( [ F R P ] ) \qquad ( 1 )$$

wherein:
C₀ is a constant;
ƒ₁ is explicit function of friction-reducing (FR) polymer molecular weights;
ƒ₂ is explicit function of monovalent salt concentration in base fluid;
ƒ₃ is explicit function of two independent variables: divalent salt concentration of the base fluid and the percent AMPS units in the FR polymers;
ƒ₄ is explicit function of the FR polymer concentration; and
   the following dependent variable:
      % DR is estimated drag reduction of a downhole fluid; and
   the following measurable independent variables:
      MW is the polymer weight of the FR polymers to be added to the base fluid to form the downhole fluid;
      % S is a measure of a percentage of AMPS units in the FR polymers to be added to the base fluid to form the downhole fluid;
   [MVI] is the monovalent ion concentration in the base fluid;
   [DVI] is the divalent ion concentration in the base fluid;
      [FRP] is the FR polymer concentration to be added to the base fluid to form the downhole fluid; and
      % S is a measure of a percentage of AMPS units in the FR polymers to be added to the base fluid to form the downhole fluid.

In certain embodiments, the function of Equation (1) may take the functional form of Equations (2) and (2a):

$$\% DR = {C}_{0} \times [ 1 - ( \frac{1}{{e}^{( {C}_{M W} \times M W )}} ) ] \times [ 1 - ( {C}_{MVI} \times [ MVI ] ) ] \times [ 1 + {\sum }_{i = 1}^{3} {( {\sum }_{j = 0}^{3} {C}_{DVIij} \times {( \% S )}^{j} ) [ DVI ]}^{i} ] \times [ {\sum }_{k = 0}^{3} {{C}_{FRPk} [ FRP ]}^{k} ] \qquad ( 2 )$$

$$\% DR = {C}_{0} \times [ 1 - ( \frac{1}{{e}^{( {C}_{M W} \times M W )}} ) ] \times [ 1 - ( {C}_{MVI} \times [ MVI ] ) ] \times [ 1 + {\sum }_{i = 1}^{2} {( {\sum }_{j = 0}^{2} {C}_{DVIij} \times {( \% S )}^{j} ) [ DVI ]}^{i} ] \times [ {\sum }_{k = 0}^{3} {{C}_{FRPk} [ FRP ]}^{k} ] \qquad ( 2 a )$$

wherein:
% DR represents percent drag reduction of a downhole fluid,
C₀ represents a real number zeroth order constant,
MW is the molecular weight of the FR polymers,
C_{MW} is a real number constant associated with the independent variable FR polymer molecular weight,
[MVI] is the concentration of monovalent metal ions in the base fluid,
C_{MVI} is a real number constant associated with the independent variable [MVI],
[DVI] is the concentration of divalent metal ions in the base fluid,
% S is a measure of the amount of AMPS monomer units in the FR polymers,
C_{DVIij} are real number constants associated with the independent variables [DVI] and % S,
[FRP] is the concentration of FR polymers,
C_{FRPk} is a real number constant associated with the independent variable [FRP],
i is an integer counter ranging from 1 to 3 for Equation (2) or 1 to 2 for Equation (2a),
j is an integer counter ranging from 0 to 3 for Equation (2) or 0 to 2 for Equation (2a), and
k is an integer counter ranging from 0 to 3 for Equation (2) or 0 to 2 for Equation (2a).

In certain embodiments, the function ƒ₁(MW) may take the functional form of exponential functions of Equations (3) or (3a):

$${f}_{1} ( M W ) = 1 - ( \frac{1}{{e}^{( {C}_{M W} \times M W )}} ) \qquad ( 3 )$$

$${f}_{1} ( M W ) = 1 - ( \frac{1}{e ( \frac{{Z}_{M W} \times M W}{20.5} )} ) \qquad ( 3 a )$$

wherein:
MW is the molecular weight of the FR polymers having a real numeric value between about 0.5 and about 25.00 MDa (mega Daltons), including any subrange or any specific value within the range, and
C_{MW} is a real number constant having a value between about 0.0195 and about 1.9512, including any subrange or any specific value within the range, or
Z_{MW} is a Real Number Constant Having a Value Between about 0.4 and 40.0 Including any subrange or any specific value within the range.

In certain embodiments, the function ƒ₂([MVI]) may take the functional form of linear functions of Equations (4) or (4a):

$${f}_{2} ( [ MVI ] ) = 1 - ( {C}_{MVI} \times [ MVI ] ) \qquad ( 4 )$$

$${f}_{2} ( [ MVI ] ) = 1 - ( \frac{{Z}_{MVI} \times [ MVI ]}{180000} ) \qquad ( 4 a )$$

[MVI] is the concentration of monovalent metal ions in the base fluid having a real numeric value between about 10 and about 250,000 ppm, including any subrange or any specific value within the range, and
C_{MVI} is a real valued constant having a value ranging between about 5.556×10⁻⁹ and 5.556×10⁻⁷, including any subrange or any specific value within the range, or
Z_{MVI} having a real numeric value between about 0.001 and 0.100 including any subrange or any specific value within the range.

In certain embodiments, the function ƒ₃([DVI], % S) may take the functional form of polynomial functions of Equation (5) and (5a):

$${f}_{3} ( [ DVI ] , \% S ) = 1 + {\sum }_{i = 1}^{3} {( {\sum }_{{j = 0}^{}}^{3} {C}_{DVIij} \times {( \% S )}^{j} ) [ DVI ]}^{i} \qquad ( 5 )$$

$${f}_{3} ( [ DVI ] , \% S ) = 1 + {\sum }_{i = 1}^{2} {( {\sum }_{j = 0}^{2} {C}_{DVIij} \times {( \% S )}^{j} ) [ DVI ]}^{i} \qquad ( 5 a )$$

wherein:
[DVI] is the concentration of monovalent metal ions in the base fluid having a real numeric value between about 1 and about 100,000 ppm, including any subrange or any specific value within the range,
% S is a measure of the amount of AMPS monomer units in the FR polymers,
C_{DVI10} is a real number constant having a value between about −2×10⁻⁶ and about −2×10⁻⁴,
C_{DVI11} is a real number constant having a value between about 5×10⁻⁸ and about 5×10⁻⁶
C_{DVI12} is a real number constant having a value between about −8×10⁻¹⁰ and about −8×10⁻⁸
C_{DVI13} is a real number constant having a value less than ±1×10⁻¹⁰,
C_{DVI20} is a real number constant having a value between about 2×10⁻¹¹ and about 2×10⁻⁹
C_{DVI12} is a real number constant having a value between about 8×10⁻¹³ and about 8×10⁻¹¹,
C_{DVI22} is a real number constant having a value between about 1×10⁻¹¹ and about 1×10⁻¹², and
C_{DVI23} is a real number constant having a value less than ±1×10⁻¹³.

In a certain embodiments, the function ƒ₄([FRP]) may take the functional form of a polynomial functions of Equation (6) and (6a):

$${f}_{4} ( [ FRP ] ) = {\sum }_{k = 0}^{3} {{C}_{F R P k} [ F R P ]}^{k} \qquad ( 6 )$$

$${f}_{4} ( [ FRP ] ) = {\sum }_{k = 0}^{2} {{C}_{F R P k} [ F R P ]}^{k} \qquad ( 6 a )$$

wherein:
[FRP] is the concentration of FR polymers,
C_{FRP0} is a real number constant having a value between about 0.06 and about 6.00,
C_{FRP1} is a real number constant having a value between about 0.04 and about 4.00,
C_{FRP2} is a real number constant having a value between about −1.00 and about −0.01, and
C_{FRP3} is a real number constant having a value less than ±0.01.

The function of Equations (1), (2) and (2a) are formulated to calculated % DR value for a downhole including a base fluid and a specific FR polymer composition, wherein the specific FR polymer composition is designed to minimize the % DR based on the above listed base fluid properties and the above listed FR polymer properties.

### SUITABLE COMPONENTS FOR USE IN THE DISCLOSURE

### Aqueous Base Fluids

Suitable base fluids for use in this disclosure include, without limitation, any source of water such as fresh water, saltwater (e.g., water containing one or more salts dissolved therein), brine (e.g., saturated saltwater), seawater, produced water, surface water (e.g., from a river or a pond), reclaimed water, aqueous fluids formulated using any combination of these sources of water, or any mixture or combination thereof.

### Oil-Based Base Fluids

Suitable oil-based base fluids include, without limitation, a hydrocarbon fluid such as diesel, kerosene, fuel oil, selected crude oils, mineral oil, or any combination thereof.

### Friction-Reducing (FR) Polymers

Suitable friction-reducing polymers for use in this disclosure include, without limitation, one or more anionic polymers, one or more cationic polymers, one or more amphoteric polymers, or any combination thereof. Exemplary examples include, without limitation, one or more acrylamide copolymers, one or more anionic acrylamide copolymers, one or more cationic acrylamide copolymers, one or more nonionic acrylamide copolymers, one or more amphoteric acrylamide copolymers, one or more polyacrylamides, one or more polyacrylamide derivatives, one or more polyacrylate, one or more polyacrylate derivative, one or more polymethacrylate, one or more polymethacrylate derivatives, and any mixture or combination thereof. Exemplary examples of suitable FR polymers include, without limitation, polyacrylates, polyacrylate derivatives, polyacrylate copolymers, polymethacrylates, polymethacrylate derivatives, polymethacrylate copolymers, polyacrylamide, polyacrylamide derivatives, polyacrylamide copolymers, acrylamide copolymers, polysaccharides, polysaccharide derivatives, polysaccharide copolymers, synthetic polymers, superabsorbent polymers, and any combination thereof. Exemplary examples of water soluble FR polymers include, without limitation, polymers containing one or more of the following monomers: acrylamide, acrylic acid, methacrylic acid, vinyl acetate, vinyl sulfonic acid, N-vinyl acetamide, N-vinyl formamide, itaconic acid, acrylic acid ester, methacrylic acid ester, ethoxylated-2-hydroxyethyl acrylate, ethoxylated-2-hydroxyethyl methacrylate, 2-hydroxyethyl acrylate, 2-hydroxyethylmethyl methacrylate, 2-hydroxypropyl acrylate, 2-hydroxypropyl methacrylate, hydroxymethyl styrene, 2-acrylamido-2-methylpropane sulfonic acid (AMPS), acrylamido tertiary butyl sulfonic acid (ATBS), 2-(meth)acrylamido-2-methylpropane sulfonic acid, 2-amino-2-methyl-1-propanol (AMP), N,N-dimethylacrylamide (DMAA), a salt of any of the foregoing, and any combination thereof. In certain embodiments, the FR polymers include one or more copolymers including acrylamide and AMPS. In other embodiments, the FR polymers may comprise high molecular weight, linear polymers. In certain embodiments, the one or more friction reducing polymers include one or more monomers. The one or more monomers include acrylamide, acrylic acid, 2-acrylamido-2-methylpropane sulfonic acid, acrylamido tertiary butyl sulfonic acid, a salt of any of the foregoing, and any mixture or combination thereof. In other embodiments, the water-based FR polymers have molecular weights ranging from about 100,000 to about 40,000,000, from about 200,000 to about 35,000,000, from about 300,000 to about 30,000,000, from about 400,000 to about 25,000,000, or from about 500,000 to about 20,000,000.

### Friction Reducing Composition Additives

Suspending and/or Dispersing Agent

Suitable suspending and/or dispersing agents for use in this disclosure include, without limitation, a bentonite clay, a phyllosilicate clay, fumed silica, or any combination thereof. In certain embodiments, the clay may include, without limitation, any water-based clay, fumed silica, modified clay, or any mixture or combination thereof. In other embodiments, the clay may have nano-structures and/or micro-structures.

### Gel-Bridging Agents

Suitable gel-bridging agents for use in this disclosure include, without limitation, polyethylene glycols such as PEG 200, PEG 300, PEG 400, PEG 500, or similar polyethylene polymers, polypropylene glycols, polyethylene/propylene glycols, other polyalkylene oxide polymers, or any mixture thereof.

### pH Adjusting Agents

Suitable pH adjusting agents for use in this disclosure include, without limitation, organic acids such as fatty acid, diacids, polyacids, citric acid, oxalic acid, ascorbic acid, isocitric acid, aconitic acid, propane-1,2,3-tricarboxylic acid, or any mixture thereof.

### Fatty Acids

Suitable fatty acids for use in this disclosure include, without limitation, any saturated fatty acid or unsaturated fatty acids or mixtures or combinations thereof suitable for a human, mammal or animal consumption. Exemplary fatty acids include short chain free fatty acids (SCFFA), medium chain free fatty acids (MCFFA), long chain free fatty acids (LCFFA), very-long-chain free fatty acids (VLCFFA) and mixtures or combinations thereof. SCFFA include free fatty acids having a carbyl tail group having less than between 4 and less than 8 carbon atoms (C₄ to C₈). MCFFA include free fatty acids having a carbyl group having between 8 and less than 14 carbon atoms (C₈ to C₁₄). LCFFA include free fatty acids having a carbyl group having between 14 and 24 carbon atoms (C₁₄-C₂₄). VLCFFA include free fatty acids having a carbyl group having greater than 24 carbon atoms (>C₂₄). Exemplary unsaturated fatty acids include, without limitation, myristoleic acid [CH₃(CH₂)₃CH═CH(CH₂)—COOH, cis-Δ⁹, C:D 14:1, n−5], palmitoleic acid [CH₃(CH₂)₅CH═CH(CH₂)₇COOH, cis-Δ⁹, C:D 16:1, n−7], sapienic acid [CH₃(CH₂)₈CH═CH(CH₂)₄COOH, cis-Δ⁶, C:D 16:1, n−10], oleic acid [CH₃(CH₂)₇CH═CH(CH₂)₇COOH, cis-Δ⁹, C:D 18:1, n−9], acid linoleic [CH₃(CH₂)₄CH═CHCH₂CH═CH(CH₂)₇COOH, cis,cis-Δ⁹,Δ¹², C:D 18:2, n−6], α-Linolenic acid [CH₃CH₂CH═CHCH₂CH═CHCH₂CH═CH(CH₂)₇COOH, cis,cis,cis-Δ⁹,Δ¹²,Δ¹⁵, C:D 18:3, n−3], arachidonic acid [CH₃(CH₂)₄CH═CHCH₂CH═CHCH₂CH═CHCH₂CH═CH(CH₂)₃COOH, cis,cis,cis,cis-Δ^{5Δ8},Δ¹¹,Δ¹⁴, C:D 20:4, acid n−6], eicosapentaenoic [CH₃CH₂CH═CHCH₂CH═CHCH₂CH═CHCH₂CH═CHCH₂CH═CH(CH₂)₃COOH], cis,cis,cis,cis,cis-Δ⁵,Δ⁸,Δ¹¹,Δ¹⁴,Δ¹⁷, 20:5, n−3], erucic acid [CH₃(CH₂)₇CH═CH(CH₂)₁₁COOH, cis-Δ¹³, C:D 22:1, n−9], docosahexaenoic acid [CH₃CH₂CH═CHCH₂CH═CHCH₂CH═CHCH₂CH═CHCH₂CH═CHCH₂CH—CH(CH₂)₂COOH, cis,cis,cis,cis,cis,cis-Δ⁴,Δ⁷,Δ¹⁰,Δ¹³,Δ¹⁶,Δ¹⁹, C:D 22:6, n−3], or mixtures and combinations thereof.

Exemplary saturated fatty acids include, without limitation, lauric acid [CH₃(CH₂)₁₀COOH, C:D 12:0], myristic acid [CH₃(CH₂)₁₂COOH, C:D 14:0], palmitic acid [CH₃(CH₂)₁₄COOH, C:D 16:0], stearic acid [CH₃(CH₂)₁₆COOH, C:D 18:0], arachidic acid [CH₃(CH₂)₁₈COOH, C:D 20:0], behenic acid [CH₃(CH₂)₂₀COOH, C:D 22:0], lignoceric acid [H₃(CH₂)₂₂COOH, C:D 24:0], cerotic acid [CH₃(CH₂)₂₄COOH, C:D 26:0], or mixture or combinations thereof.

Exemplary saturated fatty acids include, without limitation, butyric (C₄), valeric (C₅), caproic (C₆), enanthic (C₇), caprylic (C₈), pelargonic (C₉), capric (C₁₀), undecylic (Cn), lauric (C₁₂), tridecylic (C₁₃), myristic (C₁₄), pentadecylic (C₁₅), palmitic (C₁₆), margaric (C₁₇), stearic (C₁₈), nonadecylic (C₁₉), arachidic (C₂₀), heneicosylic (C₂₁), behenic (C₂₂), tricosylic (C₂₃), lignoceric (C₂₄), pentacosylic (C₂₅), cerotic (C₂₆), heptacosylic (C₂₇), montanic (C₂₈), nonacosylic (C₂₉), melissic (C₃₀), hentriacontylic (C₃₁), lacceroic (C₃₂), psyllic (C₃₃), geddic (C₃₄), ceroplastic (C₃₅), hexatriacontylic (C₃₆), heptatriacontylic acid (C₃₇), octatriacontylic acid (C₃₈), nonatriacontylic acid (C₃₉), tetracontylic acid (C₄₀), and mixtures or combinations thereof. Unsaturated fatty acids include, without limitation, n−3 unsaturated fatty acids such as α-linolenic acid, stearidonic acid, cicosapentaenoic acid, and docosahexaenoic acid, n−6 unsaturated fatty acids such as linoleic acid, γ-linolenic acid, dihomo-γ-linolenic acid, and arachidonic acid, n−9 unsaturated fatty acids oleic acid, claidic acid, cicosenoic acid, crucic acid, nervonic acid, mead acid and mixtures or combinations thereof.

Exemplary unsaturated fatty acids include, without limitation, (a) ω-3 unsaturated fatty acids such as octenoic (8:1), decenoic (10:1), decadienoic (10:2), lauroleic (12:1), laurolinoleic (12:2), myristovaccenic (14:1), myristolinoleic (14:2), myristolinolenic (14:3), palmitolinolenic (16:3), palmitidonic (16:4), α-linolenic (18:3), stearidonic (18:4), dihomo-α-linolenic (20:3), cicosatetraenoic (20:4), cicosapentaenoic (20:5), clupanodonic (22:5), docosahexaenoic (22:6), 9,12,15,18,21-tetracosapentaenoic (24:5), 6,9,12,15,18,21-tetracosahexaenoic (24:6), and mixtures or combinations thereof; (b) ω-5 unsaturated such as myristoleic (14:1), palmitovaccenic (16:1), α-eleostearic (18:3), β-eleostearic (trans-18:3) punicic (18:3), 7,10,13-octadecatrienoic (18:3), 9,12,15-eicosatrienoic (20:3), β-cicosatetraenoic (20:4), and mixtures or combinations thereof; (c) ω-6 unsaturated such as 8-tetradecenoic (14:1), 12-octadecenoic (18:1), linoleic (18:2), linolelaidic (trans-18:2), γ-linolenic (18:3), calendic (18:3), pinolenic (18:3), dihomo-linoleic (20:2), dihomo-γ-linolenic (20:3), arachidonic (20:4), adrenic (22:4), osbond (22:5), and mixtures or combinations thereof; (d) ω-7 unsaturated such as palmitoleic (16:1), vaccenic (18:1), rumenic (18:2), paullinic (20:1), 7,10,13-eicosatrienoic (20:3), and mixtures or combinations thereof; (e) ω-9 Unsaturated such as oleic (18:1), elaidic (trans-18:1), gondoic (20:1), crucic (22:1), nervonic (24:1), 8,11-eicosadienoic (20:2), mead (20:3), and mixtures or combinations thereof; (f) ω-10 Unsaturated such as Sapienic (16:1); (g) ω-11 unsaturated such as gadoleic (20:1); (h) ω-12 Unsaturated such as 4-Hexadecenoic (16:1) Petrosclinic (18:1) 8-Eicosenoic (20:1), and mixtures or combinations thereof; and (i) mixtures or combinations thereof.

### Diacids

Exemplary examples of saturate diacids include, without limitation, ethanedioic acid (oxalic acid), propanedioic acid (malonic acid), butanedioic acid (succinic acid), pentanedioic acid (glutaric acid), hexanedioic acid (adipic acid), heptanedioic acid (pimelic acid), octanedioic acid (suberic acid, nonanedioic acid (azelaic acid), decanedioic acid (sebacic acid), undecanedioic acid, dodecanedioic acid, tridecanedioic acid (brassylic acid), hexadecanedioic acid (thapsic acid), hencicosa-1,21-dioic acid (japanic acid), docosanedioic acid (phellogenic acid), triacontanedioic acid (equisetolic acid), and mixtures or combinations thereof. Exemplary examples of unsaturated diacids include, without limitation, (Z)-butenedioic acid (maleic acid), (E)-butenedioic acid (fumaric acid), (Z and E)-pent-2-enedioic acid (glutaconic acid), 2-decenedioic acid, dodec-2-enedioic acid (traumatic acid), (2E,4E)-hexa-2,4-dienedioic acid (muconic acid), and mixtures or combinations thereof.

### Poly Acids

Suitable poly carboxylic acid compounds for use in the present disclosure include, without limitation, any poly carboxylic acid compound. Exemplary examples of water immiscible poly acids include, without limitation, dicarboxylic acids having carbyl or carbenyl groups having between 8 and 50 carbon atoms and mixtures or combinations thereof. Polymer carboxylic acids or polymers including carboxylic acid groups, where the polymers are oil soluble or are oils, not miscible with water. Exemplary example of hydrophilic poly acids include, without limitation, polyacrylic acid, polymethacrylic acid, polylactic acid, polyglycol acid, mixtures and Corporation (a registered trademark of the Lubrizol Corporation), other carboxylic acid containing polymers, or mixtures or combinations thereof.

### Hydroxy Acids

Suitable hydroxy acids include, without limitation, 2-hydroxyoleic acid, 2-hydroxytetracosanoic acid (cerebronic acid), 2-hydroxy-15-tetracosenoic acid (hydroxynervonic acid), 2-hydroxy-9-cis-octadecenoic acid, 3-hydroxypalmitic acid methyl ester, 2-hydroxy palmitic acid, 10-hydroxy-2-decenoic acid, 12-hydroxy-9-octadecenoic acid (ricinoleic acid), 1,13-dihydroxy-tetracos-9t-enoic acid (axillarenic acid), 3,7-dihydroxy-docosanoic acid (byrsonic acid), 9,10-dihydroxyoctadecanoic acid, 9,14-dihydroxyoctadecanoic acid, 22-hydroxydocosanoic acid (phellonic acid), 2-oxo-5,8,12-trihydroxydodecanoic acid (phascolic acid), 9,10,18-trihydroxyoctadecanoic acid (phloionolic acid), 7,14-dihydroxydocosa-4 Z, 8,10,12,16Z,19Z-hexaenoic acid (Maresin 1), 5S,12R,18R-trihydroxy-6Z,8E,10E,14Z,16E-eicosapentaenoic acid (resolvin E1), resolvin D1, 10, 17S-docosatriene, (neuroprotectin D1).

### Downhole Fluid Compositions

Suitable downhole fluid composition for use in this disclosure include, without limitation, low viscosity or foam drilling fluid compositions, high viscosity drilling fluids, slick water fracturing compositions, high viscosity fracturing compositions, low viscosity completion fluid, high viscosity composition fluid, or any other downhole fluid, where drag reduction is needed.

### Downhole Fluid Composition Additives

Suitable downhole fluid additives include, without limitation, proppants, acids, diverting agents, fluid loss control additives, gas, nitrogen, carbon dioxide, surface modifying agents, tackifying agents, foamers, corrosion inhibitors, scale inhibitors, catalysts, clay control agents, biocides, antifoam agents, bridging agents, flocculants, H₂S scavengers, CO₂ scavengers, oxygen scavengers, lubricants, viscosifiers, breakers, weighting agents, relative permeability modifiers, resins, surfactants, wetting agents, coating enhancement agents, filter cake removal agents, antifreeze agents (e.g., ethylene glycol), and the like. A person skilled in the art, with the benefit of this disclosure, will recognize the types of additives that may be included in the fluids of the present disclosure for a particular application.

### Proppants

Suitable proppants for use in this disclosure include, without limitation, fly ash, silica, alumina, fumed carbon (e.g., pyrogenic carbon), carbon black, graphite, mica, titanium dioxide, metal-silicate, silicate, kaolin, talc, zirconia, boron, hollow microspheres (e.g., spherical shell-type materials having an interior cavity), glass, sand, bauxite, sintered bauxite, ceramics, sintered ceramics, calcined clays (e.g., clays that have been heated to drive out volatile materials), partially calcined clays (e.g., clays that have been heated to partially drive out volatile materials), composite polymers (e.g., thermoset nanocomposites), halloysite clay nanotubes, carbon nanotube containing materials, and any combination thereof. The proppants may be of any shape (regular or irregular) suitable or desired for a particular application. In certain embodiments, the proppants may be round or spherical in shape, although they may also take on other shapes such as ovals, capsules, rods, toroids, cylinders, cubes, or variations thereof. In other embodiments, the proppants may be relatively flexible or deformable, which may allow them to enter certain perforations, microfractures, or other spaces within a subterranean oil and/or gas bearing formation whereas solid particulates of a similar diameter or size may be unable to do so.

To facilitate a better understanding of the present disclosure, the following examples of certain aspects of particular embodiments are given. The following examples are not the only examples that could be given according to the present disclosure and are not intended to limit the scope of the disclosure or claims.

### Interface

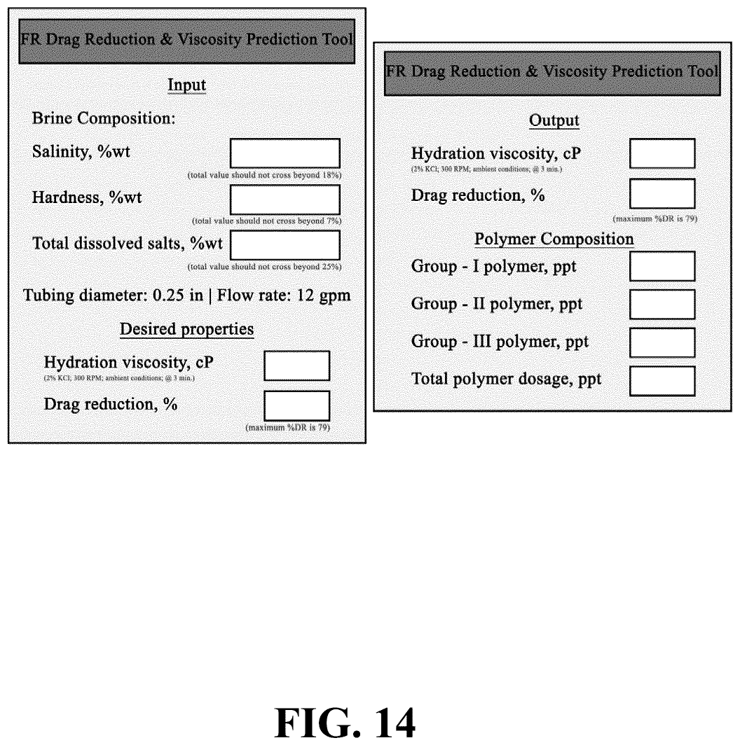

FIG. 14 depicts screen shots of a user interface for predicting an optimized friction reducing polymer composition based input data including water salinity, hardness, and total dissolved salts and desired properties such as hydration viscosity target value and percent drag reduction (% DR) producing output data including hydration viscosity target value, percent drag reduction (% DR) and polymer composition including amounts of Group I-III polymers calculated ppt values and total polymer ppt value.

### EXPERIMENTS OF THE DISCLOSURE

The following friction-reducing (FR) polymers used in the examples of this disclosure are tabulated in Table 1, which includes the polymer designation and line type used in the attached Figures:

TABLE 1
FR Polymer Samples Used in the Examples

| Sample | Line Type Used in Figures |
|---|---|
| FR0 | |
| FR1 | light grey solid line |
| FR2 | dark grey solid line |
| FR3 | black solid line |
| FR4 | black short dashed line |
| FR5 | black long dashed line |
| FR6 | black dash dot dash line |
| FR7 | black dash dot dot dash line |
| FR8 | black two short dashes one dot line |
| FR9 | black doted line |
| FR10 | n/a |
| FR11 | n/a |
| FR12 | n/a |
| FR13 | n/a |
| FR14 | n/a |
| FR15 | n/a |

Table 2 tabulates the nature of the FR polymers used in the examples below.

TABLE 2
FR Polymer Sample Categorization Based AMPS Content

| | Percent AMPS | |
|---|---|---|
| Sample Categorization | Content | Samples |
| APAM and Low | ≤5 | FR1, FR2, FR10 & FR15 |
| Sulfonated FR Polymers | | |
| Intermediate Sulfonated | >5 & ≤15 | FR3, FR8, FR9 & FR11 |
| FR Polymers | | |
| High Sulfonated FR | >15 | FR7, FR12, FR13 & FR14 |
| Polymers | | |

Table 3 tabulates three properties of the FR polymers used in the examples below.

TABLE 3
FR Polymer Sample Characterization
Based on Percent Sodium Acrylate and Sodium AMPS Content

| | | Percent Sodium | Percent Sodium | MW |
|---|---|---|---|---|
| Example # | Sample | Acrylate Content | AMPS Content | (MDa) |
| Control | FR0 | 29 | 0 | 15-17 |
| 1 | FR2 | 24.5 | 5 | 13-15 |
| 2 | FR3 | 21 | 10 | 12-14 |
| 3 | FR4 | 19 | 15 | 10-12 |
| 4 | FR6 | 15 | 25 | 9-11 |

### Examples 1-3

% DR value data was collected between 5 minutes and 10 minutes after fluid formation using the FR polymers, FR1, FR11, FR6, and FR7. Twenty one (21) runs were made for FR1, FR11, FR6, and FR7 resulting in 21 data sets. The 21 data sets were used to calculate 21 midpoint values for % DR for each of the 21 data sets. The 21 midpoint values were then used for modeling to determine a best equation for determining the relationship between % DR (percent drag reduction) and normalized molecular weight in Mda (MW, P₁), salinity (P₂), and percent sulfonation (P₃).

The 21 experimental midpoint % DR values were used to determine a working mathematical model for predicting % DR values from the salinity of a given base fluid, a FR polymer molecular weight, and % sulfonation of the FR polymer (i.e., percent AMPS monomers in the FR polymer).

### Example 1

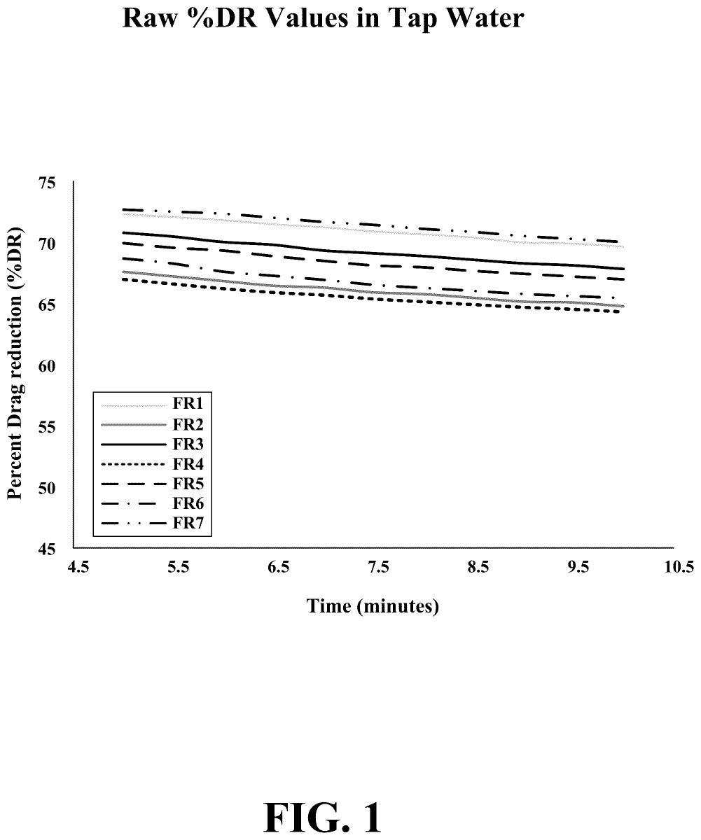

In this example, seven FR polymers were tested in a flow-loop apparatus, where measurements of percent drag reduction (% DR) in tap water versus time were determined. Looking at FIG. 1, a plot of raw flow-loop data of percent drag reduction (% DR) in tap water versus time for a variety of 2-acrylamido-2-methylpropane sulfonic acid (AMPS)-containing friction reducing (FR) polymer compositions is shown. The FR polymers tested in the example are FR1, FR2, FR3, FR4, FR5, FR6, and FR7, wherein the FR1 data is shown by a light grey solid line, the FR2 data is shown by a dark grey solid line, the FR3 data is shown by a black solid line, the FR4 data is shown by a short dashed black line, the FR5 data is shown by a black long dashed line, the FR6 data is shown by a black dash-dot-dash line, and the FR7 data is shown by a black dash-dot-dot-dash line. Looking at the data, the relative order of the FR polymers with respect to % DR in descending % DR values are FR7>FR1>FR3>FR5>FR6>FR2>FR4.

### Example 2

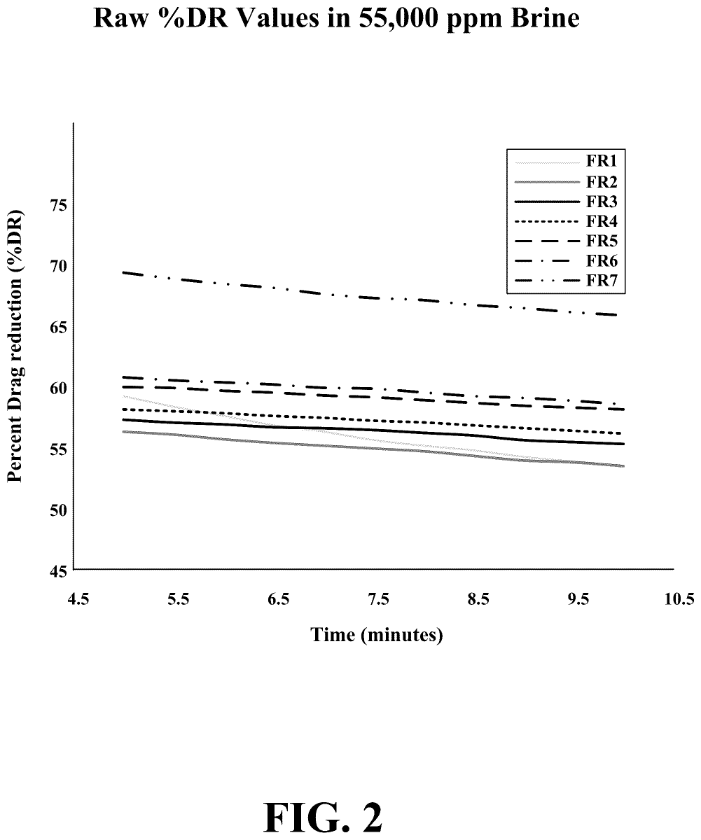

In this example, seven FR polymers were tested in a flow-loop apparatus, where measurements of percent drag reduction (% DR) in a 55,000 ppm brine versus time were determined. Looking at FIG. 2, a plot of raw flow-loop data of percent drag reduction (% DR) in 55,000 (55K) ppm brine versus time for a variety of AMPS-containing friction reducing polymer compositions is shown. The FR polymers tested in the example are FR1, FR2, FR3, FR4, FR5, FR6, and FR7, wherein the FR1 data is shown by a light grey solid line, the FR2 data is shown by a dark grey solid line, the FR3 data is shown by a black solid line, the FR4 data is shown by a short dashed black line, the FR5 data is shown by a black long dashed line, the FR6 data is shown by a black dash-dot-dash line, and the FR7 data is shown by a black dash-dot-dot-dash line. Looking at the data, the relative order of the FR polymers with respect to % DR in descending % DR values are FR7>>FR6>FR5>FR1>FR4>FR3>FR2. Please note that the % DR value for FR1 decreases faster over time compared to the other FR polymers. Changing from tap water to a 55K ppm brine, adversely affected the % DR values for FR polymer samples FR1 through FR6, with only a modest degree in % DR for FR7.

### Example 3

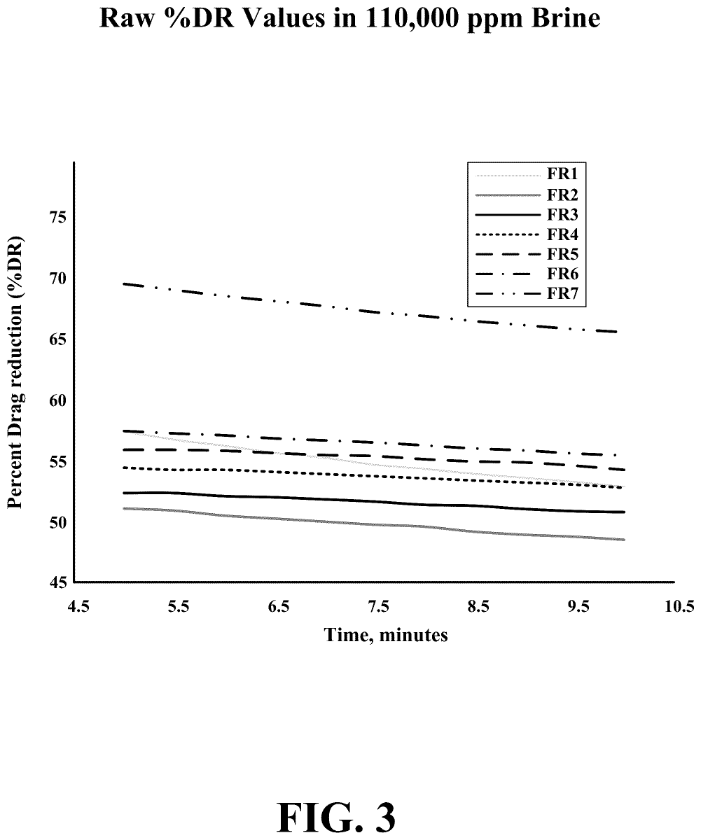

In this example, seven FR polymers were tested in a flow-loop apparatus, where measurements of percent drag reduction (% DR) in a 110,000 ppm brine versus time were determined. Looking at FIG. 3, a plot of raw flow-loop data of percent drag reduction (% DR) in 55,000 (55K) ppm brine versus time for a variety of AMPS-containing friction reducing polymer compositions is shown. The FR polymers tested in the example are FR1, FR2, FR3, FR4, FR5, FR6, and FR7, wherein the FR1 data is shown by a light grey solid line, the FR2 data is shown by a dark grey solid line, the FR3 data is shown by a black solid line, the FR4 data is shown by a short dashed black line, the FR5 data is shown by a black long dashed line, the FR6 data is shown by a black dash-dot-dash line, and the FR7 data is shown by a black dash-dot-dot-dash line. Looking at the data, the relative order of the FR polymers with respect to % DR in descending % DR values are FR7>>FR6˜FR1>FR5>FR4>FR3>FR2. Please note that the % DR value for FR1 decreases faster over time compared to the other FR polymers. Changing from tap water to a 110K ppm brine, adversely affected the % DR values for FR polymer samples FR1 through FR6 more than the 55K ppm brine, but not to the same extent as going from tap water to the 55K ppm brine. Again, % DR for FR7 was only a modestly reduced.

### Example 4

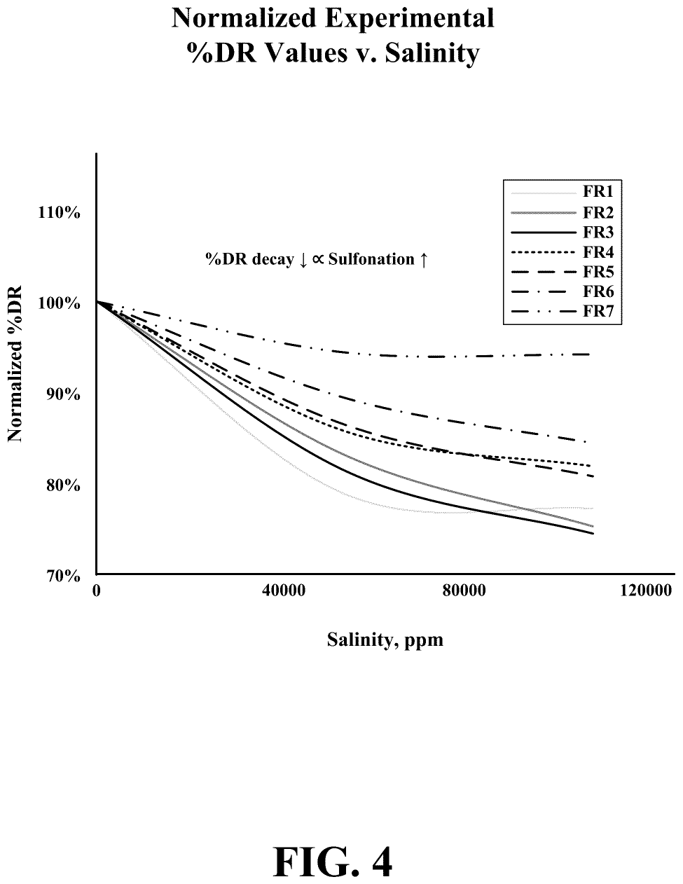

In this example, seven FR polymers were tested in a flow-loop apparatus, where measurements of normalized percent drag reduction (% DR) versus brine salinity in ppm were determined. Looking at FIG. 4, a plot of normalized experimental % DR versus salinity for the FR polymers FR1, FR2, FR3, FR4, FR5, FR6, and FR7 is shown. The FR1 data is shown by a light grey solid line, the FR2 data is shown by a dark grey solid line, the FR3 data is shown by a black solid line, the FR4 data is shown by a short dashed black line, the FR5 data is shown by a black long dashed line, the FR6 data is shown by a black dash-dot-dash line, and the FR7 data is shown by a black dash-dot-dot-dash line. Looking at the data, the relative order of the FR polymers with respect to normalized % DR in descending normalized % DR values are FR7>FR6>FR5>FR4>FR2>FR3>FR1. Please note that the FR4 data curve crosses the FR5 data curve at high salinity and that the FR1 data curves crosses the FR2 and FR3 curves. It should also be noted that % DR decreases as % sulfonation of the FR polymer increases.

### Example 5

In this example, the normalized experimental % DR data from Example 4 were compared to calculated % DR data generated by a computation system using molecular weight, salinity, and percent FR polymer sulfonation as independent variable for the seven FR polymers of Example 4 at three different salinity values 0 ppm, 55,000 ppm, and 110,000 ppm.

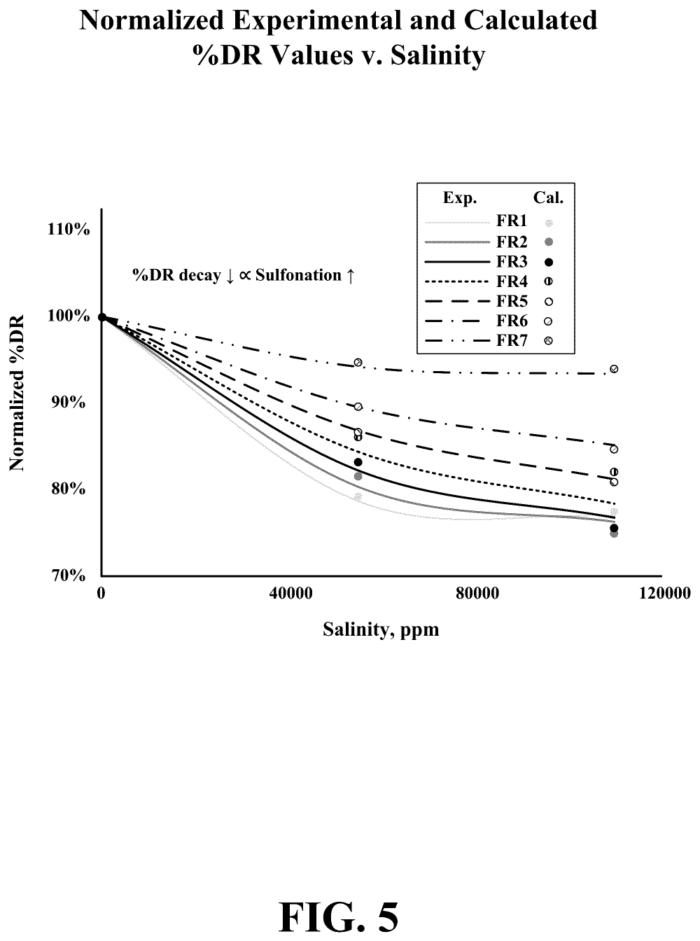

Looking at FIG. 5, a plot of the normalized experimental % DR values versus salinity for the FR polymers FR1, FR2, FR3, FR4, FR5, FR6, and FR7, wherein the FR1 data is shown by a light grey solid line, the FR2 data is shown by a dark grey solid line, the FR3 data is shown by a black solid line, the FR4 data is shown by a short dashed black line, the FR5 data is shown by a black long dashed line, the FR6 data is shown by a black dash-dot-dash line, and the FR7 data is shown by a black dash-dot-dot-dash line.

Looking again at FIG. 5, the calculated % DR values for FR1 are shown by light grey solid circles, the calculated % DR values for FR2 are shown by dark grey solid circles, calculated % DR values for FR3 are shown by black solid circles, the calculated % DR values for FR4 are shown by black outlined vertical line filled circles, calculated % DR values for FR5 are shown by black outlined left slated line filled circles, calculated % DR values for FR6 are shown by black outlined right slated line filled circles, and the calculated % DR values for FR1 are shown by black outlined cross-hashed filled circles.

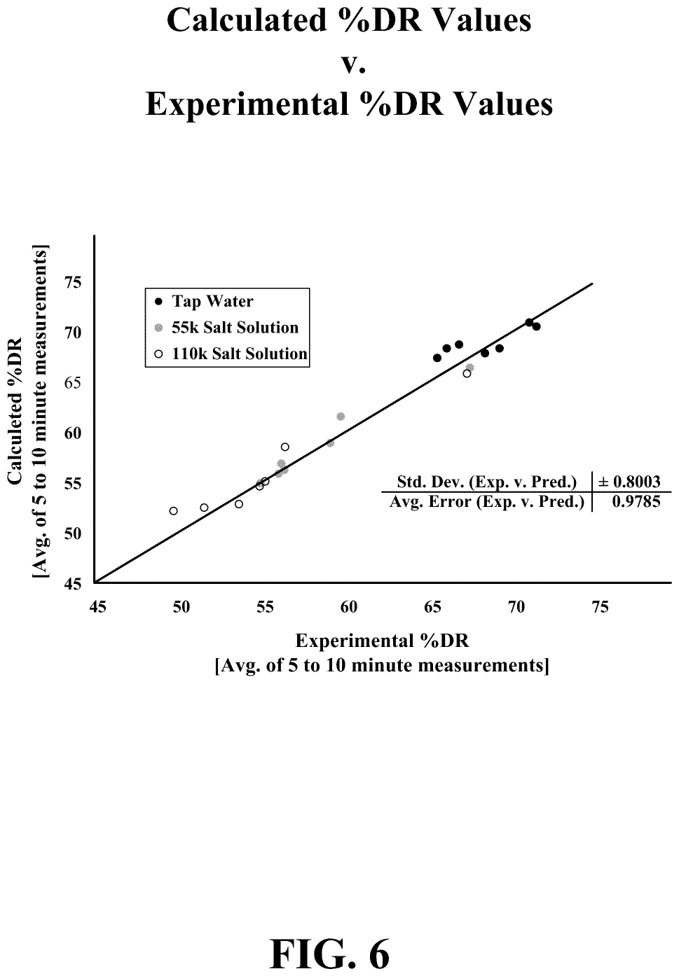

Referring now to FIG. 6, a best line fit derived from the normalized experimental % DR values versus the normalized calculated % DR values is shown having a standard deviation of experimental versus calculated of ±0.8003 and an average error of experimental versus calculated of 0.9785 for the data of Examples 1-5.

### Example 6

The molecular weight (MW) of the friction reducing polymers may be determined using various techniques for measuring polymer molecular weights including, without limitation, viscosity average molecular weight techniques, mass average molecular weight techniques, weight average molecular weight techniques, and/or volume average molecular weight techniques. In certain embodiments, the molecular weights of the friction reducing polymers were determined using a size 02 Ubbelohde viscometer measured @ 0° C.

The percent sulfonation values of the FR polymers, an indirect measure of AMPS monomer content of the FR polymers were determined using various either NMR, CHNS, or an equivalent method.

The concentration of monovalent and/or divalent salts in the base fluid (if unknown), au determined using various techniques including, without limitation, manual titration, digital titration, turbidity meter, inductively coupled plasma-optical emission spectrometry (ICP-OES), TDS meter, pH meter, and/or infrared analyzers.

The experimental studies for measuring percent drag reduction may be conducted at times up to 30 minutes after friction reducing polymer addition. In certain embodiments, the % DR was measured and predicted as an average of measurement made over a 5 to 10 minute time period after friction reducing polymer addition using a flow loop technique. These data were then used to formulate functions capable of calculating % DR values that conformed to the experimental data to an acceptable accuracy.

Table 4 tabulates experimental data on the four FR polymer composition FR1, FR2, FR3, and FR4 for use in determining the mathematical function that best accounts for the relationship of % DR and molecular weight of the FR polymers and the concentration of FR polymers in the FR polymer compositions:

TABLE 4
Experimental and Calculated % DR Value for Four FR Polymers

| | | Polymer | | | Brine | | | |
|---|---|---|---|---|---|---|---|---|
| | | Characteristics | | | Characteristics | | | |
| | | AMPS | MW | Conc. | Monovalent | Divalent | | |
| # | Sample | (%) | (MDa) | (ppt) | (ppm) | (ppm) | % DRₑₓₚₜ | % DR_{calcd} |
| 1 | FR01 | 0 | 18.9 | 1 | 75 | 75 | 69.4 | 69.5 |
| 2 | FR01 | 0 | 18.9 | 1 | 42000 | 13000 | 47.5 | 51.4 |
| 3 | FR01 | 0 | 18.9 | 1 | 85000 | 25000 | 42.8 | 40.4 |
| 4 | FR01 | 0 | 18.9 | 1 | 125000 | 55000 | 36.3 | 36.6 |
| 5 | FR02 | 12.5 | 20.5 | 1 | 75 | 75 | 70.7 | 69.8 |
| 6 | FR02 | 12.5 | 20.5 | 1 | 42000 | 13000 | 56.8 | 56.2 |
| 7 | FR02 | 12.5 | 20.5 | 1 | 85000 | 25000 | 50.9 | 47.4 |
| 8 | FR02 | 12.5 | 20.5 | 1 | 125000 | 55000 | 43.3 | 41.5 |
| 9 | FR03 | 25 | 12.3 | 1 | 75 | 75 | 65.8 | 65.7 |
| 10 | FR03 | 25 | 12.3 | 1 | 42000 | 13000 | 52.2 | 55.4 |
| 11 | FR03 | 25 | 12.3 | 1 | 85000 | 25000 | 48.6 | 48.6 |
| 12 | FR03 | 25 | 12.3 | 1 | 125000 | 55000 | 41.6 | 42.5 |
| 13 | FR04 | 32.6 | 16.4 | 1 | 75 | 75 | 70.0 | 68.6 |
| 14 | FR04 | 32.6 | 16.4 | 1 | 42000 | 13000 | 60.2 | 58.7 |
| 15 | FR04 | 32.6 | 16.4 | 1 | 85000 | 25000 | 54.8 | 52 |
| 16 | FR04 | 32.6 | 16.4 | 1 | 125000 | 55000 | 43.6 | 46.1 |
| 17 | FR04 | 32.6 | 16.4 | 0.9 | 98860 | 68563 | 50.6 | 47.3 |
| 18 | FR04 | 32.6 | 16.4 | 1.2 | 98860 | 68563 | 56.6 | 50.8 |
| 19 | FR04 | 32.6 | 16.4 | 1.8 | 98860 | 68563 | 60.6 | 55.2 |
| 20 | FR04 | 32.6 | 16.4 | 2.4 | 98860 | 68563 | 60.9 | 56.0 |

### Example 7

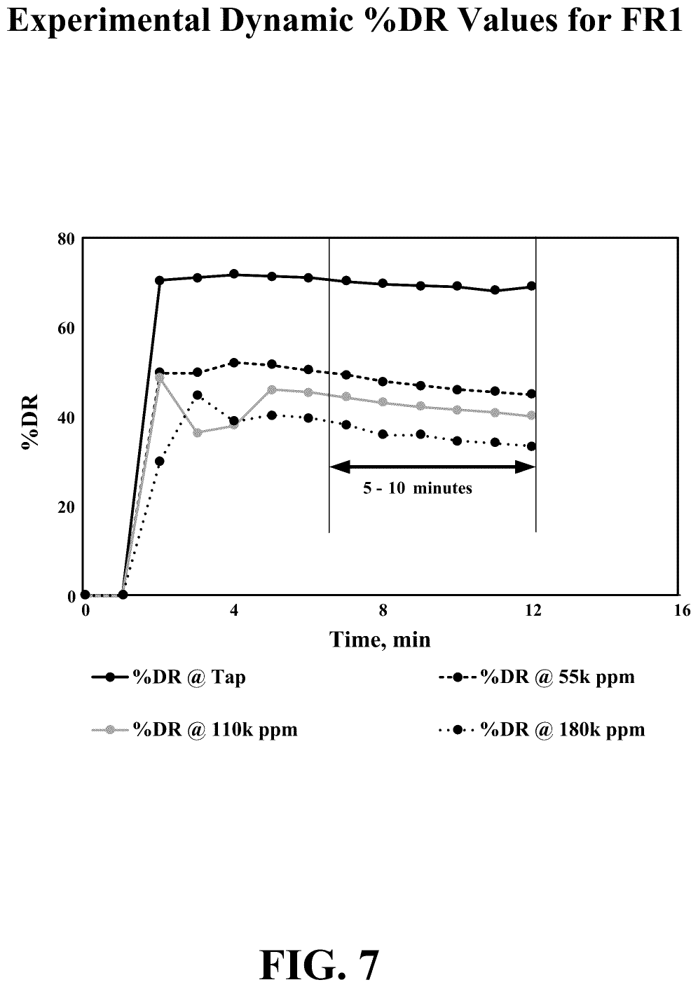

In this example, experimental dynamic % DR values were determined using a flow-loop apparatus for FR1 over a 12 minute period of time, with data being collected between 5 minutes and 10 minutes in tap water, a 55K brine, a 110K brine, and a 180 k brine. Looking at FIG. 7, a plot of the % DR values are shown over the 12 minute period. The data shows that % DR value decreases as the salinity of the brine increases at least in the 5 to 12 minute period.

### Example 8

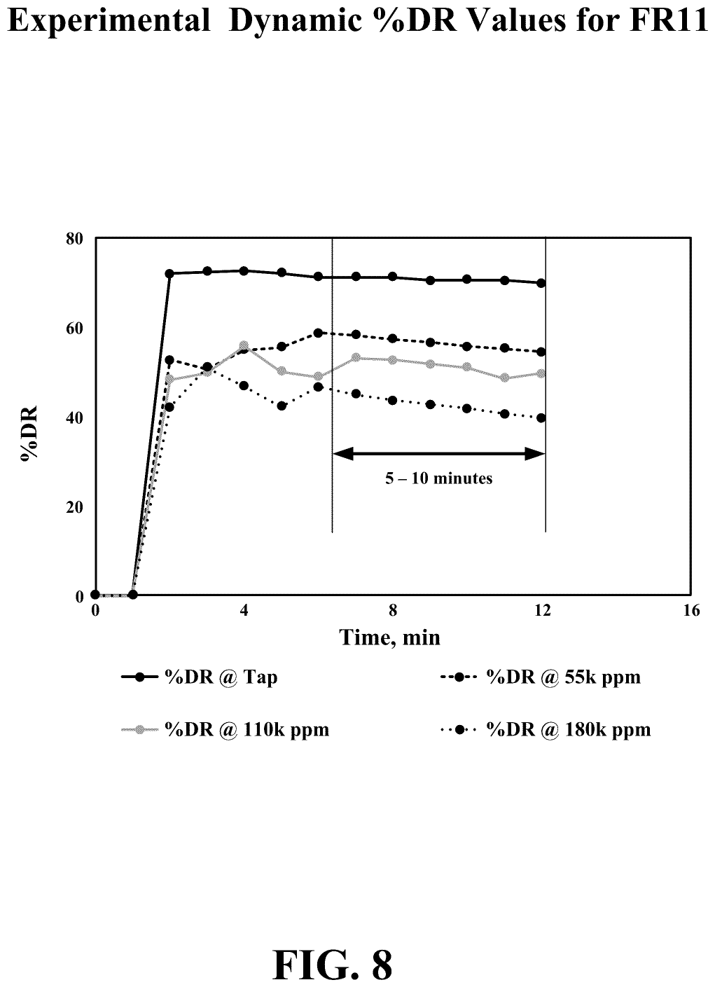

In this example, experimental dynamic % DR values were determined using a flow-loop apparatus for FR11 over a 12 minute period of time, with data being collected between 5 minutes and 10 minutes in tap water, a 55K brine, a 110K brine, and a 180K brine. Looking at FIG. 8, a plot of the % DR values are shown over the 12 minute period. The data shows that % DR value decreases as the salinity of the brine increases at least in the 5 to 12 minute period.

### Example 9

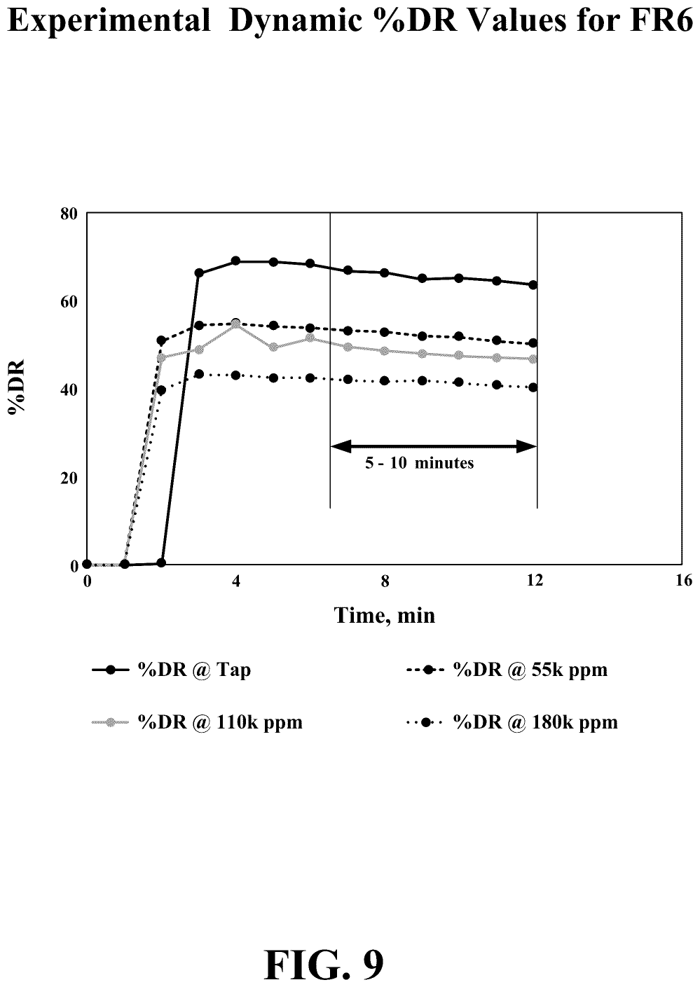

In this example, experimental dynamic % DR values were determined using a flow-loop apparatus for FR6 over a 12 minute period of time, with data being collected between 5 minutes and 10 minutes in tap water, a 55 k brine, a 110 k brine, and a 180 k brine. Looking at FIG. 9, a plot of the % DR values are shown over the 12 minute period. The data shows that % DR decrease as the salinity of the brine increases at least in the 5 to 12 minute period.

### Example 10

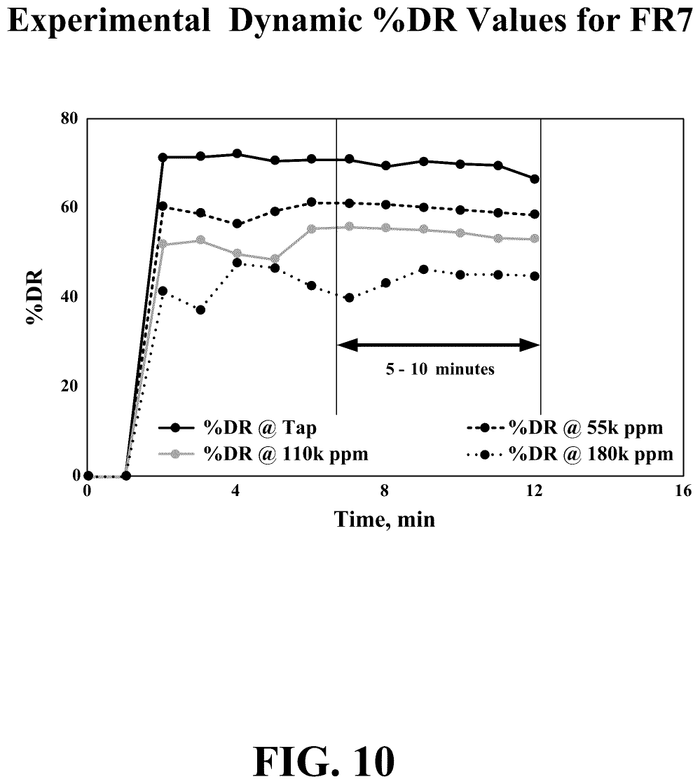

In this example, experimental dynamic % DR values were determined using a flow-loop apparatus for FR7 over a 12 minute period of time, with data being collected between 5 minutes and 10 minutes in tap water, a 55 k brine, a 110 k brine, and a 180 k brine. Looking at FIG. 10, a plot of the % DR values are shown over the 12 minute period. The data shows that % DR value decreases as the salinity of the brine increases at least in the 5 to 12 minute period.

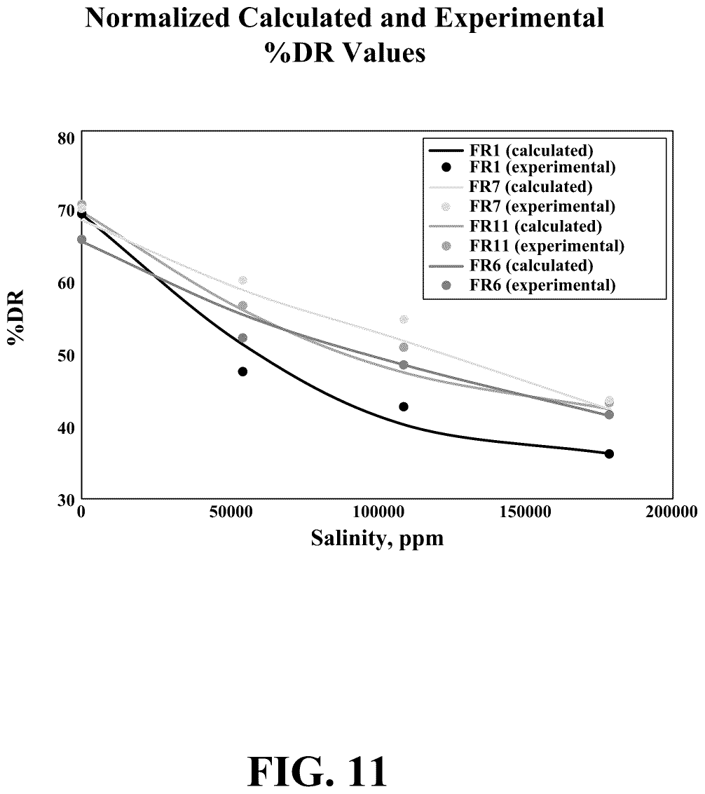

Referring now to FIG. 11, a plot of the normalized experimental and calculated % DR values of Examples 6-9 versus salinity is shown.

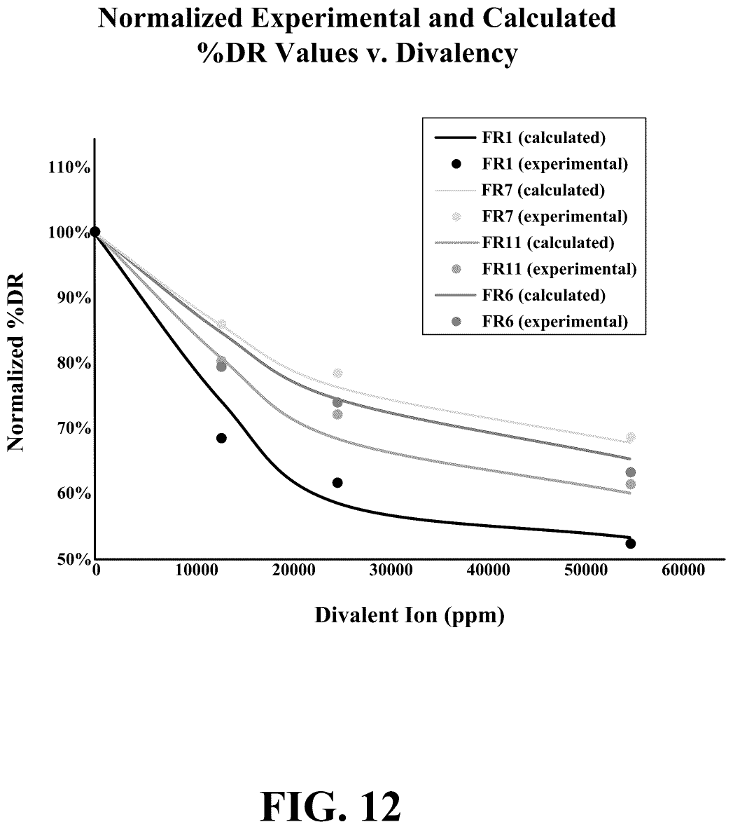

Referring now to FIG. 12, a plot of the normalized experimental and calculated % DR values of Examples 6-9 versus divalency is shown.

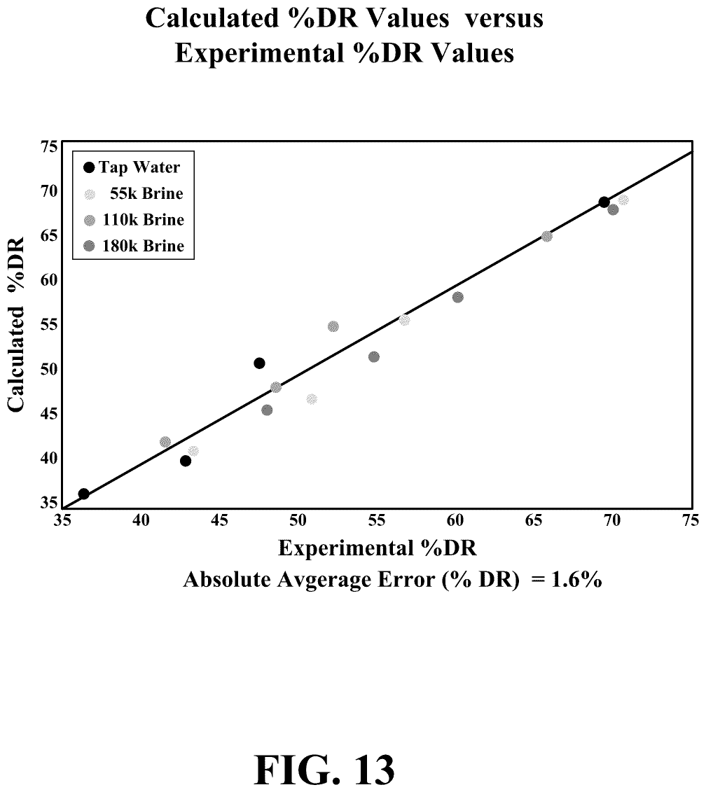

Referring now to FIG. 13, a best line fit derived from the normalized experimental % DR values versus the normalized calculated % DR values is shown having a standard deviation of experimental versus calculated of ±0.8003 and an average error of experimental versus calculated of 0.9785 for the data of Examples 6-9.

### Example 11

### Derivation of Computational Model

From the data tabulated in Table 4, the functional form of the function ƒ₁ was determined to be expressed as an exponential function of the form of the Equations (3) or (3a):

$${f}_{1} ( M W ) = 1 - ( \frac{1}{{e}^{( {C}_{M W} \times M W )}} ) \qquad ( 3 )$$

$${f}_{1} ( M W ) = 1 - ( \frac{1}{{e}^{( \frac{{Z}_{M W} \times M W}{20.5} )}} ) \qquad ( 3 a )$$

MW is the molecular weight of the FR polymers having a real numeric value between about 0.5 and about 25.00 MDa (mega Daltons), including any subrange or any specific value within the range, and
C_{MW} is a real number constant having a value between about 0.0195 and about 1.9512, including any subrange or any specific value within the range, or
Z_{MW} is a real number constant having a value between about 0.4 and 40.0 including any subrange or any specific value within the range.

From the data tabulated in Table 4 and the data shown in FIG. 6-9, the functional form of the function ƒ₂ was determined to be expressed as linear functions of the form of the Equations (4) or (4a):

$${f}_{2} ( [ MVI ] ) = 1 - ( {C}_{MVI} \times [ MVI ] ) \qquad ( 4 )$$

$${f}_{2} ( [ MVI ] ) = 1 - ( \frac{{Z}_{MVI} \times [ MVI ]}{180000} ) \qquad ( 4 a )$$

wherein:
[MVI] is the concentration of monovalent metal ions in the base fluid having a real numeric value between about 10 and about 250,000 ppm, including any subrange or any specific value within the range, and
Cₘₒₙₒ is a real valued constant having a value ranging between about 5.556×10⁻⁹ and 5.556×10⁻⁷, including any subrange or any specific value within the range, or
Zₘₒₙₒ having a real numeric value between about 0.001 and 0.100 including any subrange or any specific value within the range.

From the data tabulated in Table 4 and the data shown in FIG. 6-9, the functional form of the function ƒ₃ was determined to be expressed as polynomial functions of Equation (5) and (5a):

$${f}_{3} ( [ DVI ] , \% S ) = 1 + {\sum }_{i = 1}^{3} {( {\sum }_{j = 0}^{3} {C}_{DVIij} \times {( \% S )}^{j} ) [ DVI ]}^{i} \qquad ( 5 )$$

$${f}_{3} ( [ DVI ] , \% S ) = 1 + {\sum }_{i = 1}^{2} {( {\sum }_{j = 0}^{2} {C}_{DVIij} \times {( \% S )}^{j} ) [ DVI ]}^{i} \qquad ( 5 a )$$

wherein
[DVI] is the concentration of monovalent metal ions in the base fluid having a real numeric value between about 1 and about 100,000 ppm, including any subrange or any specific value within the range,
% S is a measure of the amount of AMPS monomer units in the FR polymers,
C_{DVI10} is a real number constant having a value between about −2×10⁻⁶ and about −2×10⁻⁴,
C_{DVI11} is a real number constant having a value between about 5×10⁻⁸ and about 5×10⁻⁶
C_{DVI12} is a real number constant having a value between about −8×10⁻¹⁰ and about −8×10⁻⁸
C_{DVI13} is a real number constant having a value less than ±1×10⁻¹⁰,
C_{DVI20} is a real number constant having a value between about 2×10⁻¹¹ and about 2×10⁻⁹
C_{DVI12} is a real number constant having a value between about 8×10⁻¹³ and about 8×10⁻¹¹,
C_{DVI22} is a real number constant having a value between about 1×10⁻¹¹ and about 1×10⁻¹², and
C_{DVI23} is a real number constant having a value less than ±1×10⁻¹³.

From the data tabulated tabulated in Table 4 and the data shown in FIG. 6-9, the functional form of the function ƒ₄ was determined to be expressed as polynomial functions of Equation (6) and (6a):

$${f}_{4} ( [ FRP ] ) = {\sum }_{k = 0}^{3} {{C}_{F R P k} [ F R P ]}^{k} \qquad ( 6 )$$

$${f}_{4} ( [ FRP ] ) = {\sum }_{k = 0}^{2} {{C}_{F R P k} [ F R P ]}^{k} \qquad ( 6 a )$$

wherein:
[FRP] is the concentration of FR polymers,
C_{FRP0} is a real number constant having a value between about 0.06 and about 6.00,
C_{FRP1} is a real number constant having a value between about 0.04 and about 4.00,
C_{FRP2} is a real number constant having a value between about −1.00 and about −0.01, and
C_{FRP3} is a real number constant having a value less than ±0.01.

### Example 12

The following experiments studying the physics-based/ML modeling of % drag reduction (% DR) in response to (i) pH, (ii) ferric (Fe³⁺) management, and (iii) guar-acrylamide compatibility.

The examples are designed to test the following information concerning % DR as shown in the following table:

| Test parameters | Remarks | Modeling approach |
|---|---|---|
| Re ≈ 140,000 | temperature (T), | % DR = f(fluid salinity, |
| Salinity-150 ppm to | polymer concentration | sulfonic substitution) |
| 110,000 ppm | (pc), polymer ionicity | |
| ATBS-5% to 25% | (pi) are constant. | |
| MW-7.5 MDa to | % DR measured by | |
| 7.8 MDa | flow-loop. | |

The examples are consistent with Equations (7a&b):

$${W}_{ι}^{br} = \{ 1 - ( \frac{\sum {C}_{i} \times {𝓏}_{i}^{2}}{\sum {C}_{i - sat} \times {𝓏}_{i}^{2}} ) \} \times \frac{{( {aN}^{0.6} )}^{3}}{{k}_{B} T} \times {μ}_{s} \times \frac{8 u}{d} \qquad ( 7 a )$$

$$( for Re \geq {Re}_{crit} and {W}_{ι}^{br} \geq {W}_{{ι}_{onset}}^{br} \qquad ( 7 b )$$

$$\frac{\% DR}{\% {DR}_{MDR}} = 1 - \frac{2}{1 + {e}^{( \frac{{W}_{ι}^{br} \geq {W}_{{ι}_{onset}}^{br}}{w} )}}$$

wherein
Re≈140,000,
Salinity—150 to 110,000 ppm,
ATBS—5 to 25%, and
MW—7.5 to 7.8 MDa.

These examples are designed to model % DR based on the general Equation (1):

$$\% DR = C \times {f}_{1} ( M W ) \times {f}_{2} ( m v ) \times {f}_{3} ( d v , \% s ) \times {f}_{4} ( p c ) \qquad ( 1 )$$

wherein % DR is percent drag reduction, C is a proportionality constant, MW is molecular weight, mv is monovalent ion concentration, dv is divalent ion concentration, % s is a percentage of sulfonation of polymer (i.e., a measure of the amount of, and pc is polymer concentration.

The function of ƒ₃ was shown to behave according to Equation (8):

$${f}_{3} ( dv , \% s ) = 1 + ( {𝓏}_{dv , 1} \times {C}_{dv} ) + ( {𝓏}_{dv , 2} \times {C}_{dv}^{2} ) \qquad ( 8 )$$

$${C}_{dv} = ppm of {CaCl}_{2} + ( x \times ppm of {MgCl}_{2} ) , \qquad ( 8 a )$$

$${𝓏}_{dv , 1} = {𝓏}_{dv , 1 , S \text{.1}} + ( {𝓏}_{dv , 1 , S \text{.2}} \times \% s ) + ( {𝓏}_{dv , 1 , S \text{.3}} \times \% {s}^{2} ) \qquad ( 8 b )$$

$${𝓏}_{dv , 1 , S , 1} is 1.3 \times 1 {0}^{- 13} ,$$

$${𝓏}_{dv , 1 , S , 2} is \text{-8} \text{.813} \times 1 {0}^{- 12} ,$$

$$and$$

$${𝓏}_{dv , 1 , S , 3} is 2.69971 \times 1 {0}^{- 10}$$

$${𝓏}_{dv , 2} = {𝓏}_{dv , 2 , S \text{.1}} + ( {𝓏}_{dv , 2 , S \text{.2}} \times \% s ) + ( {𝓏}_{dv , 2 , S \text{.3}} \times \% {s}^{2} ) \qquad ( 8 c )$$

$${𝓏}_{dv , 2 , S , 1} is \text{-8} \text{.03} \times 1 {0}^{- 9} ,$$

$${𝓏}_{dv , 2 , S , 2} is 5.94304 \times 1 {0}^{- 7} ,$$

$$and$$

$${𝓏}_{dv , 2 , S , 3} is - 2.3354 \times 1 {0}^{- 5}$$

| Applicable Parameters | Range of Values |
|---|---|
| MW (polymer molecular weight in MDa) | 0.5-25 |
| % s (sulfonic acid groups in polymer in wt. %) | 0.1-45 |
| C_{pc} (polymer concentration in ppt) | 0.1-5 |
| Cₘᵥ (monovalent salt concentration in ppm) | 10-250,000 |
| C_{dv} (divalent salt concentration in ppm) | 1-100,000 |

These examples are designed to study: (a) viscosity/viscoelasticity as a function of fluid salinity (i.e., monovalent ion concentration and divalent ion concentration) and polymer properties; (b) pH and buffer additive effects such as pH adjustment using treatments of (i) caustic soda (ii) caustic soda and soda ash, pH variation on fluid ionic composition, and pH effects on % DR and viscosity; (c) trivalent ion (Fe) and chelating agent effects on % DR and viscosity, wherein the chelating agents include EDTA, NTA, citric acid, hydrogen peroxide, etc.; (d) APAM/SPAM and guar compatibility effects on % DR and viscosity, wherein the guar include various grades of guar for viscosity management along with different APAM/SPAM polymers (% DR management); and (e) creating modeling from the experimental data.

These examples are designed to study: (f) rheology data and modeling based on viscosity and visco-elasticity properties of the FR polymers; and (g) FR polymer and brine performance properties in industry-standard (IS) brines, wherein the FR polymers include FR1, FR11, FR6, and FR7 polymers and the brines include monovalent brines having salinity values between 10 ppm, 150 ppm, 55K ppm, 110K ppm, and 180K ppm and industry standard (IS) brines set forth in the following table:

Industry Standard (IS) Brines

| | 55K IS Brine | 110K IS Brine | 180K IS Brine |
|---|---|---|---|
| Salt | (ppm) | (ppm) | (ppm) |
| NaCl | 42,000 | 85,000 | 125,000 |
| CaCl₂ | 10,000 | 25,000 | 45,000 |
| MgCl₂ | 3,000 | 0 | 10,000 |

The polymer concentration was held at 20 ppt (i.e., 0.6 g in 250 mL) using a testing protocol of forty-five seconds (45 s) brine mixing and seventy-five seconds (75 s) polymer mixing @ 3000 RPM. Viscosity values were measured using a FANN 35SA viscometry model: R1-B1 configured to operate @300 RPM shear rate at ambient temperature.

The viscosity of two different FR polymers were measured in different monovalent brines to determine the effects of monovalent brine salinity and FR polymer properties on viscosity measured in Cp's. The two FR polymers were FR1 included no AMPS monomers and a molecular weight of 18.9 MDa and FR11 included 12.5 wt. % of AMPS monomers and a molecular weight of 20.5 MDa. The results are set forth in the table below:

Viscosity Values of the FR1 and FR11 in Different NaCl Brines

| | | Polymer | | | NaCl Brine | | |
|---|---|---|---|---|---|---|---|
| | | Characteristics | | | Characteristics | | |
| | | AMPS | MW | | mv^{†} | dv^{‡} | Viscosity |
| # | Name | (%) | (MDa) | DoH* | (ppm) | (ppm) | (Cp) |
| 1 | FR1 | 0 | 18.9 | 29.7 | 10 | 0 | 25 |
| 2 | FR1 | 0 | 18.9 | 29.7 | 150 | 0 | 17 |
| 3 | FR1 | 0 | 18.9 | 29.7 | 55000 | 0 | 8 |
| 4 | FR1 | 0 | 18.9 | 29.7 | 110000 | 0 | 9 |
| 5 | FR1 | 0 | 18.9 | 29.7 | 180000 | 0 | 10.7 |
| 6 | FR11 | 12.5 | 20.5 | 21.8 | 10 | 0 | 24 |
| 7 | FR11 | 12.5 | 20.5 | 21.8 | 150 | 0 | 17 |
| 8 | FR11 | 12.5 | 20.5 | 21.8 | 55000 | 0 | 8 |
| 9 | FR11 | 12.5 | 20.5 | 21.8 | 110000 | 0 | 10 |
| 10 | FR11 | 12.5 | 20.5 | 21.8 | 180000 | 0 | 13 |

^{†}mv means monovalent ions and
^{‡}dv means divalent ions.

These experiments run using a 20K NaCl only brine were used to determine boundary values for exponential decay and linear rise.

The test runs listed above showed that: (1) changing from distilled water (10 ppm NaCl) to tap-water (150 NaCl) resulted in a sharp exponential drop in viscosity by about 33%; (2) changing from tap-water (150 NaCl) to a 55K IS brine resulted in a further sharp exponential drop in viscosity by about 68%, and (3) changing from a 55K IS brine to a 180K IS brine resulted in a slow linear rise in viscosity. Comparing the a FR polymer (FR1) containing no AMPS monomer units to a FR polymer (FR11) including 12.5 wt. % AMPS showed very little different in viscosity values and viscosity reductions were similar.

The viscosity of two different FR polymers were measured in different monovalent brines to determine the effects of monovalent brine salinity and FR polymer properties on viscosity measured in Cp's. The two FR polymers were FR6 included 25 wt. % of AMPS monomers and had a molecular weight of 12.3 MDa and FR7 included 32.6 wt. % of AMPS monomers and had a molecular weight of 16.4 MDa. The results are set forth in the table below:

Viscosity Values of the FR6 and FR7 in Different NaCl Brines

| | | Polymer | | | NaCl Brine | | |
|---|---|---|---|---|---|---|---|
| | | Characteristics | | | Characteristics | | Viscosity |
| # | Name | AMPS (%) | MW (MDa) | DoH* | mv^{†} (ppm) | dv^{‡} (ppm) | (Cp) |
| 11 | FR6 | 25 | 12.3 | 18.6 | 10 | 0 | 13 |
| 12 | FR6 | 25 | 12.3 | 18.6 | 150 | 0 | 4 |
| 13 | FR6 | 25 | 12.3 | 18.6 | 55000 | 0 | 2 |
| 14 | FR6 | 25 | 12.3 | 18.6 | 110000 | 0 | 2 |
| 15 | FR6 | 25 | 12.3 | 18.6 | 180000 | 0 | 2 |
| 16 | FR7 | 32.6 | 16.4 | 9.6 | 10 | 0 | 24 |
| 17 | FR7 | 32.6 | 16.4 | 9.6 | 150 | 0 | 15 |
| 18 | FR7 | 32.6 | 16.4 | 9.6 | 55000 | 0 | 7 |
| 19 | FR7 | 32.6 | 16.4 | 9.6 | 110000 | 0 | 8 |
| 20 | FR7 | 32.6 | 16.4 | 9.6 | 180000 | 0 | 9 |

^{†}mv means monovalent ions and
^{‡}dv means divalent ions.

The test runs listed above showed that for the low molecular weight FR polymer FR6, the initial viscosity is significantly lower as the salinity of the brine increase, but plateaus at 2 Cp, while the higher molecular weight FR polymer FR7 has a slower reduction in viscosity and rises slightly have the initial viscosity dip.

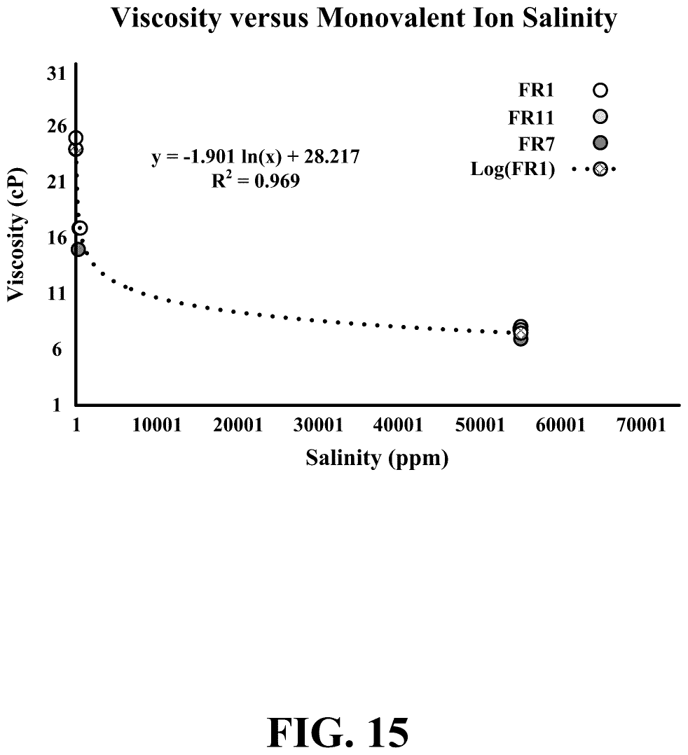

Referring now to FIG. 15, a plot of viscosity values in cPs versus monovalent brine salinity values for three different FR polymers, FR1, FR11, and FR7, is shown evidencing the rapid decay in viscosity as salinity increases followed by a leveling out of the viscosity to a plateau or an asymptote. This viscosity decay behavior for FR1 may be modeled in accord with a logarithmic function given by Equation (9):

$$y = - 1.901 ln ( x ) + 28.217 \qquad ( 9 )$$

wherein the logarithmic function as an R² value of 0.969.

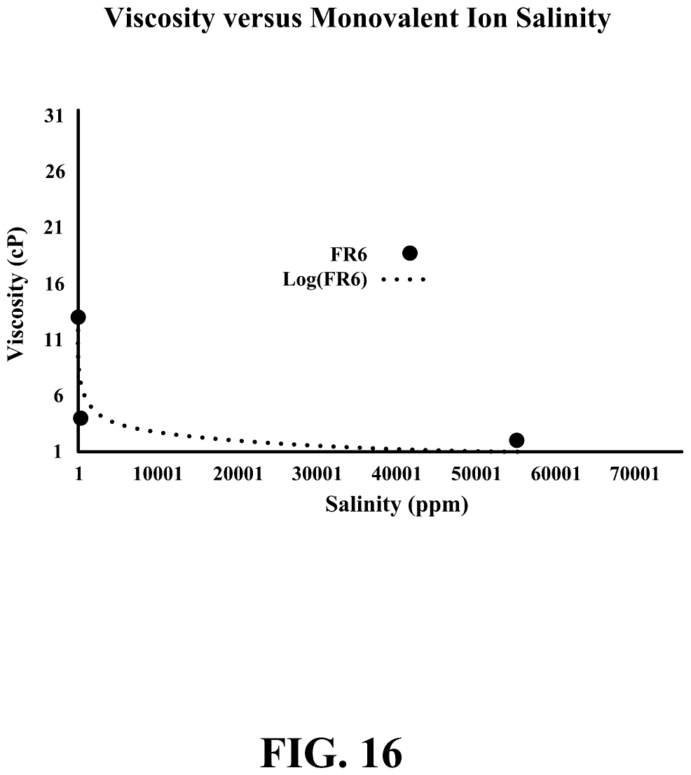

Referring now to FIG. 16, a plot of viscosity values in cPs versus monovalent brine salinity values for FR6 is shown evidencing the rapid decay in viscosity as salinity increases followed by a leveling out of the viscosity. This viscosity decay behavior for FR6 may also be modeled in accord with a logarithmic function. It should also be noted that FR6 is a lower molecular weight FR polymer than FR1, FR7, and FR11 and therefore drops to a lower final viscosity plateau.

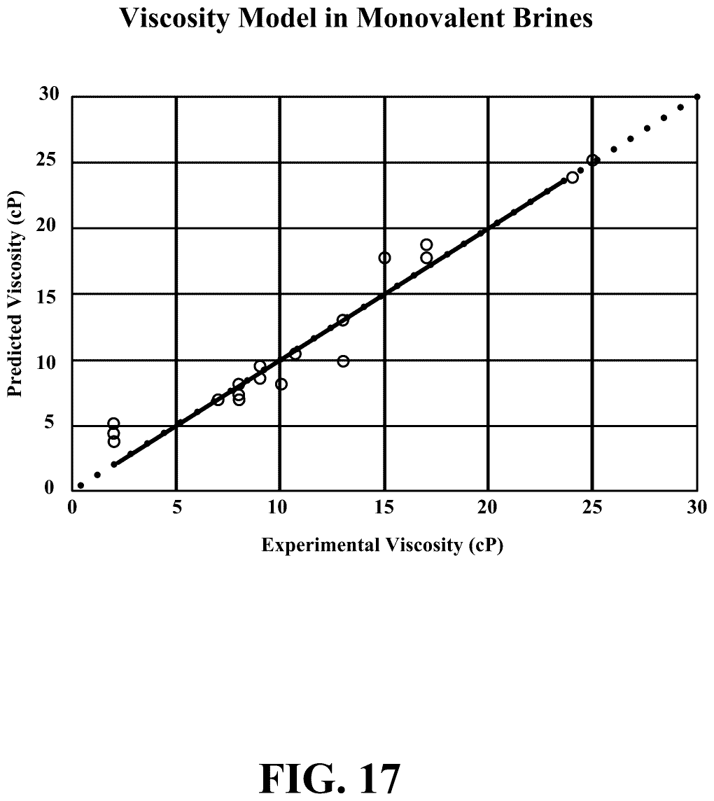

Referring now to FIG. 17, a plot of experimental viscosity values versus predicted viscosity values based on Equation (10)

$$Viscosity ( cP ) = C \times {f}_{1} ( M W ) \times \underline{{f}_{2}} ( mv ) \qquad ( 10 )$$

where MW is molecular weight and mv is the concentration of monovalent ions. The viscosity function is set forth in logarithmic viscosity behaviors shown in FIGS. 15 and 16.

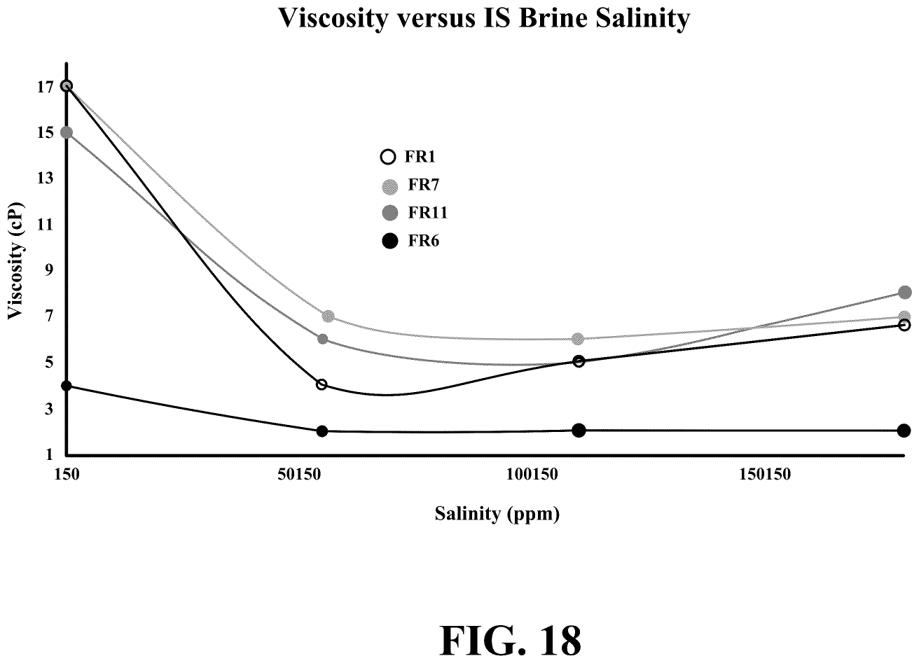

Referring now to FIG. 18, plots of viscosity versus salinity for four FR polymers, FR1, FR6, FR7, and FR11 in IS brines. The plots show that sulfonic acid substitution (i.e., wt. % AMPS in FR polymers) provides higher final viscosity values in the IS brines for the higher molecular weight FR polymers, FR7 and FR11 compared to FR1, which as no AMPS monomers in the FR polymer. It should also be noticed that the lower molecular FR6 shows little change in viscosity values over the entire salinity range studied. To better determine the interplay between sulfonic acid substitution or wt. % of AMPS in the FR polymers and divalent ion concentration (dv), additional experiments were undertaken and discussed herein.

Visco-elastic properties were analyzed to be determine storage modulus (G′) measured in Pa and loss modulus (G″) measured in Pa for different FR polymers in different brine systems. These studies will allow the modeling of the behavior of FR polymers in low-salinity brines, wherein such FR polymers are tangibly viscoelastic and low-shear viscosity responses may also be deduced from the rheometer data derived from a rheometer.

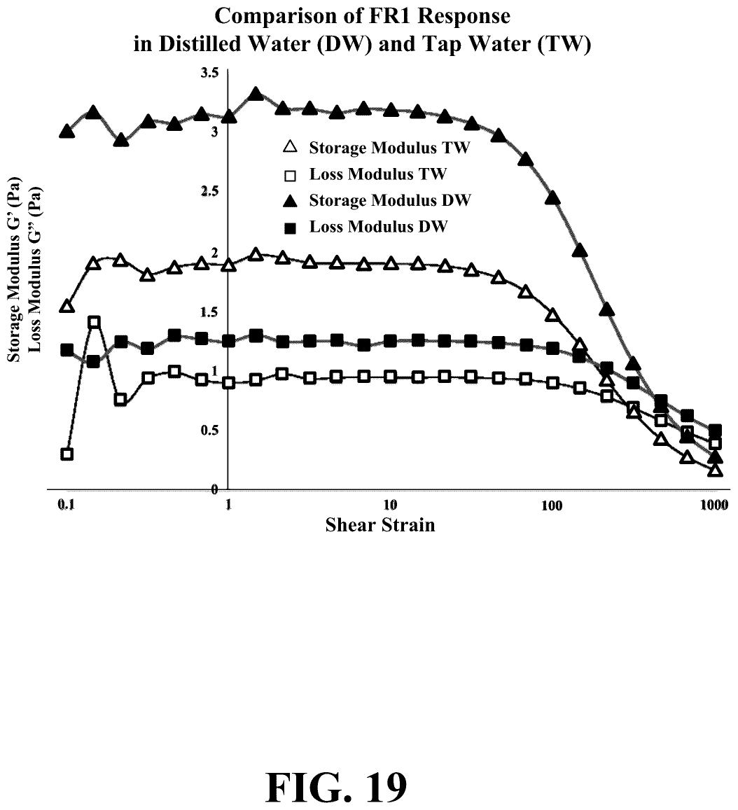

Referring now to FIG. 19, a plot of storage modulus (G′) and loss modulus (G″) versus shear strain for FR1 in distilled water and tap water. The plot shows that there is a large difference between the loss modulus G″ and the storage modulus G′ for FR1 in distilled water and a smaller difference between the loss modulus G″ and storage modulus G′ for FR1 in tap water. Thus, even modest changes in salinity significantly change the differences between storage and loss moduli G′ and G″, respectfully.

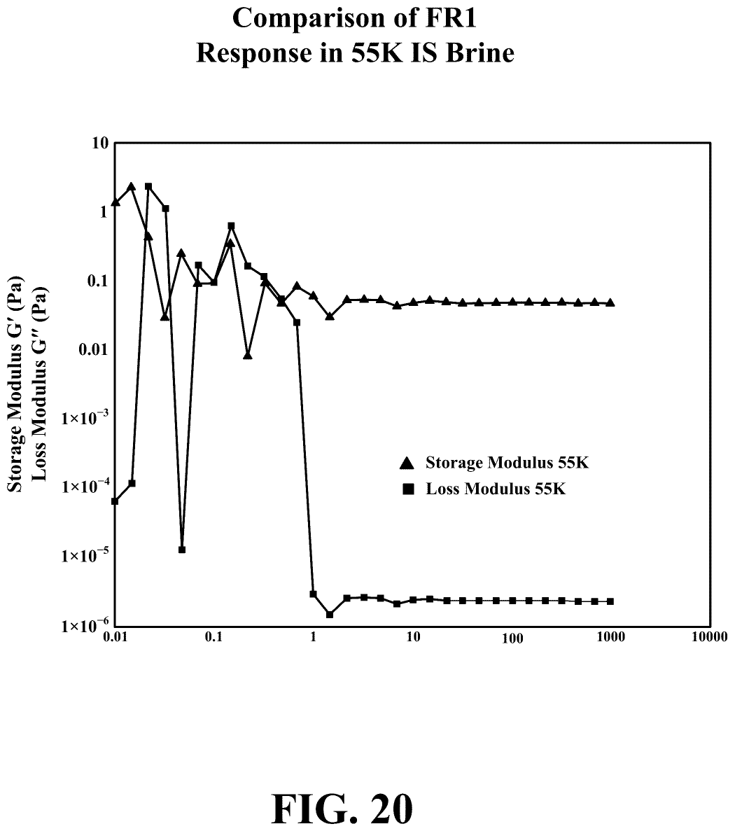

Referring now to FIG. 20, a plot of storage modulus (G′) and loss modulus (G″) versus shear strain for FR1 in a 55K IS brine. The plot shows that the loss modulus G″ falls of at a shear strain value of log land the storage modulus G′ for FR1 in the 55K IS brine remains substantially constant after a strain of about log 1.

The data in FIGS. 19 and 20 show that the storage modulus G′ sequence for FR1 system is G′ in distilled water >G′ in tap water >G′ in the 55 k IS brine. Thus, the fluid system loses elasticity at 55 k IS brine where G″>G′.

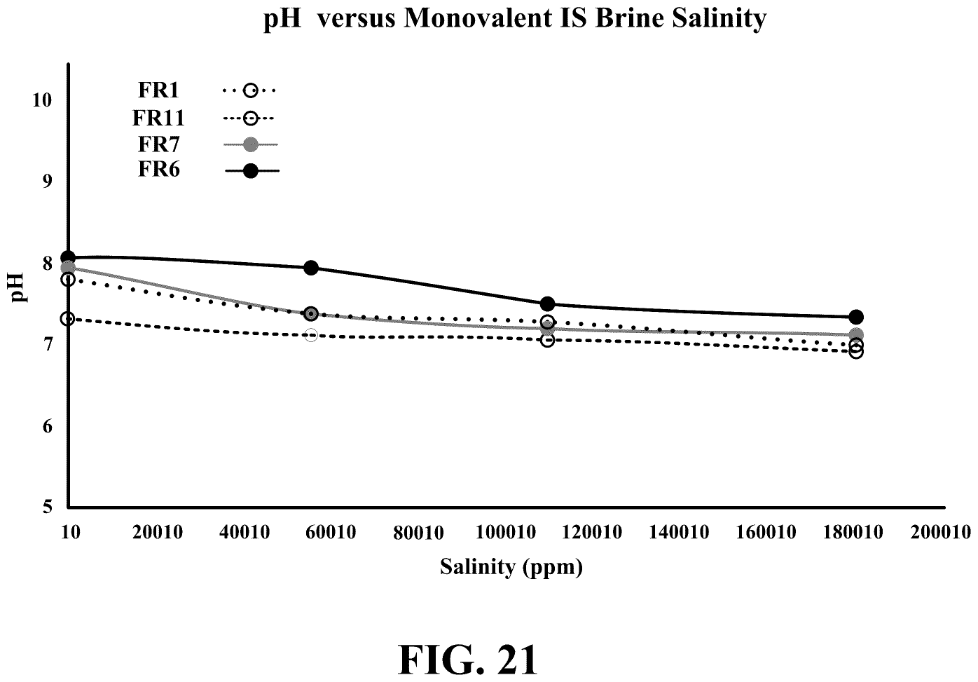

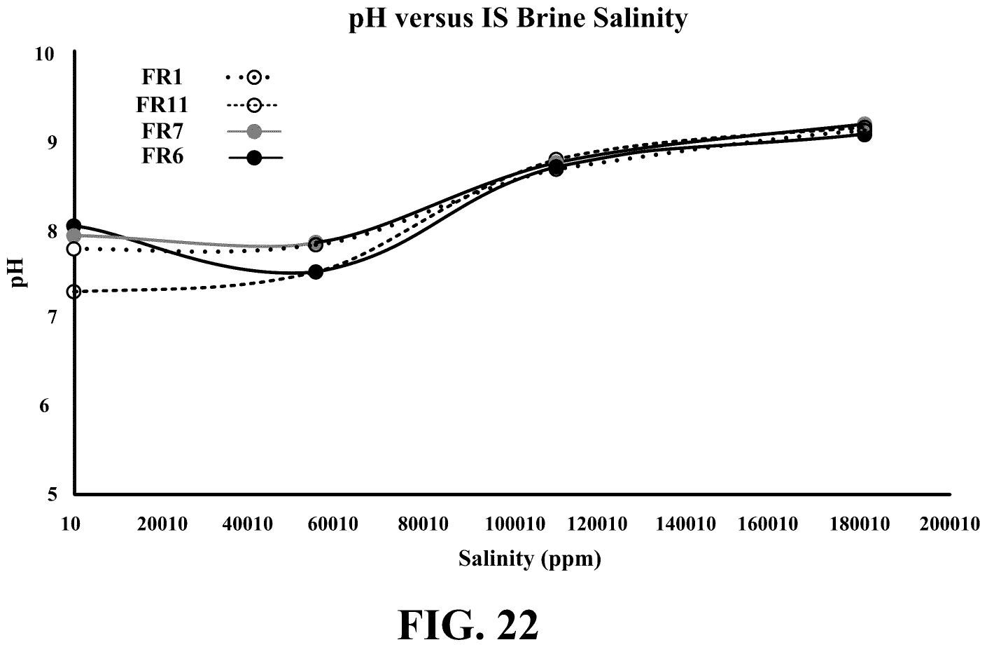

Referring now to FIG. 21, a plot of pH of monovalent brines shows only slight reduction of pH as salinity increases for FR polymers FR1, FR6, FR7, and FR11, while FIG. 22, a plot of pH of IS brines shows only an S-shaped increase in pH with as salinity increases for FR polymers FR1, FR6, FR7, and FR11.

Thus, in monovalent brines, pH decreased with increasing in salinity (NaCl conc.), in IS brines, pH increased with rise in salinity due to the impact of divalent ions in the brines. It is interesting that unexpectedly FR11 provided a lower initial pH in both type of brines.

### pH, Fe³⁺ Management, and Guar-Acrylamide Compatibility Review Meeting II

The following examples evidence experimental studies and physics-based/ML modeling of % drag reduction (% DR) in response to (i) pH, (ii) ferric (Fe³⁺) management, and (iii) guar-acrylamide compatibility.

In the following experiments, the affect of salinity of monovalent and IS brines and polymer properties are investigated according to the following generalized formula:

Viscosity/viscoelasticity=ƒ(fluid salinity−mono/divalency,polymer properties)

### pH Effect and Buffer Additives

pH effects are important because field-brines, i.e., produced waters, may have inherently low pH values that may affect slickwater fluid performance. The pH values for several field brines were raised adding various solution to the field brines, e.g., treating with H₂O₂ and caustic soda, caustic soda, or Na₂CO₃ (pot ash). Results are tabulated below:

| | Phase 1 | | Phase 2 | Phase 3 |
|---|---|---|---|---|
| | Red Hills | Stampede | Red Hills | Red Hills |
| Chemical Treatment | H₂O₂ + Caustic Soda | | Caustic Soda | Na₂CO₃ |
| Treatment pH | 7.5 | 7.5 | 9.5 | >11 |
| Objective | | | | |
| Iron, mg/L | | | | |
| Hardness as CaCO₃, mg/L | n/a | | some reduction | <1,000 |
| Produced Water | | | | |
| Iron, mg/L | 80 | 17 | 80 | |
| Hardness as CaCO₃, mg/L | ≈50,000 | n/a | ≈50,000 | |
| Turbidity, NTU | over measuring range | | | |
| pH | 6.0 | 6.5 | 5.9 | 5.9 |
| Treated Water | | | | |
| Iron, mg/L | 0.6 | 0.4 | 0.6 | 0.4 |
| Hardness as CaCO₃, mg/L | n/a | n/a | not measured | 280 |
| Turbidity, NTU | 1.7 | 1.1 | 1 | 1.3 |
| pH | 7.5 | 7.8 | 8 | 7.7 |
| Treated Water, bbl | 3,750 | 1,364 | 1,893 | 1,125 |
| Sludge generated, lbs/bbl | 1.03 | n/a | 6.5 | 23.8 |

Note:
Excessive addition of caustic soda, lead to Ca(OH)₂ precipitation: sludge removal was needed.

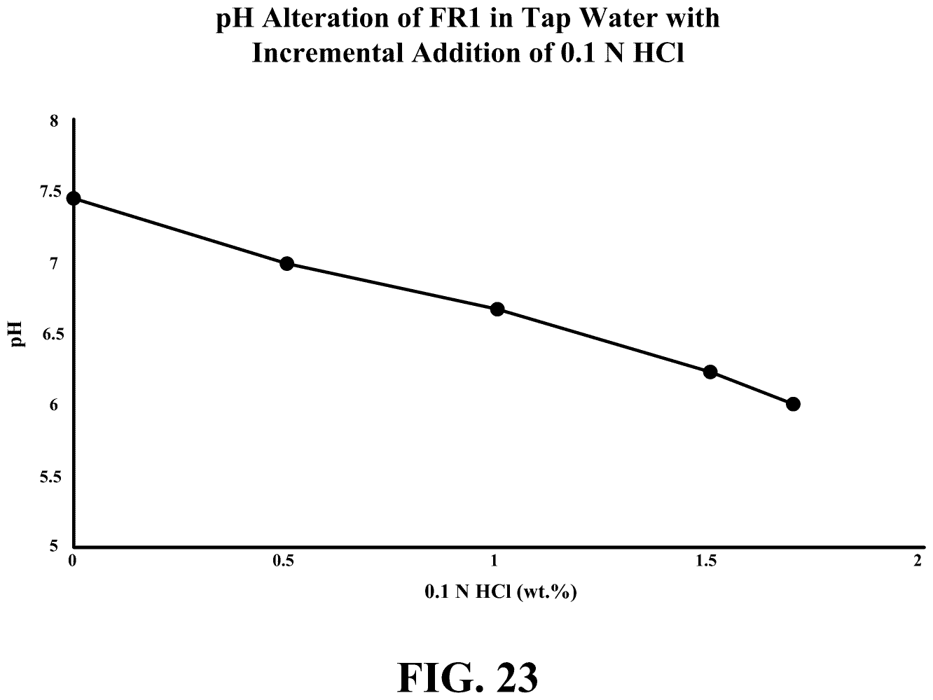

Referring now to FIG. 23, a plot of pH versus incremental addition of 0.1 N HCl to a FR1 solution up to 1.5 wt. % in a flow loop apparatus. The plot was generally linear.

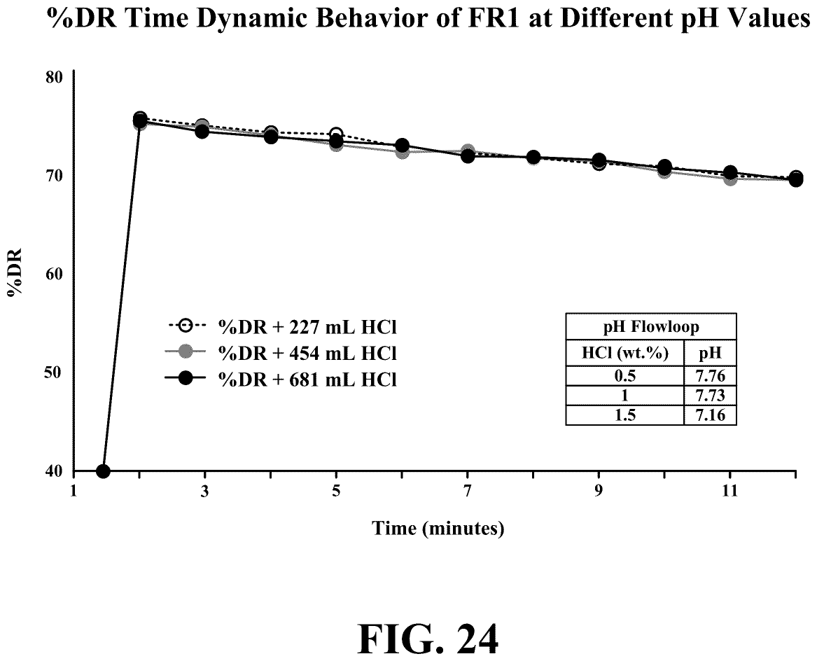

Referring now to FIG. 24, a plot of % DR versus time to investigate the dynamic behavior of incremental addition of 0.1 N HCl to a FR1 solution up to 1.5 wt. % in a flow loop apparatus. The results showed that the effect of added 0.1 N HCl to a FR1 solution as negligible.

### Impact of Polymer Concentration on Drag Reduction

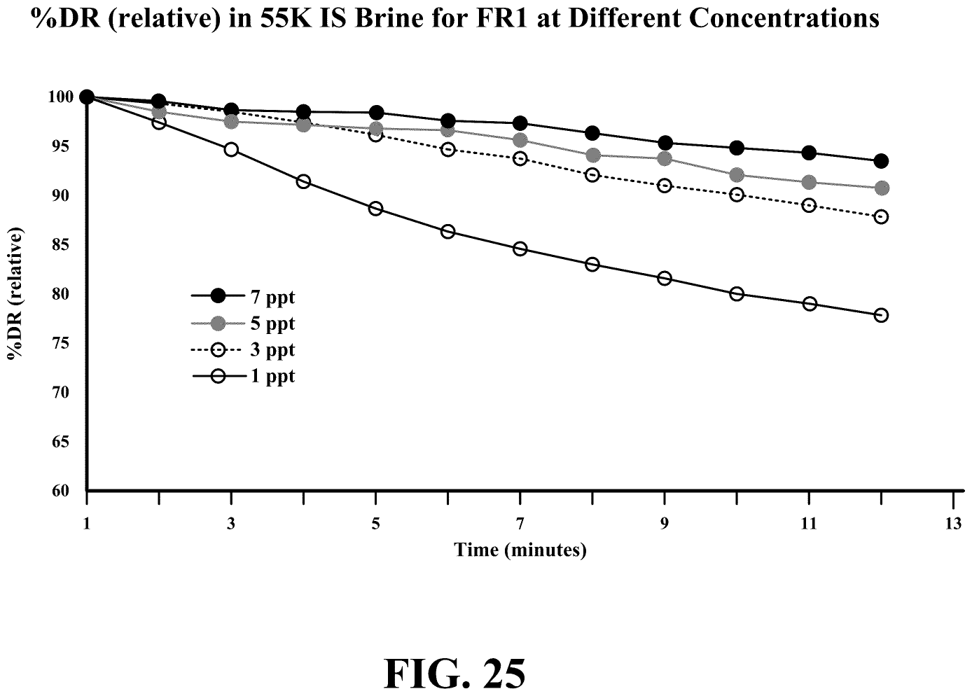

Referring now to FIG. 25, a plot of % DR relative versus time in minutes of different FR1 concentrations measured as ppt in the 55K IS Brine. The 1 ppt FR1 solution shows that largest reduction in % DR relative over time. As the concentration in ppt increases, the reduction in % DR relative over time decreases, with the high ppt value showing the smallest reduction in % DR relative over time.

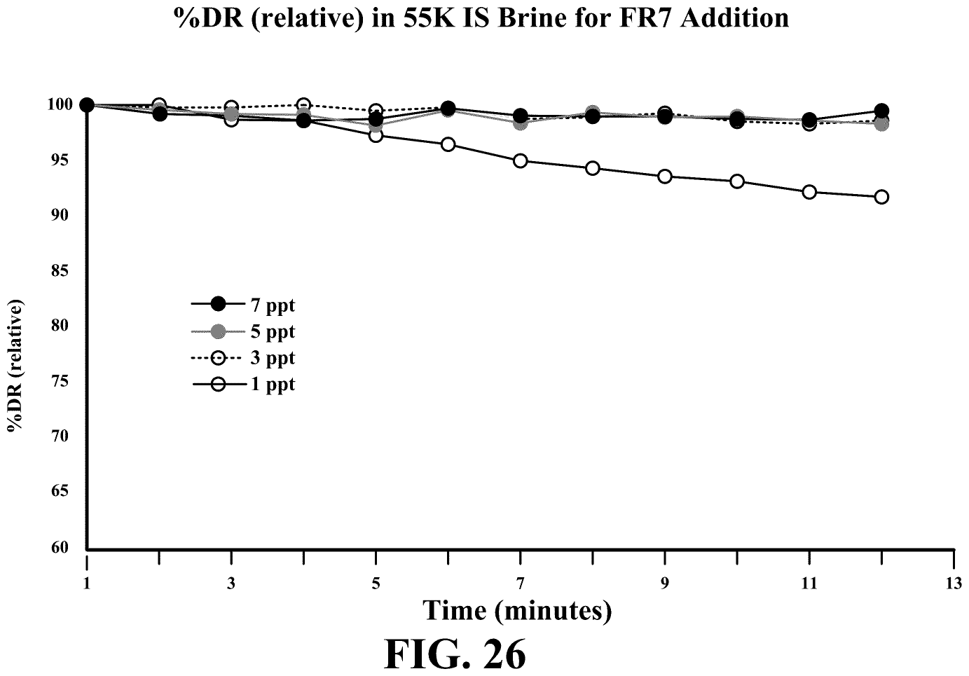

Referring now to FIG. 26, a plot of % DR relative versus time in minutes of different FR7 concentrations measured as ppt in the 55K IS Brine. The 1 ppt FR1 solution shows that largest reduction in % DR relative over time. As the concentration in ppt increases, the reduction in % DR relative over time decreases essentially disappears.

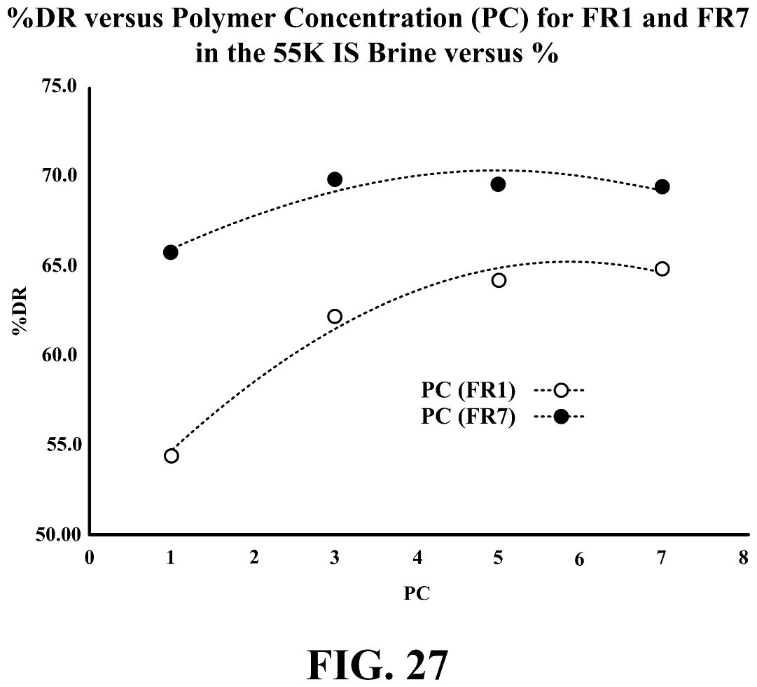

Referring now to FIG. 27, a plot of % DR versus polymer concentration (PC) for FR1 and FR7 in the 55K IS Brine. The behavior of % DR versus PC may be estimated mathematically by the binomial equation of the form:

$$\% DR = - {aPC}^{2} + bPC + c$$

wherein a is a numeric constant having a value between about 0.1 and about 0.6, b is a numeric constant having a value between about 2.0 and about 6.0, and c is a numeric constant having a value between about 40.0 and 70.0. These values will varies depending on the exact FR polymer being used.

In the case of FR1, the estimated mathematical binomial equation is given by:

$$\% DR = - 0.447 {PC}^{2} + 5.2 \; 57 PC + 49.763 ,$$

while in the case of FR7, the estimated mathematical binomial equation is given by:

$$\% DR = - 0.269 {PC}^{2} + 2.6 \; 95 PC + 63.516 .$$

Thus, the methods of this disclosure include the step of analyzing the relationship between % DR and polymer concentration to determine the values of a, b, and c so that appropriate for polymer concentration formula may be inserted into Equation (1).

### Coupled Effect of Fe and Solution pH

The following experiments are designed to investigate the effect of FeCl₃ contamination on brine pH at 26° C. The experiments were carried out by adding different amount of FeCl₃ to a 55K IS brine over a 45 section period of time with mixing in a Hamilton Beach mixer @ 3000 RPM. Each pH measurement was an average of six data points. pH values were measured using a standard pH meter.

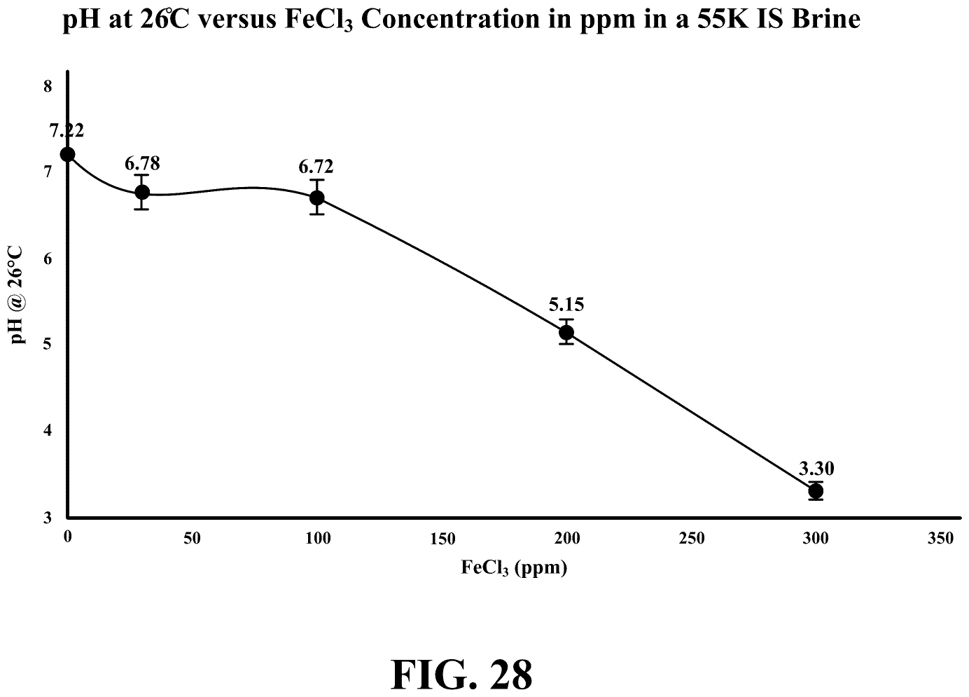

Referring now to FIG. 28, a plot of pH at 26° C. versus FeCl₃ concentration in ppm. Clearly, the presence of Fe³⁺ ions in the field brines significantly lowers pH values. In fact, 300 ppm of Fe³⁺ ions in a 55K IS brine reduced the pH from 7.22 to 3.30.

The present experiment, % DR response was measured relative to added FeCl₃ concentration in ppm for different FR polymers having different degrees of sulfonation (amount of AMPS monomers in the FR polymers).

| | Degree of Sulfonation (% S) | | | |
|---|---|---|---|---|
| FeCl₃ | FR1 | FR11 | FR7 | FR14 |
| (ppm) | (0% S) | (12.5% S) | (32.6% S) | (26.3% S) |
| 0 | 47.54 | 56.79 | 60.16 | 59.50 |
| 15 | 46.48 | 55.51 | 59.53 | 60.94 |
| 100 | 45.62 | 54.02 | 58.07 | 57.45 |
| 150 | 44.23 | 54.26 | 55.57 | 58.23 |
| 200 | 0 | 0 | 0 | 0 |
| 250 | 0 | 0 | 0 | 0 |

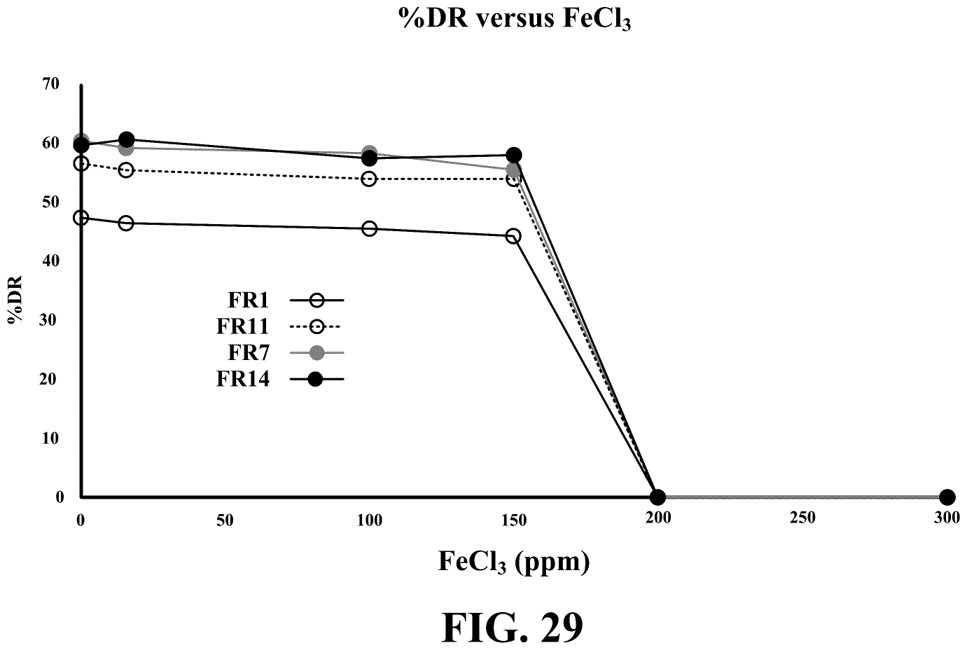

Referring now to FIG. 29, a plot of the above data, which shows that as % S increases % DR decreases from a % DR value of 50 at a % S value of 0 to a % DR value of 60 at a % S value of above 20. The % DR values for each FR polymer decreases very slowly up to a FeCl₃ concentration above about 150 ppm and then drops to a % DR value of 0 at a FeCl₃ concentration of 200 ppm corresponding to a pH value of about 5.

### Viscoelasticity of Polymer-Brines Solutions

The present experiments investigated the storage modulus response versus shear strain for a 20 ppt FR polymer solutions for FR1 and FR7 in deionized water (DW), tap water (TW), a 20K IS brine and a 55K IS brine.

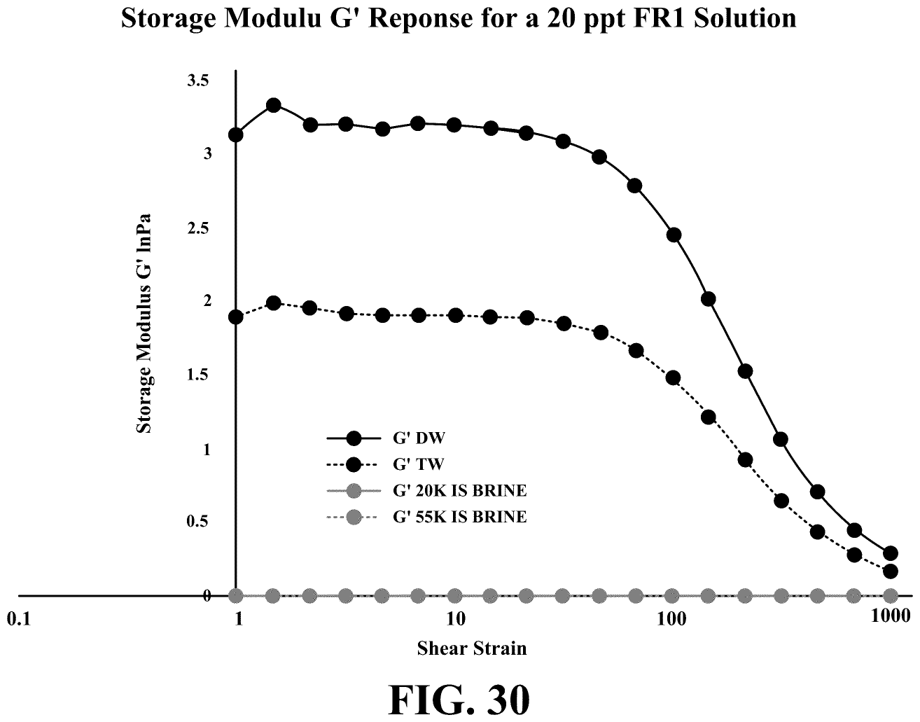

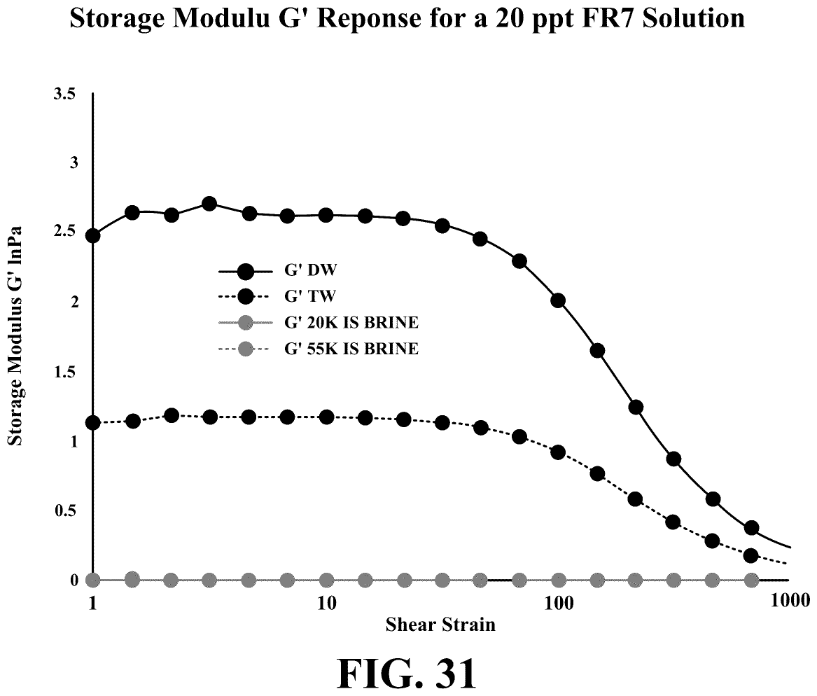

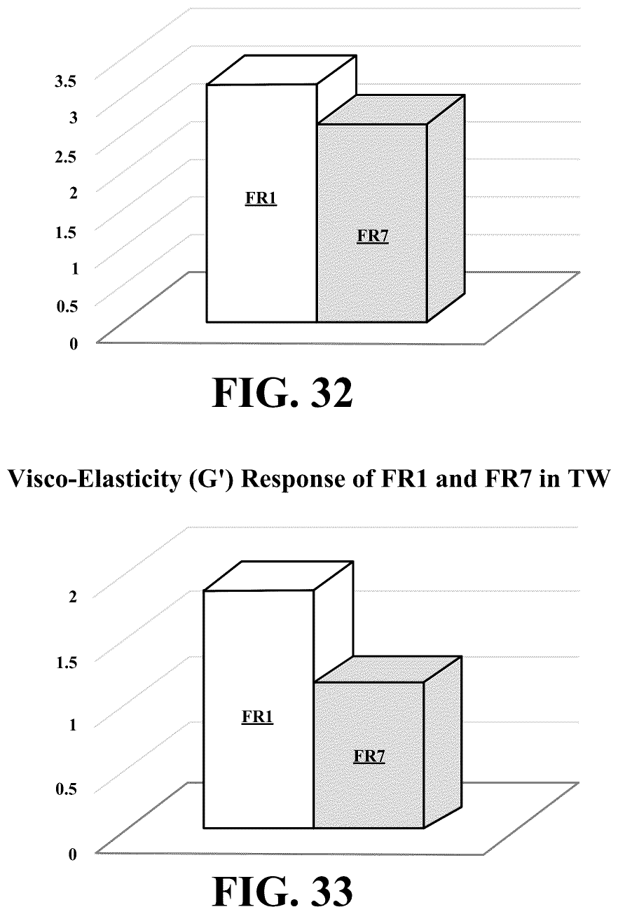

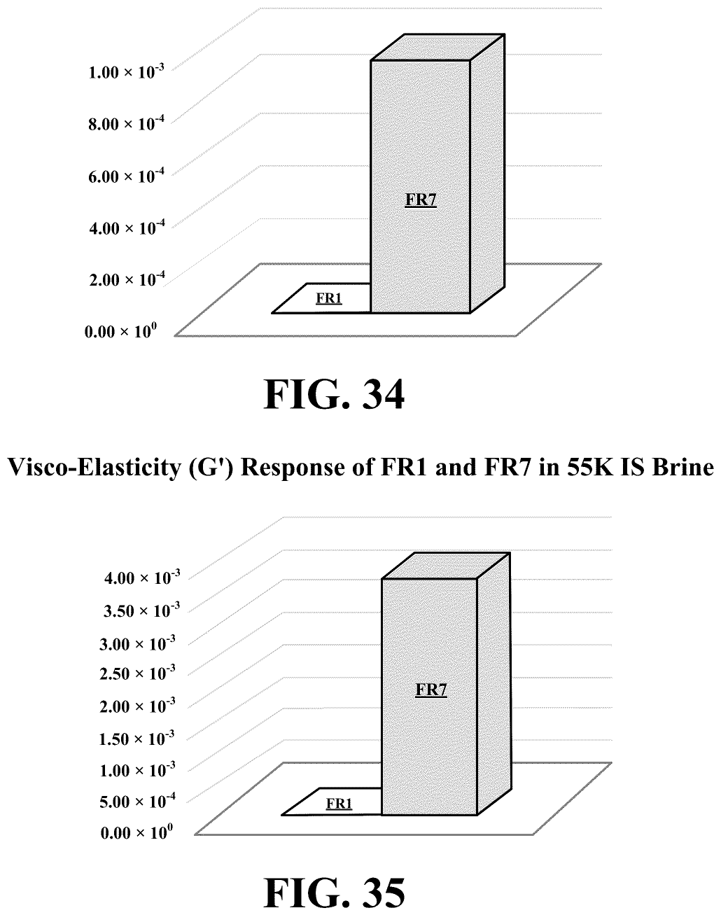

Referring now to FIGS. 30 through 35, plots of storage modulus G′ (InPa) versus shear strain for a 20 ppt FR1 solution and a 20 ppt FR7 solution, where the G′ values for FR1 and FR7 in 20K IS and 55K IS brines have storage modulus of about 0. The plots show that FR1 and FR7 polymers in low-salinity brines were tangibly viscoelastic, while low-shear viscosity response may be deduced from the rheometer response.

### Impact of Polymer Concentration on Pressure Drop and % DR

The present experiments investigated the impact of polymer concentration on pressure drop and % DR for different FR7 polymer solutions in a 55K IS brine, a 100K IS Brine, and a 180K IS Brine.

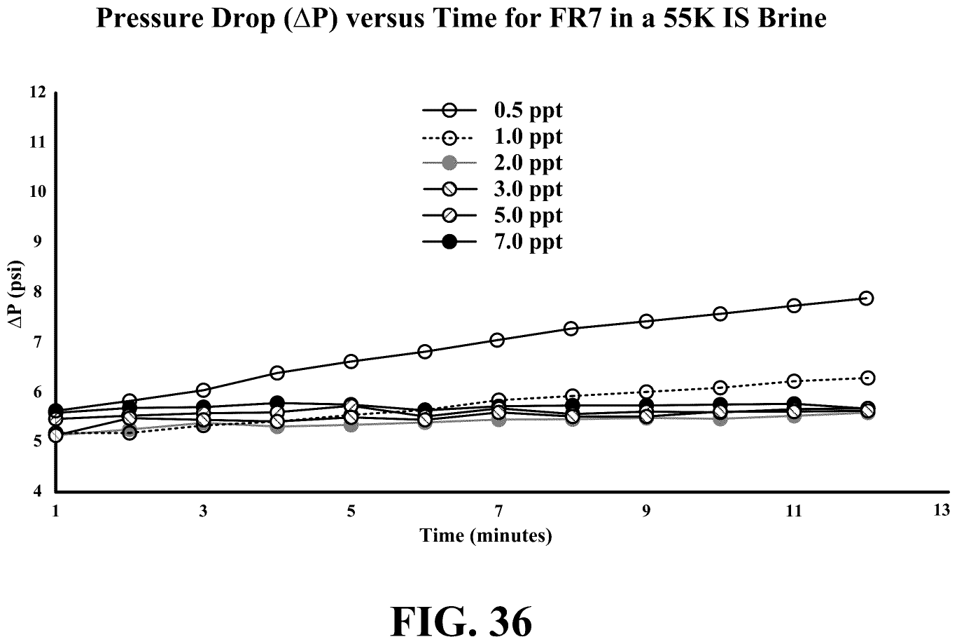

Referring now to FIG. 36, a plot of pressure drop (ΔP) in psi versus different FR7 polymer concentrations in a 55K IS brine. The concentration ranges from 0.5 ppt to 7 ppt. As the FR7 polymer concentration increases, the amount of ΔP change decreases.

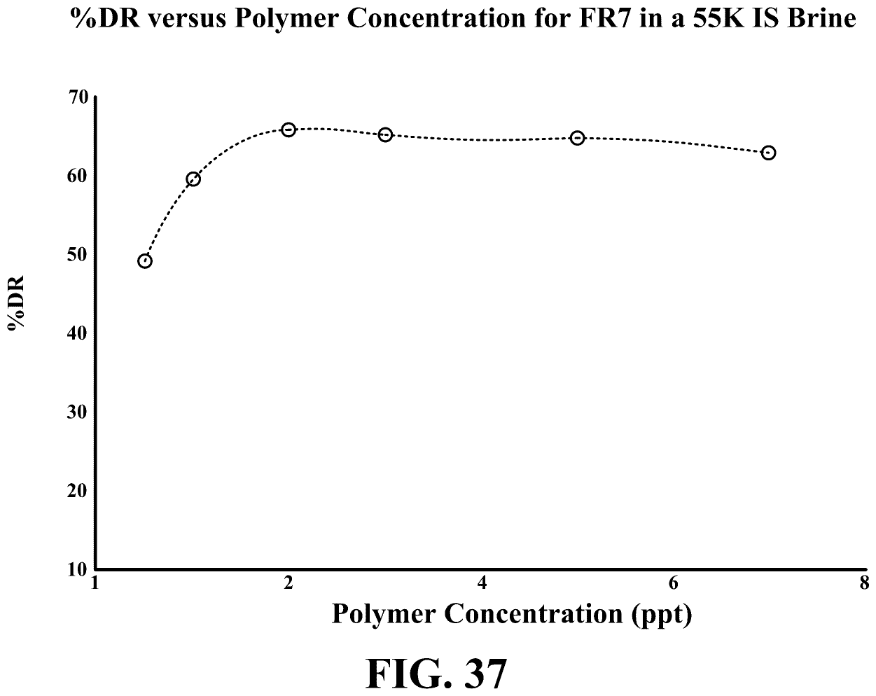

Referring now to FIG. 37, a plot of % DR versus different FR7 polymer concentrations in a 55K IS brine. The % DR rises sharply and then decreases slowly.

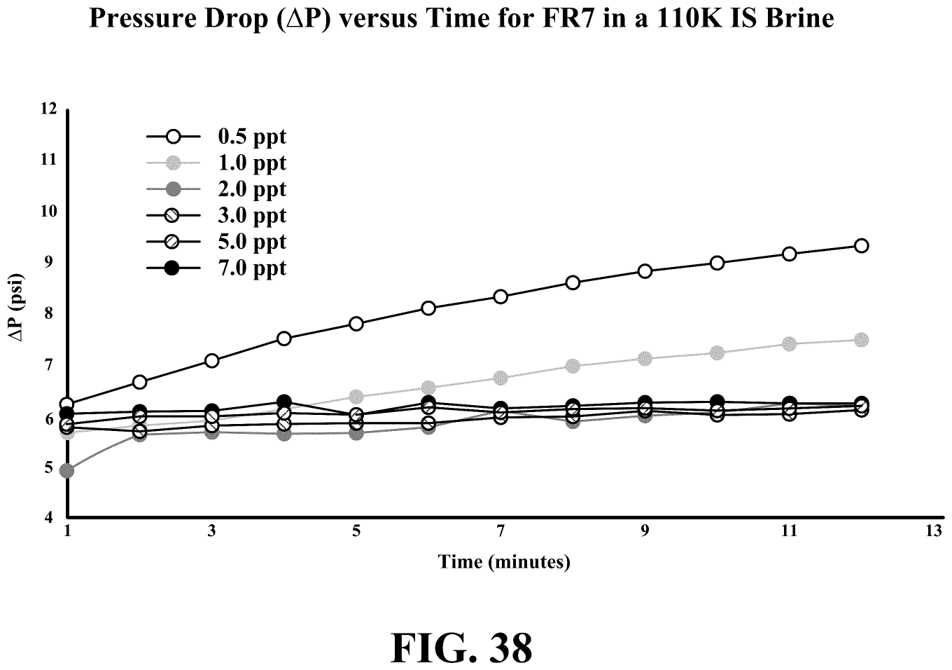

Referring now to FIG. 38, a plot of pressure drop (ΔP) in psi versus different FR7 polymer concentrations in a 100K IS brine. The concentration ranges from 0.5 ppt to 7 ppt. As the FR7 polymer concentration increases, the amount of ΔP change decreases.

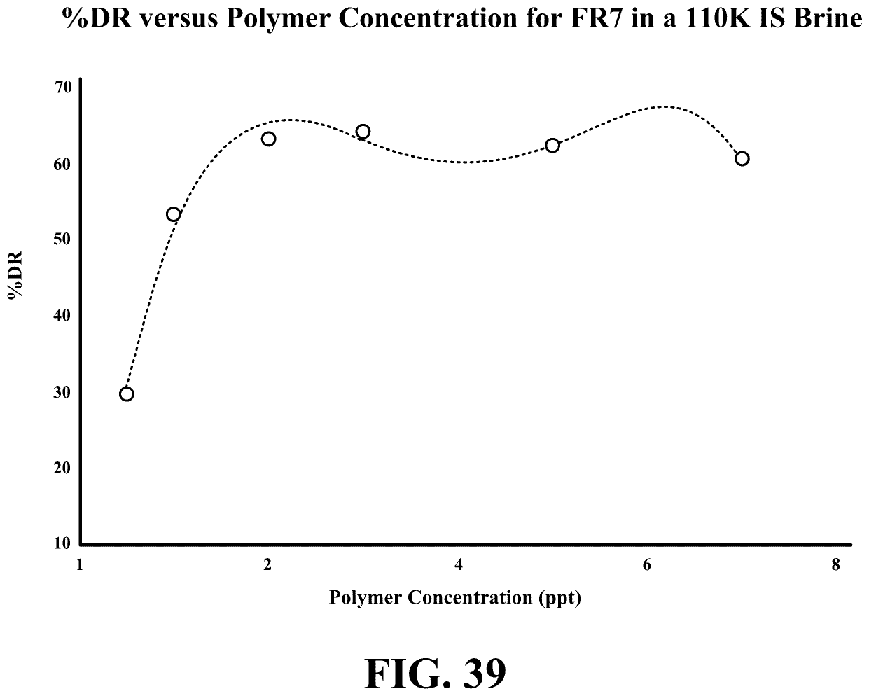

Referring now to FIG. 39, a plot of % DR versus different FR7 polymer concentrations in a 100K IS brine. The % DR rises sharply, drops to a minimum, rises to a maximum, and then decreases.

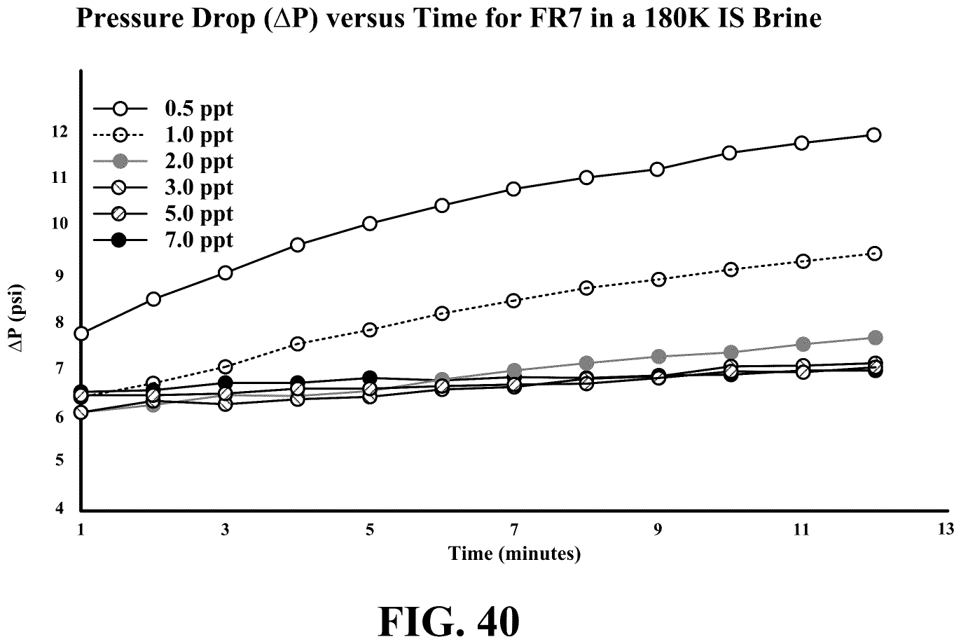

Referring now to FIG. 40, a plot of pressure drop (ΔP) in psi versus different FR7 polymer concentrations in a 180K IS brine. The concentration ranges from 0.5 ppt to 7 ppt. As the FR7 polymer concentration increases, the amount of ΔP change decreases.

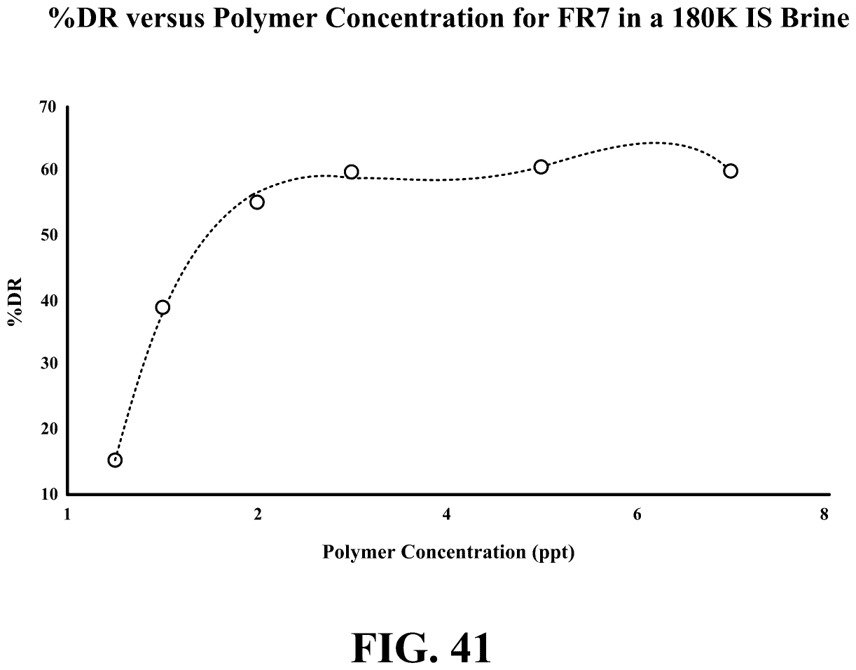

Referring now to FIG. 41, a plot of % DR versus different FR7 polymer concentrations in a 180K IS brine. The % DR rises sharply, drops to a minimum, rises to a maximum, and then decreases.

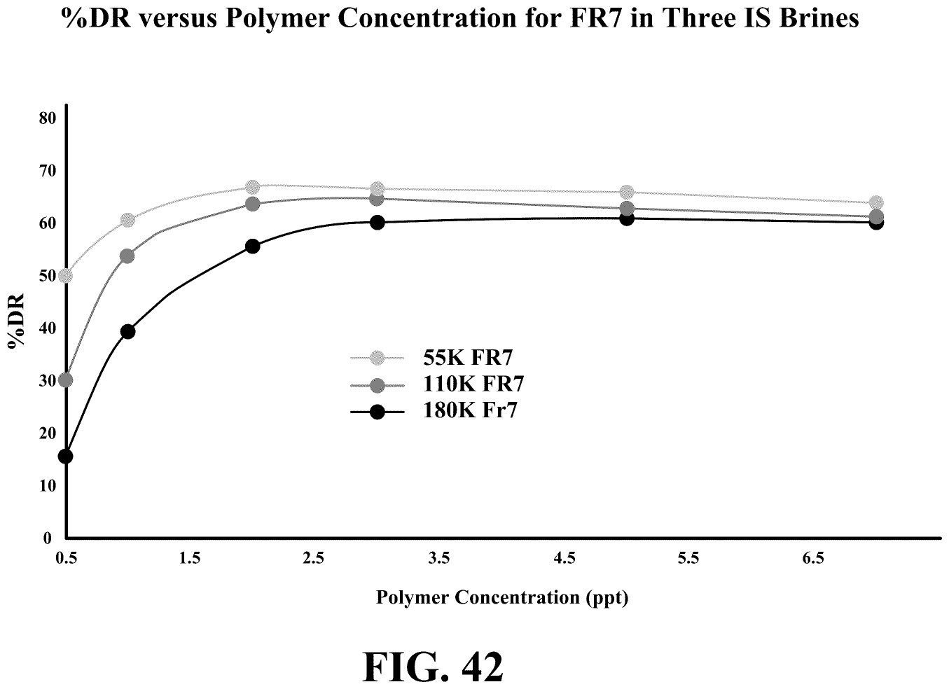

Referring now to FIG. 42, a plot of % DR versus different FR7 polymer concentrations in the 55K IS brine, the 110K IS brine, and the 180K IS brine. The % DR values change more dramatically in the 180K IS brine than in the 55K IS brine with the 110K IS brine is in the middle.

Comprehensive analysis of FR7 behavior in different IS brines are tabulated for % DR (@ 1 ppt), threshold polymer concentration (ppt), and threshold limiting % DR (@ 1 ppt) below.

| | | Threshold PC | Threshold limiting |
|---|---|---|---|
| salinity | % DR (@ 1 ppt) | (ppt) | % DR (@ 1 ppt) |
| 55k | 60.0 | 2.20 | 67.1 |
| 110k | 53.4 | 3.05 | 66.9 |
| 180k | 38.8 | 3.45 | 63.4 |

The present experiments investigated the impact of polymer concentration on pressure drop and % DR for different FR1 polymer solutions in tap water, a 20K IS brine, and a 150K IS Brine.

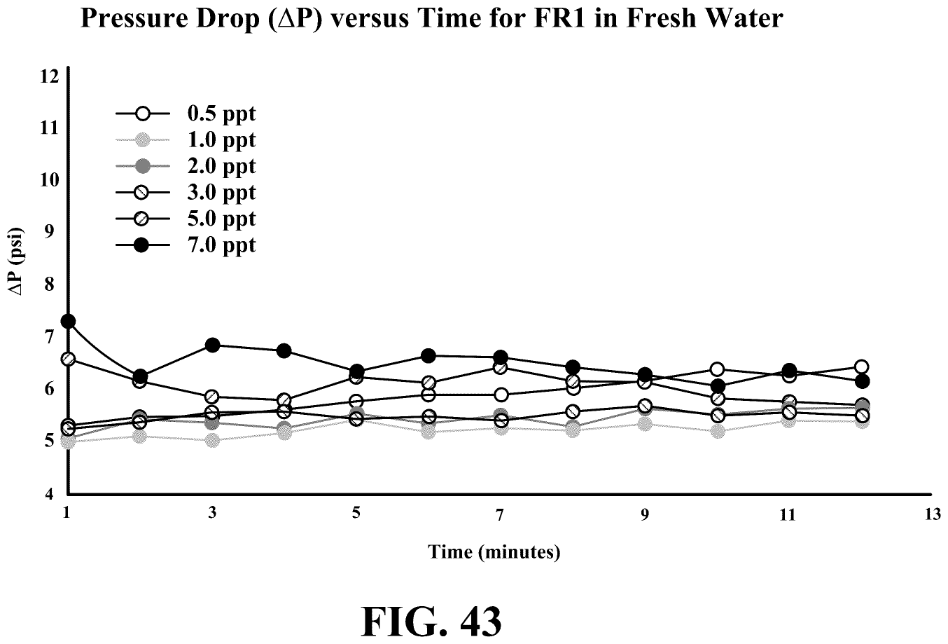

Referring now to FIG. 43, a plot of pressure drop (ΔP) in psi versus different FR1 polymer concentrations in fresh water. The concentration ranges from 0.5 ppt to 7 ppt. As the FR7 polymer concentration increases, the amount of ΔP change decreases.

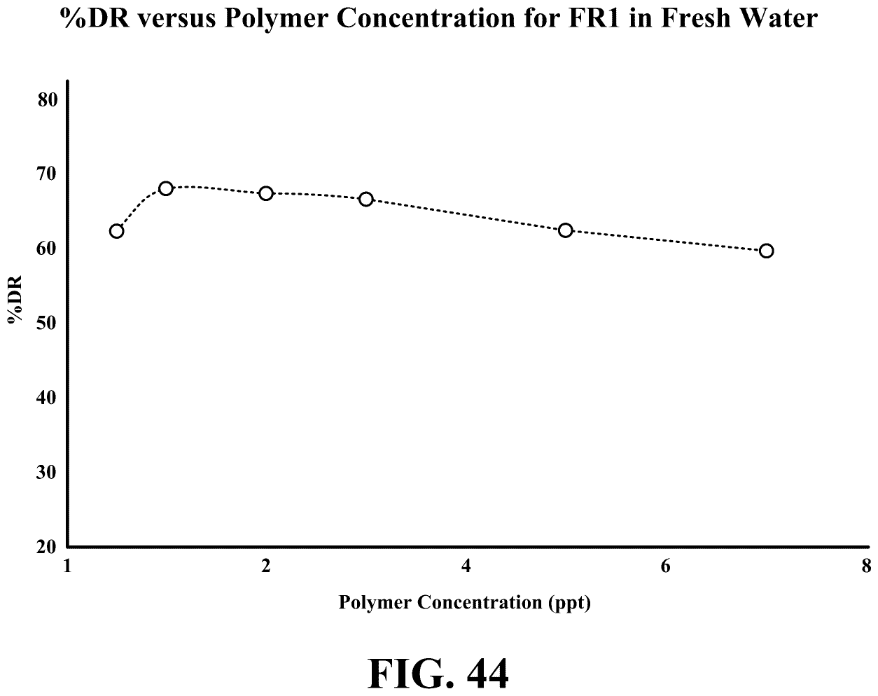

Referring now to FIG. 44, a plot of % DR versus different FR7 polymer concentrations in fresh water. The % DR rises sharply and then decreases slowly.

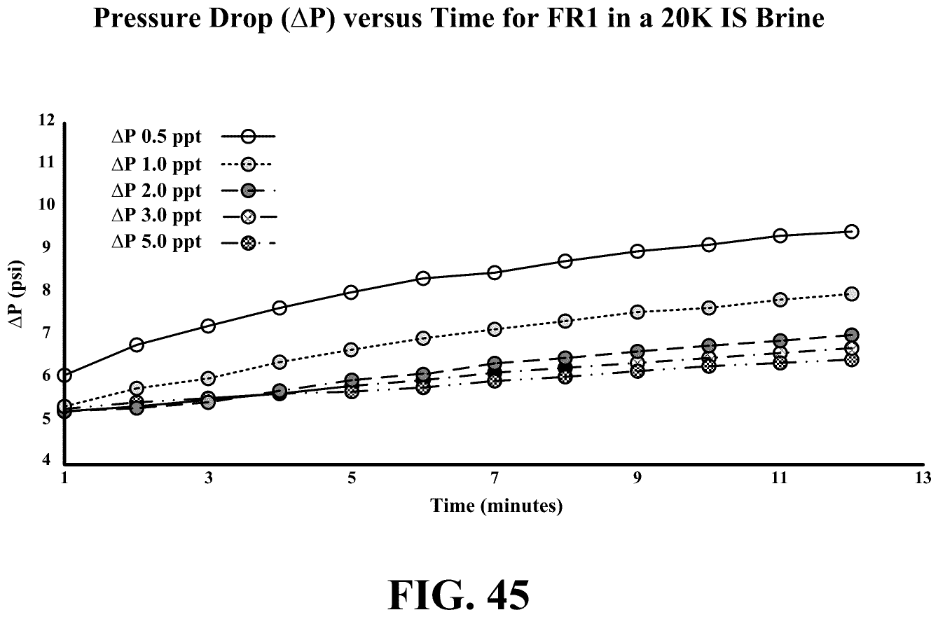

Referring now to FIG. 45, a plot of pressure drop (ΔP) in psi versus different FR7 polymer concentrations in a 20K IS brine. The concentration ranges from 0.5 ppt to 7 ppt. As the FR7 polymer concentration increases, the amount of ΔP change decreases.

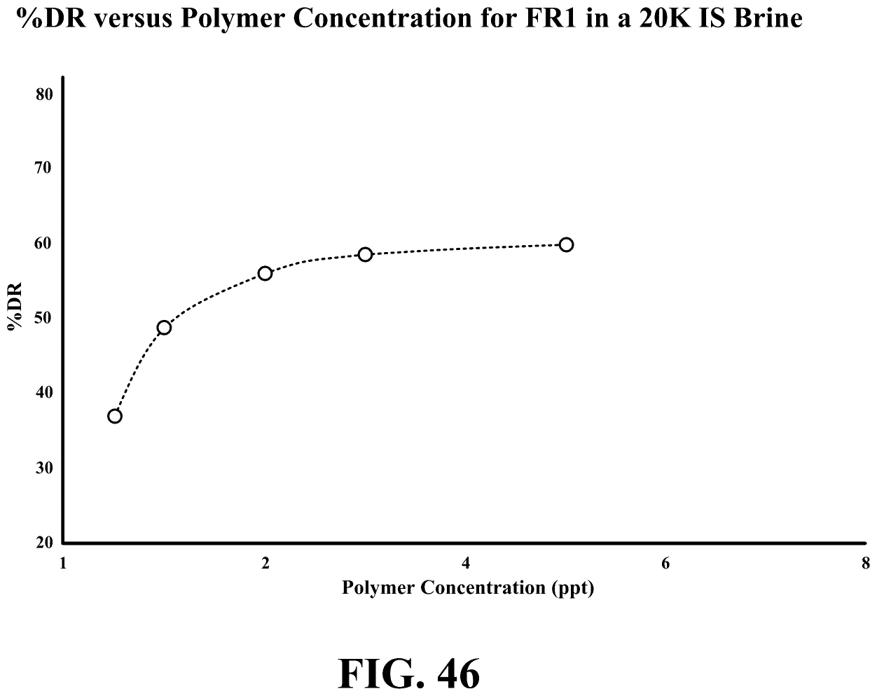

Referring now to FIG. 46, a plot of % DR versus different FR7 polymer concentrations in a 20K IS brine. The % DR rises sharply, drops to a minimum, rises to a maximum, and then decreases.

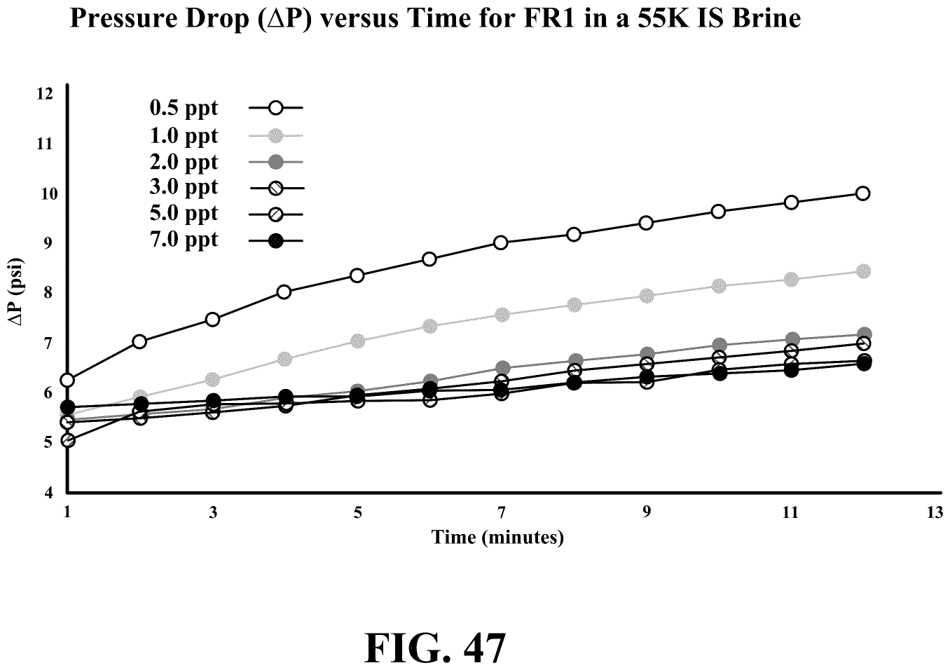

Referring now to FIG. 47, a plot of pressure drop (ΔP) in psi versus different FR7 polymer concentrations in a 150K IS brine. The concentration ranges from 0.5 ppt to 7 ppt. As the FR7 polymer concentration increases, the amount of ΔP change decreases.

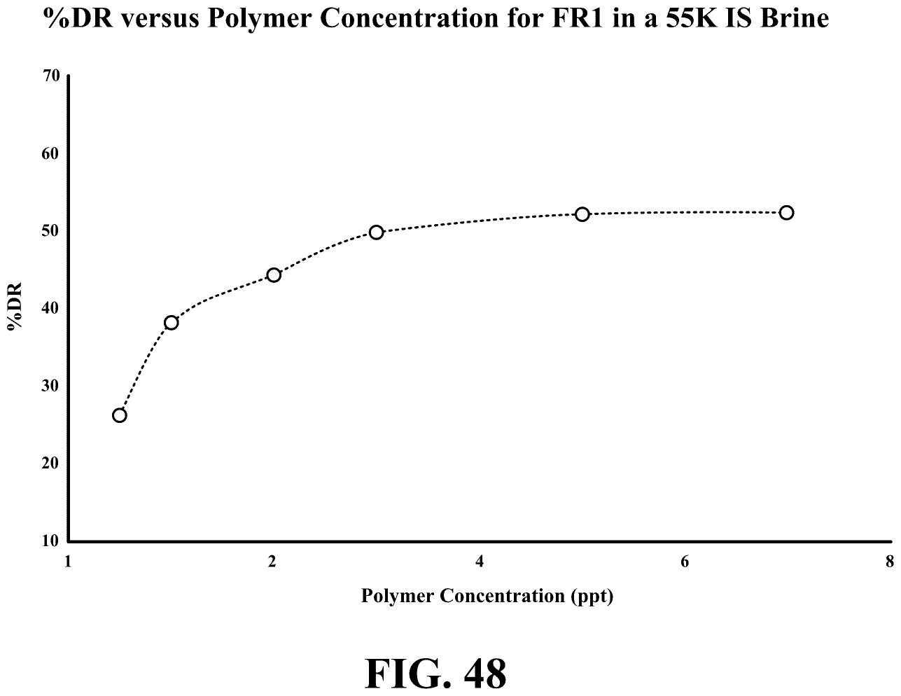

Referring now to FIG. 48, a plot of % DR versus different FR7 polymer concentrations in a 150K IS brine. The % DR rises sharply, drops to a minimum, rises to a maximum, and then decreases.

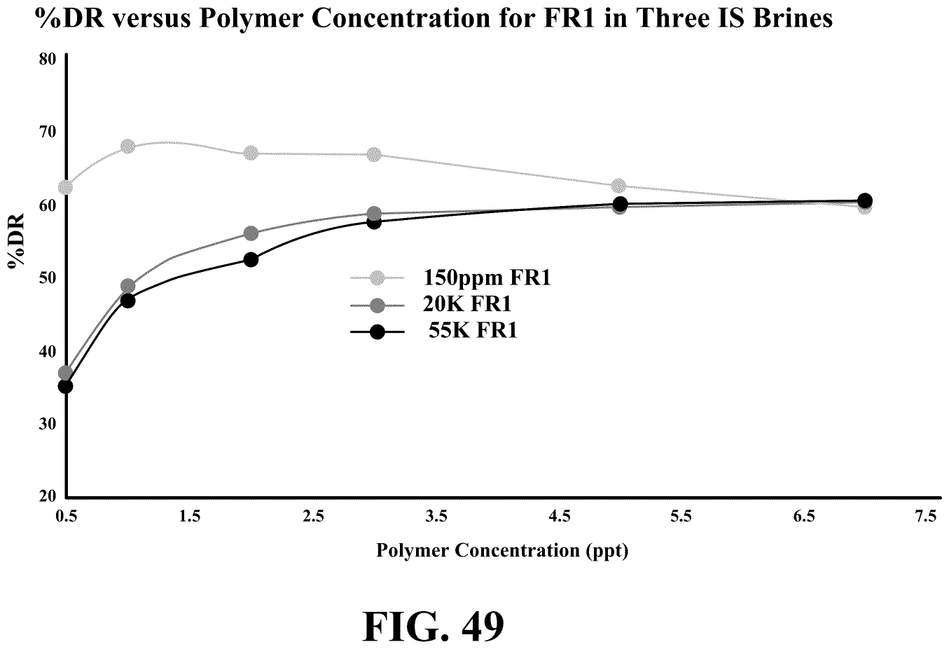

Referring now to FIG. 49, a plot of % DR versus different FR7 polymer concentrations in the 55K IS brine, the 110K IS brine, and the 180K IS brine. The % DR values change more dramatically in the 180K IS brine than in the 55K IS brine with the 110K IS brine is in the middle.

Comprehensive analysis of FR7 behavior in different IS brines are tabulated for % DR (@ 1 ppt), threshold polymer concentration (ppt), and threshold limiting % DR (@ 1 ppt) below.

| | | Threshold PC | Threshold limiting |
|---|---|---|---|
| salinity | % DR (@ 1 ppt) | (ppt) | % DR (@ 1 ppt) |
| tap water | 68.1 | 1.00 | 68.1 |
| 20K | 53.4 | 3.00 | 60.1 |
| 55K | 46.8 | 6.00 | 60.1 |

### CHNS Analysis, MW, and Degree of Ionicity Datat

The present experiments were designed to investigate influences FR polymer composition based on carbon, hydrogen, nitrogen and sulfur (CHNS) analysis, FR molecular weight (MW), the degree of ionicity of the FR polymer, and the moisture content of the FR polymer. A composition of FR14 was varied to investigate these properties.

The molecular weight of FR14 were analyzed using the following process: sieving, mixing, and testing. The sieving step need to be performed at very first of the entire MW analysis process. Samples were passed through 85 mesh prior to mixing and testing. The mixing step involved mixing different concentration ranging from 1 ppt to 15 ppt of the 85 mesh passed polymer samples with a 0.2 M Na₂SO₄ brine solution as the aqueous base fluid. The concentrated polymer samples were then mixed for 150 seconds using CSM Mixer, wherein 1 ppt=0.12 g/1000 mL. The testing step involved keeping the samples in hot water bath at 35° C. for 2 hours until the samples were stable. The samples were then tested in sequence of low to high concentrations and the time taken to reach the marked points (A & B) on the Ubbelohde Viscometer was noted.

Two compositions of FR14 were used to investigate information on the effect of polymer make up (CHNS analysis) data, MW data, degree of ionicity data, and moisture content data. Certain properties two FR14 polymers that were tested are tabulated below:

| | FR14_{New} | FR14_{old} |
|---|---|---|
| Molecular Weight | 11.5 | 13.7 |
| Degree of Ionization | 11.6 | 10.7 |
| Moisture | 11.1 | 11.0 |
| CHNS (% AMPS) | 26.3 wt. % AMPS | 27.9 wt. % AMPS |

FR14_{old} had higher MW approximately 20% higher than FR14_{new} and a slightly higher sulfonation (% S) content relative to the FR14_{new} polymer to test both MW and % S effects.

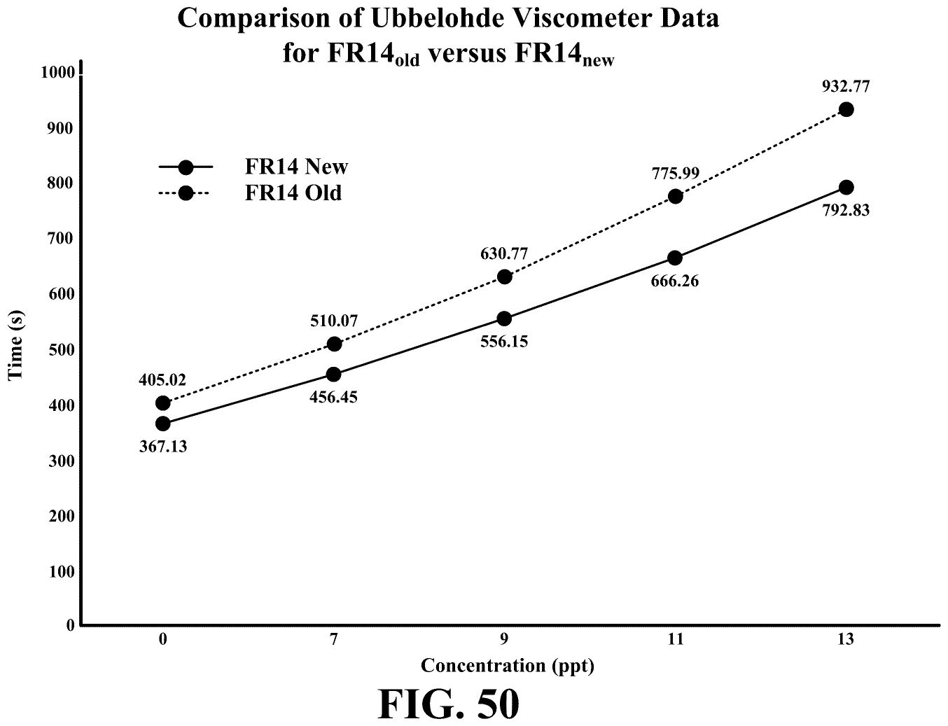

Referring now to FIG. 50, a plot of the Ubbelohde Viscometer time for reaching marked points A & B. The Ubbelohde Viscometer time values for FR14_{new} were all longer than for FR14_{old} and deviated more at higher polymer concentrations. This data may also be used in Equation (1) to improve the prediction of % DR of a friction-reducing polymer composition to reduce or optimize the % DR for a given aqueous base fluid and for changes of the aqueous base fluid during drilling or treating operations.

### EMBODIMENTS OF THE DISCLOSURE

Embodiment 1. A system comprising:
an electronic device including a processing unit having a memory, one or more input devices, one or more output devices, one or more mass storage devices, an operating system, communication hardware and software, and software routines for calculating percent drag reduction (% DR) from friction-reducing (FR) polymer properties and base fluid properties,
wherein the system is configured to:
receive input data comprising properties of a friction-reducing polymer composition and properties of an aqueous base fluid used to prepare a downhole fluid,
calculate a percent drag reduction (% DR) for a downhole fluid according to Equation (1):

$$\% DR = {C}_{0} \times {f}_{1} ( MW ) \times {f}_{2} ( [ MVI ] ) \times {f}_{3} ( [ DVI ] , \% S ) \times {f}_{4} ( [ FRP ] ) \qquad ( 1 )$$

wherein:
C₀ is a constant;
ƒ₁ is explicit function of friction-reducing (FR) polymer molecular weights;
ƒ₂ is explicit function of monovalent salt concentration in base fluid;
ƒ₃ is explicit function of two independent variables: divalent salt concentration of the base fluid and the percent 2-acrylamido-2-methylpropane sulfonic acid (AMPS) monomer units in the FR polymers;
ƒ₄ is explicit function of the FR polymer concentration; and
   the following dependent variable:
      % DR is estimated drag reduction of a downhole fluid; and
   the following measurable independent variables:
      MW is the polymer weight of the FR polymers to be added to the base fluid to form the downhole fluid;
      % S is a measure of a percentage of AMPS units in the FR polymers to be added to the base fluid to form the downhole fluid;
   [MVI] is the monovalent ion concentration in the base fluid;
   [DVI] is the divalent ion concentration in the base fluid;
      [FRP] is the FR polymer concentration to be added to the base fluid to form the downhole fluid; and
      % S is a measure of a percentage of AMPS units in the FR polymers to be added to the base fluid to form the downhole fluid,
receive updated input data comprising properties of a friction-reducing polymer composition and properties of an aqueous base fluid in real-time or near real-time used to modify a composition of the friction-reducing polymer composition used in the downhole fluid,
modify the friction-reducing polymer composition based on the updated input data, and repeat the receive updated input data and the modify the friction-reducing polymer composition until the downhole operation is stopped,
wherein the downhole fluid includes a downhole treating fluid or a downhole drilling fluid and
wherein the treating downhole fluids include slick water fracturing fluids, cross-linked fracturing fluids, proppant-containing, slick water fracturing fluids, proppant-containing, cross-linked fracturing fluids, high and low viscosity completion fluids, zone isolation fluids, or any other treating fluid.

Embodiment 2. A method, implemented on an electronic device including a processing unit having a memory, one or more input devices, one or more output devices, one or more mass storage devices, an operating system, communication hardware and software, and software routines for calculating percent drag reduction (% DR) from friction-reducing (FR) polymer properties and base fluid properties, the method comprising:
receiving input values comprising properties of a friction-reducing polymer composition and properties of an aqueous base fluid used to prepare a downhole fluid,
calculating a percent drag reduction (% DR) according to Equation (1):

$$\% DR = {C}_{0} \times {f}_{1} ( MW ) \times {f}_{2} ( [ MVI ] ) \times {f}_{3} ( [ DVI ] , \% S ) \times {f}_{4} ( [ FRP ] ) \qquad ( 1 )$$

wherein:
   C₀ is a constant;
   ƒ₁ is explicit function of friction-reducing (FR) polymer molecular weights;
   ƒ₂ is explicit function of monovalent salt concentration in base fluid;
   ƒ₃ is explicit function of two independent variables: divalent salt concentration of the base fluid and the percent AMPS units in the FR polymers;
   ƒ₄ is explicit function of the FR polymer concentration; and
      the following dependent variable:
         % DR is estimated drag reduction of a downhole fluid; and
      the following measurable independent variables:
         MW is the polymer weight of the FR polymers to be added to the base fluid to form the downhole fluid;
         % S is a measure of a percentage of AMPS units in the FR polymers to be added to the base fluid to form the downhole fluid;
      [MVI] is the monovalent ion concentration in the base fluid;
      [DVI] is the divalent ion concentration in the base fluid;
         [FRP] is the FR polymer concentration to be added to the base fluid to form the downhole fluid; and
         % S is a measure of a percentage of AMPS units in the FR polymers to be added to the base fluid to form the downhole fluid,
receiving updated input data comprising properties of a friction-reducing polymer composition and properties of an aqueous base fluid in real-time or near real-time used to modify a composition of the friction-reducing polymer composition used in the downhole fluid,
modifying the friction-reducing polymer composition based on the updated input data, and repeating the receiving updated input data and the modifying the friction-reducing polymer composition until the downhole operation is stopped,
wherein the downhole fluid includes a downhole treating fluid or a downhole drilling fluid and
wherein the treating downhole fluids include slick water fracturing fluids, cross-linked fracturing fluids, proppant-containing, slick water fracturing fluids, proppant-containing, cross-linked fracturing fluids, high and low viscosity completion fluids, zone isolation fluids, or any other treating fluid.

Embodiment 3. A method, implemented on an electronic device including a processing uni having a memory, one or more mass storage devices, one or more input devices, one or more output devices, an operating system, and routines for running percent drag reduction computations, including computing a percent drag reduction (% DR) based on certain FR polymer properties and base fluid properties as independent variables, the method comprising:
receiving input values comprising properties of a friction-reducing polymer composition and properties of an aqueous base fluid used to prepare a downhole fluid,
calculating a percent drag reduction (% DR) according to Equation (1):

$$\% DR = {C}_{0} \times {f}_{1} ( MW ) \times {f}_{2} ( [ MVI ] ) \times {f}_{3} ( [ DVI ] , \% S ) \times {f}_{4} ( [ FRP ] ) \qquad ( 1 )$$

wherein:
   C₀ is a constant;
   ƒ₁ is explicit function of friction-reducing (FR) polymer molecular weights;
   ƒ₂ is explicit function of monovalent salt concentration in base fluid;
   ƒ₃ is explicit function of two independent variables: divalent salt concentration of the base fluid and the percent AMPS units in the FR polymers;
   ƒ₄ is explicit function of the FR polymer concentration; and
      the following dependent variable:
         % DR is estimated drag reduction of a downhole fluid; and
      the following measurable independent variables:
         MW is the polymer weight of the FR polymers to be added to the base fluid to form the downhole fluid;
         % S is a measure of a percentage of AMPS units in the FR polymers to be added to the base fluid to form the downhole fluid;
      [MVI] is the monovalent ion concentration in the base fluid;
      [DVI] is the divalent ion concentration in the base fluid;
         [FRP] is the FR polymer concentration to be added to the base fluid to form the downhole fluid; and
         % S is a measure of a percentage of AMPS units in the FR polymers to be added to the base fluid to form the downhole fluid,
receiving updated input data comprising properties of a friction-reducing polymer composition and properties of an aqueous base fluid in real-time or near real-time used to modify a composition of the friction-reducing polymer composition used in the downhole fluid,
modifying the friction-reducing polymer composition based on the updated input data, and repeating the receiving updated input data and the modifying the friction-reducing polymer composition until the downhole operation is stopped,
wherein:
   the properties include concentrations of the FR polymers, types of FR polymers, molecular weights of the FR polymers, monomer make up of the FR polymers, percent sulfonation of the FR polymer (an indirect measure of the number of AMPS monomers units in the FR polymers, degree of ionicity of the FR polymers, or any combination thereof as independent variables,
      the base fluid properties include a salinity of the base fluid, concentration of metal salts in the base fluid (monovalent metal salts and/or polyvalent metal salts), type of salts in the base fluid (specific monovalent metal salts and/or polyvalent metal salts, temperature of the base fluid, pH of the base fluid, or any combination thereof
   the downhole fluid includes a downhole treating fluid or a downhole drilling fluid and
   the treating downhole fluids include slick water fracturing fluids, cross-linked fracturing fluids, proppant-containing, slick water fracturing fluids, proppant-containing, cross-linked fracturing fluids, high and low viscosity completion fluids, zone isolation fluids, or any other treating fluid.

Embodiment 4. The Embodiments of any preceding Embodiments, wherein the Equation (1) comprises Equations (2) and (2a):

$$( 2 )$$

$$\% DR = {C}_{0} \times [ 1 - ( \frac{1}{{e}^{( {C}_{MW} \times MW )}} ) ] \times [ \text{} 1 - ( {C}_{MVI} \times [ MVI ] ) ] \times [ \text{} 1 + \text{} {\sum }_{i = 1}^{3} {( {\sum }_{j = 0}^{3} {C}_{DVIij} \times {( \% S )}^{j} ) [ DVI ]}^{i} ] \times [ {\sum }_{k = 0}^{3} {{C}_{FRPk} [ FRP ]}^{k} ]$$

$$( 2 a )$$

$$\% DR = {C}_{0} \times [ 1 - ( \frac{1}{{e}^{( {C}_{MW} \times MW )}} ) ] \times [ \text{} 1 - ( {C}_{MVI} \times [ MVI ] ) ] \times [ \text{} 1 + \text{} {\sum }_{i = 1}^{2} {( {\sum }_{j = 0}^{2} {C}_{DVIij} \times {( \% S )}^{j} ) [ DVI ]}^{i} ] \times [ {\sum }_{k = 0}^{2} {{C}_{FRPk} [ FRP ]}^{k} ]$$

wherein:
% DR represents percent drag reduction of a downhold fluid,
C₀ represents a real number zeroth order constant,
MW is the molecular weight of the FR polymers,
C_{MW} is a real number constant associated with the independent variable FR polymer molecular weight,
[MVI] is the concentration of monovalent metal ions in the base fluid,
C_{MVI} is a real number constant associated with the independent variable [MVI],
[DVI] is the concentration of divalent metal ions in the base fluid,
% S is a measure of the amount of AMPS monomer units in the FR polymers,
C_{DVIij} are real number constants associated with the independent variables [DVI] and % S,
[FRP] is the concentration of FR polymers,
C_{FRPk} is a real number constant associated with the independent variable [FRP],
i is an integer counter ranging from 1 to 3 for Equation (2) or 1 to 2 for Equation (2a),
j is an integer counter ranging from 0 to 3 for Equation (2) or 0 to 2 for Equation (2a), and
k is an integer counter ranging from 0 to 3 for Equation (2) or 0 to 2 for Equation (2a).

Embodiment 6. The Embodiments of any preceding Embodiments, wherein the function ƒ₁(MW) comprises Equations (3) or (3a):

$${f}_{1} ( MW ) = 1 - ( \frac{1}{{e}^{( {C}_{MW} \times MW )}} ) \qquad ( 3 )$$

$${f}_{1} ( MW ) = 1 - ( \frac{1}{{e}^{( \frac{{Z}_{MW} \times MW}{20.5} )}} ) \qquad ( 3 a )$$

wherein:
MW is the molecular weight of the FR polymers having a real numeric value between about 0.5 and about 25.00 MDa (mega Daltons), including any subrange or any specific value within the range, and
C_{MW} is a real number constant having a value between about 0.0195 and about 1.9512, including any subrange or any specific value within the range, or
Z_{MW} is a real number constant having a value between about 0.4 and 40.0 including any subrange or any specific value within the range.

Embodiment 8. The Embodiments of any preceding Embodiments, wherein the function ƒ₂([MVI]) comprises Equations (4) or (4a):

$${f}_{2} ( [ MVI ] ) = 1 - ( {C}_{MVI} \times [ MVI ] ) \qquad ( 4 )$$

$${f}_{2} ( [ MVI ] ) = 1 - ( \frac{{Z}_{MVI} \times [ MVI ] )}{180000} ) \qquad ( 4 a )$$

wherein:
[MVI] is the concentration of monovalent metal ions in the base fluid having a real numeric value between about 10 and about 250,000 ppm, including any subrange or any specific value within the range, and
C_{MVI} is a real valued constant having a value ranging between about 5.556×10⁻⁹ and 5.556×10⁻⁷, including any subrange or any specific value within the range, or
Z_{MVI} having a real numeric value between about 0.001 and 0.100 including any subrange or any specific value within the range.

Embodiment 10. The Embodiments of any preceding Embodiments, wherein the function ƒ₃([DVI], % S) comprises a polynomial of Equation (5) and (5a):

$${f}_{3} ( [ DVI ] , \% S ) = 1 + {\sum }_{i = 1}^{3} {( {\sum }_{j = 0}^{3} {C}_{DVIij} \times {( \% S )}^{j} ) [ DVI ]}^{i} \qquad ( 5 )$$

$${f}_{3} ( [ DVI ] , \% S ) = 1 + {\sum }_{i = 1}^{2} {( {\sum }_{j = 0}^{2} {C}_{DVIij} \times {( \% S )}^{j} ) [ DVI ]}^{i} \qquad ( 5 a )$$

wherein:
[DVI] is the concentration of monovalent metal ions in the base fluid having a real numeric value between about 1 and about 100,000 ppm, including any subrange or any specific value within the range,
% S is a measure of the amount of AMPS monomer units in the FR polymers,
C_{DVI10} is a real number constant having a value between about −2×10⁻⁶ and about −2×10⁻⁴,
C_{DVI11} is a real number constant having a value between about 5×10⁻⁸ and about 5×10⁻⁶
C_{DVI12} is a real number constant having a value between about −8×10⁻¹⁰ and about −8×10⁻⁸
C_{DVI13} is a real number constant having a value less than ±1×10⁻¹⁰,
C_{DVI20} is a real number constant having a value between about 2×10⁻¹¹ and about 2×10⁻⁹
C_{DVI12} is a real number constant having a value between about 8×10⁻¹³ and about 8×10⁻¹¹,
C_{DVI22} is a real number constant having a value between about 1×10⁻¹¹ and about 1×10⁻¹², and
C_{DVI23} is a real number constant having a value less than ±1×10⁻¹³.

Embodiment 12. The Embodiments of any preceding Embodiments, wherein the function ƒ₄([FRP]) comprises polynomial Equation (6) and (6a):

$${f}_{4} ( [ FRP ] ) = {\sum }_{k = 0}^{3} {{C}_{FRPk} [ FRP ]}^{k} \qquad ( 6 )$$

$${f}_{4} ( [ FRP ] ) = {\sum }_{k = 0}^{2} {{C}_{FRPk} [ FRP ]}^{k} \qquad ( 6 a )$$

wherein:
[FRP] is the concentration of FR polymers,
C_{FRP0} is a real number constant having a value between about 0.06 and about 6.00,
C_{FRP1} is a real number constant having a value between about 0.04 and about 4.00,
C_{FRP2} is a real number constant having a value between about −1.00 and about −0.01, and
C_{FRP3} is a real number constant having a value less than +0.01.

Embodiment 14. The Embodiments of any preceding Embodiments, wherein the function of Equations (1), (2) and (2a) are formulated to calculated % DR value for a downhole including a base fluid and a specific FR polymer composition, wherein the specific FR polymer composition is designed to minimize the % DR based on the above listed base fluid properties and the above listed FR polymer properties.

Embodiment 16. The Embodiments of any preceding Embodiments, wherein the Equations (7a&b):

$${Wi}^{br} = \{ 1 - ( \frac{\sum {C}_{i} \times {z}_{i}^{2}}{\sum {C}_{i - sat} \times {z}_{i}^{2}} ) \} \times \frac{{( {aN}^{0.6} )}^{3}}{{k}_{B} T} \times {μ}_{S} \times \frac{8 u}{d} \qquad ( 7 a )$$

$$( for Re \geq {Re}_{crit} \qquad ( 7 b )$$

$$and$$

$${Wi}^{br} \geq {Wi}_{onset}^{br}$$

$$\frac{\% DR}{\% {DR}_{MDR}} = 1 - \frac{2}{1 + {e}^{( \frac{{Wi}^{br} - {Wi}_{onset}^{br}}{w} )}}$$

Embodiment 18. The Embodiments of any preceding Embodiments, wherein the function of ƒ₃ comprises Equation (8):

$${f}_{3} ( dv , \% s ) = 1 + ( {z}_{dv , 1} \times {C}_{dv} ) + ( {z}_{dv , 2} \times {C}_{dv}^{2} ) \qquad ( 8 )$$

$$wherein :$$

$${C}_{dv} = ppm of {CaCl}_{2} + ( x \times ppm of {MgCl}_{2} ) , \qquad ( 8 a )$$

$${z}_{dv , 1} = {z}_{dv , 1 , S \text{.1}} + ( {z}_{dv , 1 , S \text{.2}} \times \% s ) + ( {z}_{dv , 1 , S \text{.3}} \times \% {s}^{2} ) \qquad ( 8 b )$$

$${z}_{dv , 1 , S , 1} is 1.3 \times 1 {0}^{- 13} ,$$

$${z}_{dv , 1 , S , 2} is - 8.813 \times 1 {0}^{- 12} ,$$

$$and$$

$${z}_{dv , 1 , S , 3} is 2.69971 \times 1 {0}^{- 10}$$

$${z}_{dv , 2} = {z}_{dv , 2 , S \text{.1}} + ( {z}_{dv , 2 , S \text{.2}} \times \% s ) + ( {z}_{dv , 2 , S \text{.3}} \times \% {s}^{2} ) \qquad ( 8 c )$$

$${z}_{dv , 2 , S , 1} is - 8.03 \times 1 {0}^{- 9} ,$$

$${z}_{dv , 2 , S , 2} is 5.94304 \times 1 {0}^{- 7} ,$$

$$and$$

$${z}_{dv , 2 , S , 3} is - 2.3354 \times 1 {0}^{- 5} ,$$

wherein:
polymer molecular weight in MDa ranges between about 0.5 and about 25, percent of sulfonic acid groups (% s) in polymer in wt. % ranges between about 0.1 and about 45,
C_{pc} (polymer concentration in ppt) ranges between about 0.1 and about 5,
Cₘᵥ (monovalent salt concentration in ppm) between about 10 and about 250,000, and
C_{dv} (divalent salt concentration in ppm) about 1 and about 100,000.

Embodiment 20. The Embodiments of any preceding Embodiments, wherein the ƒ₄([FRP]) comprises:

$$\% DR = - {aPC}^{2} + bPC + c$$

wherein a is a numeric constant having a value between about 0.1 and about 0.6, b is a numeric constant having a value between about 2.0 and about 6.0, and c is a numeric constant having a value between about 40.0 and 70.0. These values will varies depending on the exact FR polymer being used.

Embodiment 22. The Embodiment 21, wherein, for the FR1, the ƒ₄([FRP]) comprises:

$$\% DR = - 0.447 {PC}^{2} + 5.257 PC + 49.763 ,$$

Embodiment 24. The Embodiment 23, wherein, for the FR7, the ƒ₄([FRP]) comprises:

$$\% DR = - 0.269 {PC}^{2} + 2 \text{.695} PC + 63.516 .$$

Embodiment 26. The Embodiments of any preceding Embodiments, wherein the aqueous base fluid properties include salinity, conductivity, pH, specific metal ions and/or metal salts, concentrations of the specific metal ions and/or metal salts, other ions and/or chemicals, ionicity, any other property of the aqueous base fluid, or any combination thereof.

Embodiment 28. The Embodiments of any preceding Embodiments, wherein the formation properties include formation temperature or temperature profile, formation pressure or pressure profile, formation geological structural properties, e.g., type of rock, shale, sand, etc., type and nature of natural fractures within the formation, extent of the formation to be treated, depth of penetration of the treating fluid, desired treating results, type of proppants to be used, type of proppant pillar formation, type of pumping format, pumping conditions such as pumping pressure, downhole fluid flow rate, pumping sequences, etc., other formation properties, or any combination thereof.

Embodiment 30. The Embodiments of any preceding Embodiments, wherein the injection equipment and circulation equipment include any injecting and circulating systems used in the art.

Embodiment 32. The Embodiments of any preceding Embodiments, wherein the friction-reducing polymers comprise acrylamide containing polymers or polyacrylamide containing polymers include polymers including acrylamide as a major monomer making up the polymer backbone.

Embodiment 34. The Embodiment 33, wherein the polymers friction-reducing polymers include at least 30% acrylamide, at least 40% acrylamide, at least 40% acrylamide, at least 50% acrylamide, at least 60% acrylamide, at least 70% acrylamide, at least 80% acrylamide, at least 90% acrylamide, or 100% acrylamide. It should be recognized that these ranges include all subranges such as 30% to 100% or any other range or any other at least percentage.

Embodiment 36. The Embodiments of any preceding Embodiments, wherein the aqueous base fluids include a high TDS produced water, a high TDS flow back water, a high TDS fracturing flow back water, a brackish water, a reverse osmosis (RO) reject water, a clear brine, and mixtures thereof. In certain embodiments, the aqueous base fluids further include fresh water.

Embodiment 38. The Embodiments of any preceding Embodiments, wherein the oil-based base fluids include a hydrocarbon fluid such as diesel, kerosene, fuel oil, selected crude oils, a mineral oil, or any combination thereof.

Embodiment 40. The Embodiment 39, wherein the hydratable polymers or gelling agents include any hydratable polysaccharides that are capable of forming a gel in the presence of a crosslinking agent.

Embodiment 42. The Embodiment 41, wherein the hydratable polysaccharides include galactomannan gums, glucomannan gums, guars, derivatized guars, cellulose derivatives, and mixtures or combinations thereof. Specific examples are guar gum, guar gum derivatives, locust bean gum, Karaya gum, carboxymethyl cellulose, carboxymethyl hydroxyethyl cellulose, and hydroxyethyl cellulose.

Embodiment 44. The Embodiment 43, wherein the hydratable polysaccharides include guar gums, hydroxypropyl guar, carboxymethyl hydroxypropyl guar, carboxymethyl guar, and carboxymethyl hydroxyethyl cellulose. Suitable hydratable polymers may also include synthetic polymers, such as polyvinyl alcohol, polyacrylamides, poly-2-amino-2-methyl propane sulfonic acid, and various other synthetic polymers and copolymers.

Embodiment 46. The Embodiment 45, wherein the hydratable polysaccharides include the molecular weight of the hydratable synthetic polymers are between about 10,000 to about 100,000,000. In other embodiments, the molecular weight is between about 10,000 to about 10,000,000. In other embodiments, the molecular weight is between about 10,000 to about 1,000,000.

Embodiment 48. The Embodiment 47, wherein the hydratable polymer may be present in a treating or drilling fluid in a polymer concentration ranging from about 0.05 wt. % to about 10 wt. %.

Embodiment 50. The Embodiment 49, wherein the polymer concentration ranges between about 0.10 wt. % and about 5.0 wt. %.

Embodiment 52. The Embodiment 51, wherein the polymer concentration ranges between about 0.05 w. % and about 0.7 wt. % of the aqueous fluid.

Embodiment 54. The Embodiment 53, wherein the polymer concentration ranges between about about 0.10 wt. % and about 0.25 wt. %.

Embodiment 56. The Embodiment 55, wherein if the polymer is in the form or a slurry, then the slurry is present in an amount between about 10 gpt and about 30 gpt (gallons per thousand gallons) of the fracturing fluid.

Embodiment 58. The Embodiment 57, wherein the polymer slurry amount is between about 1 gpt and about 15 gpt.

Embodiment 60. The Embodiment 59, wherein the polymer slurry amount is between about between about 2 gpt and about 5 gpt.

Embodiment 62. The Embodiments of any preceding Embodiments, wherein the crosslinking agents include any compound that increases the viscosity of a fluid including the hydratable polymers by chemical crosslinks, physical crosslinks, and/or cross-links the hydratable polymer by any other mechanism.

Embodiment 64. The Embodiment 63, wherein the cross-linking agent includes a metal containing compound.

Embodiment 66. The Embodiment 65, wherein the cross-linking agent includes boron, zirconium, and titanium containing compounds, or mixtures thereof.

Embodiment 68. The Embodiment 67, wherein the cross-linking agent includes an organotitanate compound.

Embodiment 70. The Embodiment 69, wherein the cross-linking agent includes a borate.

Embodiment 72. The Embodiment 71, wherein the selection of an appropriate crosslinking agent depends upon the type of treatment to be performed and the hydratable polymer to be used.

Embodiment 74. The Embodiment 73, wherein an amount of the crosslinking agent used also depends upon the well conditions and the type of treatment to be introduced.

Embodiment 76. The Embodiment 75, wherein the amount of the crosslinking agent ranges from about 10 ppm to about 1000 ppm of metal ion of the crosslinking agent in the hydratable polymer fluid.

Embodiment 78. The Embodiment 77, wherein the crosslinking agent include borate-containing compounds, titanate-containing compounds, zirconium-containing compound, or mixtures thereof.

Embodiment 80. The Embodiment 79, wherein the crosslinking agent includes sodium borate×H₂O (varying waters of hydration), boric acid, a borate, a mixture of a titanium-containing compound and a boron-containing compound, an organotitanate compound, a mixture of a first organotitanate compound having a lactate base and a second organotitanate compound having triethanolamine base, sodium tetraborate, ulexite, colemanite, Ti(IV) acetylacetonate, Ti(IV) triethanolamine, Zr lactate, Zr triethanolamine, Zr lactate-triethanolamine, Zr lactate-triethanolamine-triisopropanolamine, and mixtures thereof.

Embodiment 82. The Embodiment 81, wherein the crosslinking agent includes titanium crosslinking agents, chromium crosslinking agents, iron crosslinking agents, aluminum crosslinking agents, zirconium crosslinking agents, zirconium triethanolamine complexes, zirconium acetylacetonate, zirconium lactate, zirconium carbonate, and chelants of organic alphahydroxycorboxylic acid and zirconium, titanium triethanolamine complexes, titanium acetylacetonate, titanium lactate, and chelants of organic alphahydroxycorboxylic acid and titanium, or combinations thereof.

Embodiment 84. The Embodiments of any preceding Embodiments, wherein the propping agents or proppants include quartz sand grains, glass beads, ceramic beads, coated glass or ceramic beads, walnut shell fragments, aluminum pellets, nylon pellets, or mixtures thereof.

Embodiment 86. The Embodiment 85, wherein the proppants are used in concentrations between about 1 lb to about 8 lbs. per gallon of a fracturing fluid, although higher or lower concentrations may also be used as desired.

Embodiment 88. The Embodiment 87, wherein the fracturing fluid may also contain other additives, such as surfactants, corrosion inhibitors, mutual solvents, stabilizers, paraffin inhibitors, tracers to monitor fluid flow back, and so on.

Embodiment 90. The Embodiments of any preceding Embodiments, wherein the inorganic acids include any inorganic acid.

Embodiment 92. The Embodiment 91, wherein the inorganic acids include hydrogen chloride, sulfuric acid, phosphoric acid, or mixtures thereof.

Embodiment 94. The Embodiments of any preceding Embodiments, wherein the organic acids include any organic acid.

Embodiment 96. The Embodiment 95, wherein the organic acids include formic acid, acetic acid, propionic acid, or mixtures thereof.

Embodiment 98. The Embodiments of any preceding Embodiments, wherein the inorganic bases include any inorganic base.

Embodiment 100. The Embodiment 99, wherein the inorganic bases include sodium hydroxide, sodium bicarbonate, sodium carbonate, sodium bicarbonate, potassium hydroxide, potassium bicarbonate, potassium carbonate, or mixtures thereof.

### Organic Bases

Embodiment 102. The Embodiments of any preceding Embodiments, wherein the organic acids include any organic base.

Embodiment 104. The Embodiment 103, wherein the organic acids include sodium tert-butoxide, potassium tert-butoxide, choline hydroxide, or mixtures thereof.

Embodiment 106. The Embodiments of any preceding Embodiments, wherein the friction-reducing polymers include one or more anionic polymers, one or more cationic polymers, one or more amphoteric polymers, or any combination thereof.

Embodiment 108. The Embodiment 107, wherein the friction-reducing polymers include one or more acrylamide copolymers, one or more anionic acrylamide copolymers, one or more cationic acrylamide copolymers, one or more nonionic acrylamide copolymers, one or more amphoteric acrylamide copolymers, one or more polyacrylamides, one or more polyacrylamide derivatives, one or more polyacrylate, one or more polyacrylate derivative, one or more polymethacrylate, one or more polymethacrylate derivatives, and any mixture or combination thereof.

Embodiment 110. The Embodiment 109, wherein the friction-reducing polymers include polyacrylates, polyacrylate derivatives, polyacrylate copolymers, polymethacrylates, polymethacrylate derivatives, polymethacrylate copolymers, polyacrylamide, polyacrylamide derivatives, polyacrylamide copolymers, acrylamide copolymers, polysaccharides, polysaccharide derivatives, polysaccharide copolymers, synthetic polymers, superabsorbent polymers, and any combination thereof.

Embodiment 112. The Embodiment 111, wherein the friction-reducing polymers include one or more water soluble FR polymers.

Embodiment 114. The Embodiment 113, wherein the one or more water soluble FR polymers include polymers containing one or more of the following monomers: acrylamide, acrylic acid, methacrylic acid, vinyl acetate, vinyl sulfonic acid, N-vinyl acetamide, N-vinyl formamide, itaconic acid, acrylic acid ester, methacrylic acid ester, ethoxylated-2-hydroxyethyl acrylate, ethoxylated-2-hydroxyethyl methacrylate, 2-hydroxycthyl acrylate, 2-hydroxyethylmethyl methacrylate, 2-hydroxypropyl acrylate, 2-hydroxypropyl methacrylate, hydroxymethyl styrene, 2-acrylamido-2-methylpropane sulfonic acid (AMPS), acrylamido tertiary butyl sulfonic acid (ATBS), 2-(meth)acrylamido-2-methylpropane sulfonic acid, 2-amino-2-methyl-1-propanol (AMP), N,N-dimethylacrylamide (DMAA), a salt of any of the foregoing, and any combination thereof.

Embodiment 116. The Embodiment 115, wherein the friction-reducing polymers include one or more copolymers including acrylamide and AMPS.

Embodiment 118. The Embodiment 117, wherein the friction-reducing polymers include high molecular weight, linear polymers.

Embodiment 120. The Embodiment 119, wherein the friction-reducing polymers include friction reducing polymers include one or more monomers selected from the groups consisting of acrylamide, acrylic acid, 2-acrylamido-2-methylpropane sulfonic acid, acrylamido tertiary butyl sulfonic acid, a salt of any of the foregoing, or any mixture or combination thereof.

Embodiment 122. The Embodiment 121, wherein the friction-reducing polymers have molecular weights ranging from about 100,000 to about 40,000,000, from about 200,000 to about 35,000,000, from about 300,000 to about 30,000,000, from about 400,000 to about 25,000,000, or from about 500,000 to about 20,000,000.

Embodiment 124. The Embodiments of any preceding Embodiments, wherein the hydration delaying salt compositions include ammonium sulfate or a mixture of ammonium sulfate and one or more other salts, one or more carbonate salts, one or more sulfate salts, one or more phosphate salts, one or more magnesium salts, one or more bromide salts, one or more formate salts, one or more acetate salts, one or more chloride salts, one or more fluoride salts, a bicarbonate salts, one or more nitrate salts, and any mixture or combination thereof.

Embodiment 126. The Embodiment 125, wherein the one or more carbonate salts include ammonium carbonate, sodium carbonate, potassium carbonate, aluminum carbonate, magnesium carbonate, calcium carbonate, barium carbonate, strontium carbonate, zinc carbonate, other metal carbonates, or any mixture or combination thereof.

Embodiment 128. The Embodiment 127, wherein the one or more phosphate salts include ammonium sulfate, sodium sulfate, potassium sulfate, aluminum sulfate, magnesium sulfate, calcium sulfate, barium sulfate, strontium sulfate, zinc sulfate, other metal sulfates, or any mixture or combination thereof.

Embodiment 130. The Embodiment 129, wherein the one or more chloride salts include ammonium chloride, sodium chloride, potassium chloride, calcium chloride, magnesium chloride, strontium chloride, barium chloride, other metal chlorides, or any mixture or combination thereof.

Embodiment 132. The Embodiment 131, wherein the one or more bromide salts include sodium bromide, potassium bromide, calcium bromide, magnesium bromide, zinc bromide, strontium bromide, other metal bromides, or any mixture or combination thereof.

Embodiment 134. The Embodiment 133, wherein the one or more bicarbonates include sodium bicarbonate, potassium bicarbonate, other metal bicarbonates, or any mixture or combination thereof.

Embodiment 136. The Embodiment 135, wherein the one or more nitrate salts include sodium nitrate, potassium nitrate, calcium nitrate, magnesium nitrate, zinc nitrate, strontium nitrate, other metal nitrate, or any mixture or combination thereof.

Embodiment 138. The Embodiment 137, wherein the hydration delaying salt compositions include divalent salts such as calcium and/or magnesium salts and monovalent salts such as ammonium and/or potassium salts work to prevent hydration as well.

Embodiment 140. The Embodiment 139, wherein the hydration delaying salt compositions include phosphate based salts such as potassium phosphate and/or variants such as potassium hexametaphosphate, which are capable of delaying or preventing FR polymer hydration.

Embodiment 142. The Embodiment 141, wherein the hydration delaying salt compositions include water-soluble potassium salts selected from the group consisting of potassium citrate, potassium carbonate, or mixtures thereof.

Embodiment 144. The Embodiment 143, wherein the hydration delaying salt compositions include multivalent salts such as zinc chloride, aluminum chloride, iron chloride, zinc sulfate, aluminum sulfate, iron sulfate, or any combination thereof.

Embodiment 146. The Embodiment 145, wherein the hydration delaying salt compositions include double salt equivalents such as magnesium ammonium sulfates, calcium ammonium sulfates, aluminum ammonium sulfates, iron ammonium sulfates, nickel ammonium sulfates, copper ammonium sulfates, similar metal ammonium salts, or any combination thereof.

Embodiment 148. The Embodiments of any preceding Embodiments, wherein the suspending agents include a bentonite clay, a phyllosilicate clay, nano-structured clays, micro-structured clay, or any combination thereof.

Embodiment 150. The Embodiments of any preceding Embodiments, wherein the gel-bridging agents polyethylene glycols such as PEG 200, PEG 300, PEG 400, PEG 500, or similar polyethylene polymers, polypropylene glycols, polyethylene/propylene glycols, other polyalkylene oxide polymers, or any mixture thereof.

Embodiment 152. The Embodiments of any preceding Embodiments, wherein the pH adjusting agents include organic acids selected from the group consisting of fatty acid, diacids, polyacids, citric acid, oxalic acid, ascorbic acid, isocitric acid, aconitic acid, propane-1,2,3-tricarboxylic acid, and any mixture thereof.

Embodiment 154. The Embodiment 153, wherein the fatty acids include any saturated fatty acid or unsaturated fatty acids or mixtures or combinations thereof.

Embodiment 156. The Embodiment 155, wherein the fatty acids include short chain free fatty acids (SCFFA), medium chain free fatty acids (MCFFA), long chain free fatty acids (LCFFA), very-long-chain free fatty acids (VLCFFA), or mixtures or combinations thereof.

Embodiment 158. The Embodiment 157, wherein the SCFFA include free fatty acids having a carbyl tail group having less than between 4 and less than 8 carbon atoms (C₄ to C₈).

Embodiment 160. The Embodiment 159, wherein the MCFFA include free fatty acids having a carbyl group having between 8 and less than 14 carbon atoms (C₄ to C₁₄).

Embodiment 162. The Embodiment 161, wherein the LCFFA include free fatty acids having a carbyl group having between 14 and 24 carbon atoms (C₁₄-C₂₄).

Embodiment 164. The Embodiment 163, wherein the VLCFFA include free fatty acids having a carbyl group having greater than 24 carbon atoms (>C₂₄).

Embodiment 166. The Embodiment 165, wherein the unsaturated fatty acids include myristolcic acid [CH₃(CH₂)₃CH═CH(CH₂)—COOH, cis-Δ⁹, C:D 14:1, n−5], palmitoleic acid [CH₃(CH₂)₅CH═CH(CH₂)₇COOH, cis-Δ⁹, C:D 16:1, n−7], sapienic acid [CH₃(CH₂)₇CH═CH(CH₂)₄COOH, cis-Δ⁶, C:D 16:1, n−10], oleic acid [CH₃(CH₂)₇CH═CH(CH₂)₇COOH, cis-Δ⁹, C:D 18:1, n−9], linoleic acid [CH₃(CH₂)₄CH═CHCH₂CH═CH(CH₂)₇COOH, cis,cis-Δ⁹,Δ¹², C:D 18:2, n−6], α-Linolenic acid [CH₃CH₂CH═CHCH₂CH═CHCH₂CH═CH(CH₂)₇COOH, cis,cis,cis-Δ⁹,Δ¹², Δ¹⁵, C:D 18:3, n−3], arachidonic acid [CH₃(CH₂)₄CH═CHCH₂CH═CHCH₂CH═CHCH₂CH═CH(CH₂)₃COOH, cis,cis,cis,cis-Δ⁵Δ⁸,Δ¹¹,Δ¹⁴, C:D 20:4, n−6], eicosapentaenoic acid [CH₃CH₂CH═CHCH₂CH═CHCH₂CH₇CHCH₂CH═CHCH₂CH═CH(CH₂)₃COOH], cis,cis,cis,cis,cis-Δ⁵,Δ⁸,Δ¹¹,Δ¹⁴,Δ¹⁷, 20:5, n−3], erucic acid [CH₃(CH₂)₇CH═CH(CH₂)₁₁COOH, cis-Δ¹³, C:D 22:1, n−9], docosahexaenoic acid [CH₃CH₂CH═CHCH₂CH═CHCH₂CH═CHCH₂CH═CHCH₂CH═CHCH₂CH═CH(CH₂)₂COOH, cis,cis,cis,cis,cis,cis-Δ⁴,Δ⁷,Δ¹⁰,Δ¹³,Δ¹⁶,Δ¹⁹, C:D 22:6, n−3], or mixtures and combinations thereof.

Embodiment 168. The Embodiment 167, wherein the saturated fatty acids include lauric acid [CH₃(CH₂)₁₀COOH, C:D 12:0], myristic acid [CH₃(CH₂)₁₂COOH, C:D 14:0], palmitic acid [CH₃(CH₂)₁₄COOH, C:D 16:0], stearic acid [CH₃(CH₂)₁₆COOH, C:D 18:0], arachidic acid [CH₃(CH₂)₁₈COOH, C:D 20:0], behenic acid [CH₃(CH₂)₂₀COOH, C:D 22:0], lignoceric acid [H₃(CH₂)₂₂COOH, C:D 24:0], cerotic acid [CH₃(CH₂)₂₄COOH, C:D 26:0], or mixture or combinations thereof.

Embodiment 170. The Embodiment 169, wherein the saturated fatty acids include butyric (C₄), valeric (C₅), caproic (C₆), enanthic (C₇), caprylic (C₈), pelargonic (C₉), capric (C₁₀), undecylic (C₁₁), lauric (C₁₂), tridecylic (C₁₃), myristic (C₁₄), pentadecylic (C₁₅), palmitic (C₁₆), margaric (C₁₇), stearic (C₁₈), nonadecylic (C₁₉), arachidic (C₂₀), heneicosylic (C₂₁), behenic (C₂₂), tricosylic (C₂₃), lignoceric (C₂₄), pentacosylic (C₂₅), cerotic (C₂₆), heptacosylic (C₂₇), montanic (C₂₈), nonacosylic (C₂₉), melissic (C₃₀), hentriacontylic (C₃₁), lacceroic (C₃₂), psyllic (C₃₃), geddic (C₃₄), ceroplastic (C₃₅), hexatriacontylic (C₃₆), heptatriacontylic acid (C₃₇), octatriacontylic acid (C₃₈), nonatriacontylic acid (C₃₉), tetracontylic acid (C₄₀), and mixtures or combinations thereof.

Embodiment 172. The Embodiment 171, wherein the fatty acids include n−3 unsaturated fatty acids such as α-linolenic acid, stearidonic acid, cicosapentaenoic acid, and docosahexaenoic acid, n−6 unsaturated fatty acids such as linoleic acid, γ-linolenic acid, dihomo-γ-linolenic acid, and arachidonic acid, n−9 unsaturated fatty acids oleic acid, elaidic acid, eicosenoic acid, erucic acid, nervonic acid, mead acid or mixtures or combinations thereof.

Embodiment 174. The Embodiment 173, wherein the unsaturated fatty acids include (a) ω-3 unsaturated fatty acids such as octenoic (8:1), decenoic (10:1), decadienoic (10:2), lauroleic (12:1), laurolinoleic (12:2), myristovaccenic (14:1), myristolinoleic (14:2), myristolinolenic (14:3), palmitolinolenic (16:3), palmitidonic (16:4), α-linolenic (18:3), stearidonic (18:4), dihomo-α-linolenic (20:3), cicosatetraenoic (20:4), cicosapentaenoic (20:5), clupanodonic (22:5), docosahexaenoic (22:6), 9,12,15,18,21-tetracosapentaenoic (24:5), 6,9,12,15,18,21-tetracosahexaenoic (24:6), and mixtures or combinations thereof; (b) ω-5 unsaturated such as myristoleic (14:1), palmitovaccenic (16:1), α-eleostearic (18:3), β-eleostearic (trans-18:3) punicic (18:3), 7,10,13-octadecatrienoic (18:3), 9,12,15-eicosatrienoic (20:3), β-eicosatetraenoic (20:4), and mixtures or combinations thereof; (c) ω-6 unsaturated such as 8-tetradecenoic (14:1), 12-octadecenoic (18:1), linoleic (18:2), linolelaidic (trans-18:2), γ-linolenic (18:3), calendic (18:3), pinolenic (18:3), dihomo-linoleic (20:2), dihomo-γ-linolenic (20:3), arachidonic (20:4), adrenic (22:4), osbond (22:5), and mixtures or combinations thereof; (d) ω-7 unsaturated such as palmitoleic (16:1), vaccenic (18:1), rumenic (18:2), paullinic (20:1), 7,10,13-eicosatriynoic (20:3), and mixtures or combinations thereof; (e) ω-9 Unsaturated such as oleic (18:1), elaidic (trans-18:1), gondoic (20:1), crucic (22:1), nervonic (24:1), 8,11-eicosadienoic (20:2), mead (20:3), and mixtures or combinations thereof; (f) ω-10 Unsaturated such as Sapienic (16:1); (g) ω-11 unsaturated such as gadoleic (20:1); (h) ω-12 Unsaturated such as 4-Hexadecenoic (16:1) Petrosclinic (18:1) 8-Eicosenoic (20:1), and mixtures or combinations thereof; and (i) mixtures or combinations thereof.

Embodiment 176. The Embodiment 175, wherein the saturate diacids include ethanedioic acid (oxalic acid), propanedioic acid (malonic acid), butanedioic acid (succinic acid), pentanedioic acid (glutaric acid), hexanedioic acid (adipic acid), heptanedioic acid (pimelic acid), octanedioic acid (suberic acid, nonanedioic acid (azelaic acid), decanedioic acid (sebacic acid), undecanedioic acid, dodecanedioic acid, tridecanedioic acid (brassylic acid), hexadecanedioic acid (thapsic acid), hencicosa-1,21-dioic acid (japanic acid), docosanedioic acid (phellogenic acid), triacontanedioic acid (equisetolic acid), or mixtures or combinations thereof.

Embodiment 178. The Embodiment 177, wherein the unsaturated diacids include (Z)-butenedioic acid (maleic acid), (E)-butenedioic acid (fumaric acid), (Z and E)-pent-2-enedioic acid (glutaconic acid), 2-decenedioic acid, dodec-2-enedioic acid (traumatic acid), (2E,4E)-hexa-2,4-dienedioic acid (muconic acid), or mixtures or combinations thereof.

Embodiment 180. The Embodiment 179, wherein the poly carboxylic acid compounds for use a pH depending release agents include any poly carboxylic acid compound.

Embodiment 182. The Embodiment 181, wherein the water immiscible poly acids include dicarboxylic acids having carbyl or carbonyl groups having between 8 and 50 carbon atoms and mixtures or combinations thereof.

Embodiment 184. The Embodiment 183, wherein the polymer carboxylic acids or polymers including carboxylic acid groups, where the polymers are oil soluble or are oils, not miscible with water.

Embodiment 186. The Embodiment 185, wherein the hydrophilic poly acids include polyacrylic acid, polymethacrylic acid, polylactic acid, polyglycol acid, mixtures and combinations thereof, copolymers thereof, CARBOPOL ® reagents available from Lubrizol Corporation (a registered trademark of the Lubrizol Corporation), other carboxylic acid containing polymers, or mixtures or combinations thereof.

Embodiment 188. The Embodiment 187, wherein the hydroxy acids include 2-hydroxyoleic acid, 2-hydroxytetracosanoic acid (cerebronic acid), 2-hydroxy-15-tetracosenoic acid (hydroxynervonic acid), 2-hydroxy-9-cis-octadecenoic acid, 3-hydroxypalmitic acid methyl ester, 2-hydroxy palmitic acid, 10-hydroxy-2-decenoic acid, 12-hydroxy-9-octadecenoic acid (ricinoleic acid), 1,13-dihydroxy-tetracos-9t-enoic acid (axillarenic acid), 3,7-dihydroxy-docosanoic acid (byrsonic acid), 9,10-dihydroxyoctadecanoic acid, 9,14-dihydroxyoctadecanoic acid, 22-hydroxydocosanoic acid (phellonic acid), 2-oxo-5,8,12-trihydroxydodecanoic acid (phascolic acid), 9,10,18-trihydroxyoctadecanoic acid (phloionolic acid), 7,14-dihydroxydocosa-4 Z,8,10,12,16Z,19Z-hexaenoic acid (Maresin 1), 5S,12R,18R-trihydroxy-6Z,8E,10E,14Z,16E-eicosapentaenoic acid (resolvin E1), resolvin D1, 10, 17S-docosatriene, (neuroprotectin D1).

Embodiment 190. The Embodiments of any preceding Embodiments, wherein the treating fluid additives include proppants, acids, diverting agents, fluid loss control additives, gas, nitrogen, carbon dioxide, surface modifying agents, tackifying agents, foamers, corrosion inhibitors, scale inhibitors, catalysts, clay control agents, biocides, antifoam agents, bridging agents, flocculants, H₂S scavengers, CO₂ scavengers, oxygen scavengers, lubricants, viscosifiers, breakers, weighting agents, relative permeability modifiers, resins, surfactants, wetting agents, coating enhancement agents, filter cake removal agents, antifreeze agents, ethylene glycol, or mixtures thereof.

Embodiment 192. The Embodiments of any preceding Embodiments, wherein the nonionic and amphoteric polymers used in the present composition preferably exhibit a molecular weight within the range of about 8 million to about 14 million or ranging from about 10 million to 15 million or ranging from about 10 million to about 12 million.

Embodiment 194. The Embodiment 193, wherein the anionic, cationic, or amphoteric polymers include homopolymers, copolymers, terpolymers, or high order mixed monomer polymers synthesized from one or more anionic monomers, cationic monomers, and/or neutral monomers.

Embodiment 196. The Embodiment 195, wherein the copolymer and high order mixed monomer polymers, the monomers used may have similar reactivities so that the resultant amphoteric polymeric material has a random distribution of monomers.

Embodiment 198. The Embodiment 197, wherein the anionic monomers may be any anionic monomer such as acrylic acid, methacrylic acid, 2-acrylamide-2-methylpropane sulfonic acid, maleic anhydride, or any combination thereof.

Embodiment 200. The Embodiment 199, wherein the cationic monomer includes dimethyl-diallyl ammonium chloride, dimethylamino-ethyl methacrylate, allyltrimethyl ammonium chloride, or any combination thereof.

Embodiment 202. The Embodiment 201, wherein the neutral monomer include butadiene, N-vinyl-2-pyrrolidone, methyl vinyl ether, methyl acrylate, maleic anhydride, styrene, vinyl acetate, acrylamide, methyl methacrylate, and/or acrylonitrile.

Embodiment 204. The Embodiment 203, wherein the polymers include a terpolymer synthesized from acrylic acid (AA), dimethyl diallyl ammonium chloride (DMDAC) or diallyl dimethyl ammonium chloride (DADMAC), and acrylamide (AM) having any ratio of monomers in the terpolymer includes a 1:1:1 ratio.

Embodiment 206. The Embodiment 205, wherein the amphoteric polymeric materials include about 30% polymerized AA, 40% polymerized AM, and 10% polymerized DMDAC or DADMAC with about 20% free residual DMDAC or DADMAC which is not polymerized due to lower relative reactivity of the DMDAC or DADMAC monomer.

### CLOSING PARAGRAPH OF THE DISCLOSURE

Therefore, the present disclosure is well adapted to attain the ends and advantages mentioned as well as those that are inherent therein. The embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. All references cited herein are incorporated by reference. Although the disclosure has been disclosed with reference to its preferred embodiments, from reading this description those of skill in the art may appreciate changes and modification that may be made which do not depart from the scope and spirit of the disclosure as described above and claimed hereafter.

1. An apparatus comprising:
an electronic device including a processing unit having a memory, one or more input devices, one or more output devices, one or more mass storage devices, an operating system, communication hardware and software, and software routines for calculating percent drag reduction (% DR) from friction-reducing (FR) polymer properties and base fluid properties,
wherein the system is configured to:
receive input data comprising properties of a friction-reducing polymer composition and properties of an aqueous base fluid used to prepare a downhole fluid,
calculate a percent drag reduction (% DR) for a downhole fluid according to Equation (1):
$$\% DR = {C}_{0} \times {f}_{1} ( MW ) \times {f}_{2} ( [ MVI ] ) \times {f}_{3} ( [ DVI ] , \% S ) \times {f}_{4} ( [ FRP ] ) \qquad ( 1 )$$
wherein:
C₀ is a constant;
ƒ₁ is explicit function of friction-reducing (FR) polymer molecular weights;
ƒ₂ is explicit function of monovalent salt concentration in base fluid;
ƒ₃ is explicit function of two independent variables: divalent salt concentration of the base fluid and the percent AMPS units in the FR polymers;
ƒ₄ is explicit function of the FR polymer concentration; and
the following dependent variable:
% DR is estimated drag reduction of a downhole fluid; and
the following measurable independent variables:
MW is the polymer weight of the FR polymers to be added to the base fluid to form the downhole fluid;
% S is a measure of a percentage of AMPS units in the FR polymers to be added to the base fluid to form the downhole fluid;
[MVI] is the monovalent ion concentration in the base fluid;
[DVI] is the divalent ion concentration in the base fluid;
[FRP] is the FR polymer concentration to be added to the base fluid to form the downhole fluid; and
% S is a measure of a percentage of AMPS units in the FR polymers to be added to the base fluid to form the downhole fluid,
receive updated input data comprising properties of a friction-reducing polymer composition and properties of an aqueous base fluid in real-time or near real-time used to modify a composition of the friction-reducing polymer composition used in the downhole fluid,
modify the friction-reducing polymer composition based on the updated input data, and
repeat the receive updated input data and the modify the friction-reducing polymer composition until the downhole operation is stopped,
wherein the downhole fluid includes a downhole treating fluid or a downhole drilling fluid and
wherein the treating downhole fluids include slick water fracturing fluids, cross-linked fracturing fluids, proppant-containing, slick water fracturing fluids, proppant-containing, cross-linked fracturing fluids, high and low viscosity completion fluids, zone isolation fluids, or any other treating fluid.

2. The apparatus of claim 1, wherein the function of Equation (1) comprises the functional form of Equations (2) or (2a):
$$DR = {C}_{0} \times [ 1 - ( \frac{1}{{e}^{( {C}_{MW} \times MW )}} ) ] \times [ 1 - ( {C}_{MVI} \times [ MVI ] ) ] \times [ \text{} 1 + {\sum }_{i = 1}^{3} {( {\sum }_{j = 0}^{3} {C}_{DVIij} \times {( \% S )}^{j} ) [ DVI ]}^{i} ] \times [ {\sum }_{k = 0}^{3} {{C}_{FRPk} [ FRP ]}^{k} ] \qquad ( 2 )$$
$$DR = {C}_{0} \times [ 1 - ( \frac{1}{{e}^{( {C}_{MW} \times MW )}} ) ] \times [ 1 - ( {C}_{MVI} \times [ MVI ] ) ] \times [ \text{} 1 + {\sum }_{i = 1}^{2} {( {\sum }_{j = 0}^{2} {C}_{DVIij} \times {( \% S )}^{j} ) [ DVI ]}^{i} ] \times [ {\sum }_{k = 0}^{2} {{C}_{FRPk} [ FRP ]}^{k} ] \qquad ( 2 a )$$
wherein:
% DR represents percent drag reduction of a downhold fluid,
C₀ represents a real number zeroth order constant,
MW is the molecular weight of the FR polymers,
C_{MW} is a real number constant associated with the independent variable FR polymer molecular weight,
[MVI] is the concentration of monovalent metal ions in the base fluid,
C_{MVI} is a real number constant associated with the independent variable [MVI],
[DVI] is the concentration of divalent metal ions in the base fluid,
% S is a measure of the amount of AMPS monomer units in the FR polymers,
C_{DVIij} are real number constants associated with the independent variables [DVI] and % S,
[FRP] is the concentration of FR polymers,
C_{FRPk} is a real number constant associated with the independent variable [FRP],
i is an integer counter ranging from 1 to 3 for Equation (2) or 1 to 2 for Equation (2a),
j is an integer counter ranging from 0 to 3 for Equation (2) or 0 to 2 for Equation (2a), and
k is an integer counter ranging from 0 to 3 for Equation (2) or 0 to 2 for Equation (2a).

3. The apparatus of claim 1, wherein the function ƒ₁(MW) comprises the functional form of exponential functions of Equations (3) or (3a):
$${f}_{1} ( MW ) = 1 - ( \frac{1}{{e}^{( {C}_{MW} \times MW )}} ) \qquad ( 3 )$$
$${f}_{1} ( MW ) = 1 - ( \frac{1}{{e}^{( \frac{{Z}_{MW} \times MW}{20.5} )}} ) \qquad ( 3 a )$$
wherein:
MW is the molecular weight of the FR polymers having a real numeric value between about 0.5 and about 25.00 MDa (mega Daltons), including any subrange or any specific value within the range, and
C_{MW} is a real number constant having a value between about 0.0195 and about 1.9512, including any subrange or any specific value within the range, or
Z_{MW} is a real number constant having a value between about 0.4 and 40.0 including any subrange or any specific value within the range.

4. The apparatus of claim 1, wherein the function ƒ₂([MVI]) may take the functional form of linear functions of Equations (4) or (4a):
$${f}_{2} ( [ MVI ] ) = 1 - ( {C}_{MVI} \times [ MVI ] ) \qquad ( 4 )$$
$${f}_{2} ( [ MVI ] ) = 1 - ( \frac{{Z}_{MVI} \times [ MVI ]}{180000} ) \qquad ( 4 a )$$
wherein:
[MVI] is the concentration of monovalent metal ions in the base fluid having a real numeric value between about 10 and about 250,000 ppm, including any subrange or any specific value within the range, and
C_{MVI} is a real valued constant having a value ranging between about 5.556×10⁻⁹ and 5.556×10⁻⁷, including any subrange or any specific value within the range, or
Z_{MVI} having a real numeric value between about 0.001 and 0.100 including any subrange or any specific value within the range.

5. The apparatus of claim 1, wherein the function ƒ₃([DVI], % S) may take the functional form of polynomial functions of Equation (5) and (5a):
$${f}_{3} ( [ DVI ] , \% S ) = 1 + {\sum }_{i - 1}^{3} {( {\sum }_{j = 0}^{3} {C}_{DVIij} \times {( \% S )}^{j} ) [ DVI ]}^{i} \qquad ( 5 )$$
$${f}_{3} ( [ DVI ] , \% S ) = 1 + {\sum }_{i - 1}^{2} {( {\sum }_{j = 0}^{2} {C}_{DVIij} \times {( \% S )}^{j} ) [ DVI ]}^{i} \qquad ( 5 a )$$
wherein:
[DVI] is the concentration of monovalent metal ions in the base fluid having a real numeric value between about 1 and about 100,000 ppm, including any subrange or any specific value within the range,
% S is a measure of the amount of AMPS monomer units in the FR polymers,
C_{DVI10} is a real number constant having a value between about −2×10⁻⁶ and about −2×10⁻⁴,
C_{DVI11} is a real number constant having a value between about 5×10⁻⁸ and about 5×10⁻⁶
C_{DVI12} is a real number constant having a value between about −8×10⁻¹⁰ and about −8×10⁻⁸
C_{DVI13} is a real number constant having a value less than ±1×10⁻¹⁰,
C_{DVI20} is a real number constant having a value between about 2×10⁻¹¹ and about 2×10⁻⁹
C_{DVI12} is a real number constant having a value between about 8×10⁻¹³ and about 8×10⁻¹¹,
C_{DVI22} is a real number constant having a value between about 1×10⁻¹¹ and about 1×10⁻¹², and
C_{DVI23} is a real number constant having a value less than ±1×10⁻¹³.

6. The apparatus of claim 1, wherein the function ƒ₄([FRP]) may take the functional form of a polynomial functions of Equation (6) and (6a):
$${f}_{4} ( [ FRP ] ) = {\sum }_{k = 0}^{3} {{C}_{FRPk} [ FRP ]}^{k} \qquad ( 6 )$$
$${f}_{4} ( [ FRP ] ) = {\sum }_{k = 0}^{2} {{C}_{FRPk} [ FRP ]}^{k} \qquad ( 6 a )$$
wherein:
[FRP] is the concentration of FR polymers,
C_{FRP0} is a real number constant having a value between about 0.06 and about 6.00,
C_{FRP1} is a real number constant having a value between about 0.04 and about 4.00,
C_{FRP2} is a real number constant having a value between about −1.00 and about −0.01, and
C_{FRP3} is a real number constant having a value less than ±0.01.

7. The apparatus of claim 1, wherein the function of ƒ₃ comprises Equation (7):
$${f}_{3} ( dv , \% s ) = 1 + ( {z}_{dv , 1} \times {C}_{dv} ) + ( {z}_{dv , 2} \times {C}_{dv}^{2} ) \qquad ( 7 )$$
$$wherein :$$
$${C}_{dv} = ppm of {CaCl}_{2} + ( x \times ppm of {MgCl}_{2} ) , \qquad ( 7 a )$$
$${z}_{dv , 1} = {z}_{dv , 1 , S \text{.1}} + ( {z}_{dv , 1 , S \text{.2}} \times \% s ) + ( {z}_{dv , 1 , S \text{.3}} \times \% {s}^{2} ) \qquad ( 7 b )$$
$${z}_{dv , 1 , S , 1} is 1.3 \times 1 {0}^{- 13} ,$$
$${z}_{dv , 1 , S , 2} is - 8.813 \times 1 {0}^{- 12} ,$$
$$and$$
$${z}_{dv , 1 , S , 3} is 2.69971 \times 1 {0}^{- 10}$$
$${z}_{dv , 2} = {z}_{dv , 2 , S \text{.1}} + ( {z}_{dv , 2 , S \text{.2}} \times \% s ) + ( {z}_{dv , 2 , S \text{.3}} \times \% {s}^{2} ) \qquad ( 7 c )$$
$${z}_{dv , 2 , S , 1} is - 8.03 \times 1 {0}^{- 9} ,$$
$${z}_{dv , 2 , S , 2} is 5.94304 \times 1 {0}^{- 7} ,$$
$$and$$
$${z}_{dv , 2 , S , 3} is - 2.3354 \times 1 {0}^{- 5} ,$$
wherein:
polymer molecular weight in MDa ranges between about 0.5 and about 25,
percent of sulfonic acid groups (% s) in polymer in wt. % ranges between about 0.1 and about 45,
C_{pc} (polymer concentration in ppt) ranges between about 0.1 and about 5,
Cₘᵥ (monovalent salt concentration in ppm) between about 10 and about 250,000, and
C_{dv} (divalent salt concentration in ppm) about 1 and about 100,000.

8. The apparatus of claim 1, wherein the aqueous base fluid properties include salinity, conductivity, pH, specific metal ions and/or metal salts, concentrations of the specific metal ions and/or metal salts, other ions and/or chemicals, ionicity, any other property of the aqueous base fluid, or any combination thereof.

9. The apparatus of claim 1, wherein the formation properties include formation temperature or temperature profile, formation pressure or pressure profile, formation geological structural properties, e.g., type of rock, shale, sand, etc., type and nature of natural fractures within the formation, extent of the formation to be treated, depth of penetration of the treating fluid, desired treating results, type of proppants to be used, type of proppant pillar formation, type of pumping format, pumping conditions such as pumping pressure, downhole fluid flow rate, pumping sequences, other formation properties, or any combination thereof.

10. The apparatus of claim 1, wherein the polymers friction-reducing polymers include at least 30% acrylamide, at least 40% acrylamide, at least 40% acrylamide, at least 50% acrylamide, at least 60% acrylamide, at least 70% acrylamide, at least 80% acrylamide, at least 90% acrylamide, or 100% acrylamide. It should be recognized that these ranges include all subranges such as 30% to 100% or any other range or any other at least percentage.

11. A method implemented on an electronic device including a processing unit having a memory, one or more input devices, one or more output devices, one or more mass storage devices, an operating system, communication hardware and software, and software routines for calculating percent drag reduction (% DR) from friction-reducing (FR) polymer properties and base fluid properties, the method comprising:
receiving input values comprising properties of a friction-reducing polymer composition and properties of an aqueous base fluid used to prepare a downhole fluid,
calculating a % DR value from a function having the form of Equation (1):
$$\% DR = {C}_{0} \times {f}_{1} ( MW ) \times {f}_{2} ( [ MVI ] ) \times {f}_{3} ( [ DVI ] , \% S ) \times {f}_{4} ( [ FRP ] ) \qquad ( 1 )$$
wherein:
C₀ is a constant;
ƒ₁ is explicit function of friction-reducing (FR) polymer molecular weights;
ƒ₂ is explicit function of monovalent salt concentration in base fluid;
ƒ₃ is explicit function of two independent variables: divalent salt concentration of the base fluid and the percent AMPS units in the FR polymers;
ƒ₄ is explicit function of the FR polymer concentration; and
the following dependent variable:
% DR is estimated drag reduction of a downhole fluid; and
the following measurable independent variables:
MW is the polymer weight of the FR polymers to be added to the base fluid to form the downhole fluid;
% S is a measure of a percentage of AMPS units in the FR polymers to be added to the base fluid to form the downhole fluid;
[MVI] is the monovalent ion concentration in the base fluid;
[DVI] is the divalent ion concentration in the base fluid;
[FRP] is the FR polymer concentration to be added to the base fluid to form the downhole fluid; and
% S is a measure of a percentage of AMPS units in the FR polymers to be added to the base fluid to form the downhole fluid,
receiving updated input data comprising properties of a friction-reducing polymer composition and properties of an aqueous base fluid in real-time or near real-time used to modify a composition of the friction-reducing polymer composition used in the downhole fluid,
modifying the friction-reducing polymer composition based on the updated input data, and
repeating the receiving updated input data and the modifying the friction-reducing polymer composition until the downhole operation is stopped,
wherein the downhole fluid includes a downhole treating fluid or a downhole drilling fluid and
wherein the treating downhole fluids include slick water fracturing fluids, cross-linked fracturing fluids, proppant-containing, slick water fracturing fluids, proppant-containing, cross-linked fracturing fluids, high and low viscosity completion fluids, zone isolation fluids, or any other treating fluid.

12. The method of claim 11, wherein, in the calculating step, the function of Equation (1) may take the functional form of Equations (2) and (2a):
$$DR = {C}_{0} \times [ 1 - ( \frac{1}{{e}^{( {C}_{MW} \times MW )}} ) ] \times [ 1 - ( {C}_{MVI} \times [ MVI ] ) ] \times [ \text{} 1 + {\sum }_{i = 1}^{3} {( {\sum }_{j = 0}^{3} {C}_{DVIij} \times {( \% S )}^{j} ) [ DVI ]}^{i} ] \times [ {\sum }_{k = 0}^{3} {{C}_{FRPk} [ FRP ]}^{k} ] \qquad ( 2 )$$
$$DR = {C}_{0} \times [ 1 - ( \frac{1}{{e}^{( {C}_{MW} \times MW )}} ) ] \times [ 1 - ( {C}_{MVI} \times [ MVI ] ) ] \times [ \text{} 1 + {\sum }_{i = 1}^{2} {( {\sum }_{j = 0}^{2} {C}_{DVIij} \times {( \% S )}^{j} ) [ DVI ]}^{i} ] \times [ {\sum }_{k = 0}^{2} {{C}_{FRPk} [ FRP ]}^{k} ] \qquad ( 2 a )$$
wherein:
% DR represents percent drag reduction of a downhold fluid,
C₀ represents a real number zeroth order constant,
MW is the molecular weight of the FR polymers,
C_{MW} is a real number constant associated with the independent variable FR polymer molecular weight,
[MVI] is the concentration of monovalent metal ions in the base fluid,
C_{MVI} is a real number constant associated with the independent variable [MVI],
[DVI] is the concentration of divalent metal ions in the base fluid,
% S is a measure of the amount of AMPS monomer units in the FR polymers,
C_{DVIij} are real number constants associated with the independent variables [DVI] and % S,
[FRP] is the concentration of FR polymers,
C_{FRPk} is a real number constant associated with the independent variable [FRP],
i is an integer counter ranging from 1 to 3 for Equation (2) or 1 to 2 for Equation (2a),
j is an integer counter ranging from 0 to 3 for Equation (2) or 0 to 2 for Equation (2a), and
k is an integer counter ranging from 0 to 3 for Equation (2) or 0 to 2 for Equation (2a).

13. The method of claim 11, wherein, in the calculating step, the function ƒ₁(MW) may take the functional form of exponential functions of Equations (3) or (3a):
$${f}_{1} ( MW ) = 1 - ( \frac{1}{{e}^{( {C}_{MW} \times MW )}} ) \qquad ( 3 )$$
$${f}_{1} ( MW ) = 1 - ( \frac{1}{{e}^{( \frac{{Z}_{MW} \times MW}{20.5} )}} ) \qquad ( 3 a )$$
wherein:
MW is the molecular weight of the FR polymers having a real numeric value between about 0.5 and about 25.00 MDa (mega Daltons), including any subrange or any specific value within the range, and
C_{MW} is a real number constant having a value between about 0.0195 and about 1.9512, including any subrange or any specific value within the range, or
Z_{MW} is a real number constant having a value between about 0.4 and 40.0 including any subrange or any specific value within the range.

14. The method of claim 11, wherein, in the calculating step, the function ƒ₂([MVI]) may take the functional form of linear functions of Equations (4) or (4a):
$${f}_{2} ( [ MVI ] ) = 1 - ( {C}_{MVI} \times [ MVI ] ) \qquad ( 4 )$$
$${f}_{2} ( [ MVI ] ) = 1 - ( \frac{{Z}_{MVI} \times [ MVI ]}{180000} ) \qquad ( 4 a )$$
wherein:
[MVI] is the concentration of monovalent metal ions in the base fluid having a real numeric value between about 10 and about 250,000 ppm, including any subrange or any specific value within the range, and
C_{MVI} is a real valued constant having a value ranging between about 5.556×10⁻⁹ and 5.556×10⁻⁷, including any subrange or any specific value within the range, or
Z_{MVI} having a real numeric value between about 0.001 and 0.100 including any subrange or any specific value within the range.

15. The method of claim 11, wherein, in the calculating step, the function ƒ₃([DVI], % S) may take the functional form of polynomial functions of Equation (5) and (5a):
$${f}_{3} ( [ DVI ] , \% S ) = 1 + {\sum }_{i - 1}^{3} {( {\sum }_{j = 0}^{3} {C}_{DVIij} \times {( \% S )}^{j} ) [ DVI ]}^{i} \qquad ( 5 )$$
$${f}_{3} ( [ DVI ] , \% S ) = 1 + {\sum }_{i - 1}^{2} {( {\sum }_{j = 0}^{2} {C}_{DVIij} \times {( \% S )}^{j} ) [ DVI ]}^{i} \qquad ( 5 a )$$
wherein:
[DVI] is the concentration of monovalent metal ions in the base fluid having a real numeric value between about 1 and about 100,000 ppm, including any subrange or any specific value within the range,
% S is a measure of the amount of AMPS monomer units in the FR polymers,
C_{DVI10} is a real number constant having a value between about −2×10⁻⁶ and about −2×10⁻⁴,
C_{DVI11} is a real number constant having a value between about 5×10⁻⁸ and about 5×10⁻⁶
C_{DVI12} is a real number constant having a value between about −8×10⁻¹⁰ and about −8×10⁻⁸
C_{DVI13} is a real number constant having a value less than ±1×10⁻¹⁰,
C_{DVI20} is a real number constant having a value between about 2×10⁻¹¹ and about 2×10⁻⁹
C_{DVI12} is a real number constant having a value between about 8×10⁻¹³ and about 8×10⁻¹¹,
C_{DVI22} is a real number constant having a value between about 1×10⁻¹¹ and about 1×10⁻¹², and
C_{DVI23} is a real number constant having a value less than ±1×10⁻¹³.

16. The method of claim 11, wherein, in the calculating step, the function ƒ₄([FRP]) may take the functional form of a polynomial functions of Equation (6) and (6a):
$${f}_{4} ( [ FRP ] ) = {\sum }_{k = 0}^{3} {{C}_{FRPk} [ FRP ]}^{k} \qquad ( 6 )$$
$${f}_{4} ( [ FRP ] ) = {\sum }_{k = 0}^{2} {{C}_{FRPk} [ FRP ]}^{k} \qquad ( 6 a )$$
wherein
[FRP] is the concentration of FR polymers,
C_{FRP0} is a real number constant having a value between about 0.06 and about 6.00,
C_{FRP1} is a real number constant having a value between about 0.04 and about 4.00,
C_{FRP2} is a real number constant having a value between about −1.00 and about −0.01, and
C_{FRP3} is a real number constant having a value less than ±0.01.

17. The method of claim 11, wherein the the function of ƒ₃ comprises Equation (7):
$${f}_{3} ( dv , \% s ) = 1 + ( {z}_{dv , 1} \times {C}_{dv} ) + ( {z}_{dv , 2} \times {C}_{dv}^{2} ) \qquad ( 7 )$$
$$wherein :$$
$${C}_{dv} = ppm of {CaCl}_{2} + ( x \times ppm of {MgCl}_{2} ) , \qquad ( 7 a )$$
$${z}_{dv , 1} = {z}_{dv , 1 , S \text{.1}} + ( {z}_{dv , 1 , S \text{.2}} \times \% s ) + ( {z}_{dv , 1 , S \text{.3}} \times \% {s}^{2} ) \qquad ( 7 b )$$
$${z}_{dv , 1 , S , 1} is 1.3 \times 1 {0}^{- 13} ,$$
$${z}_{dv , 1 , S , 2} is - 8.813 \times 1 {0}^{- 12} ,$$
$$and$$
$${z}_{dv , 1 , S , 3} is 2.69971 \times 1 {0}^{- 10}$$
$${z}_{dv , 2} = {z}_{dv , 2 , S \text{.1}} + ( {z}_{dv , 2 , S \text{.2}} \times \% s ) + ( {z}_{dv , 2 , S \text{.3}} \times \% {s}^{2} ) \qquad ( 7 c )$$
$${z}_{dv , 2 , S , 1} is - 8.03 \times 1 {0}^{- 9} ,$$
$${z}_{dv , 2 , S , 2} is 5.94304 \times 1 {0}^{- 7} ,$$
$$and$$
$${z}_{dv , 2 , S , 3} is - 2.3354 \times 1 {0}^{- 5} ,$$
wherein:
polymer molecular weight in MDa ranges between about 0.5 and about 25,
percent of sulfonic acid groups (% s) in polymer in wt. % ranges between about 0.1 and about 45,
C_{pc} (polymer concentration in ppt) ranges between about 0.1 and about 5,
Cₘᵥ (monovalent salt concentration in ppm) between about 10 and about 250,000, and
C_{dv} (divalent salt concentration in ppm) about 1 and about 100,000.

18. The method of claim 11, wherein the aqueous base fluid properties include salinity, conductivity, pH, specific metal ions and/or metal salts, concentrations of the specific metal ions and/or metal salts, other ions and/or chemicals, ionicity, any other property of the aqueous base fluid, or any combination thereof.

19. The method of claim 11, wherein the formation properties include formation temperature or temperature profile, formation pressure or pressure profile, formation geological structural properties, e.g., type of rock, shale, sand, etc., type and nature of natural fractures within the formation, extent of the formation to be treated, depth of penetration of the treating fluid, desired treating results, type of proppants to be used, type of proppant pillar formation, type of pumping format, pumping conditions such as pumping pressure, downhole fluid flow rate, pumping sequences, other formation properties, or any combination thereof.

20. The method of claim 11, wherein the polymers friction-reducing polymers include at least 30% acrylamide, at least 40% acrylamide, at least 40% acrylamide, at least 50% acrylamide, at least 60% acrylamide, at least 70% acrylamide, at least 80% acrylamide, at least 90% acrylamide, or 100% acrylamide. It should be recognized that these ranges include all subranges such as 30% to 100% or any other range or any other at least percentage.
